(19) United States
(12) Patent Application Publication
(10) Pub. No.: US 2026/0366499 A1
(43) Pub. Date: Nov. 19, 2026

(54) SOFT ORGANIC SALTS FOR BAROCALORIC HEAT TRANSFER AND STORAGE

(71) Applicant: President And Fellows of Harvard College, Cambridge, MA (US)

(72) Inventors: Jarad A. MASON, Cambridge, MA (US); Jinyoung SEO, Cambridge, MA (US); Jason BRAUN, Cambridge, MA (US); Faith E. CHEN, Cambridge, MA (US)

(21) Appl. No.: 19/120,282

(22) PCT Filed: Oct. 12, 2023
(86) PCT No.: PCT/US2023/035051

§ 371 Date: Apr. 11, 2025

Related U.S. Application Data
(60) Provisional application No. 63/415,564, filed on Oct. 12, 2022.

(51) Int. Cl. F03G 7/06

(52) U.S. Cl. CPC F03G 7/0614

(57) ABSTRACT

The invention provides methods, compositions, and systems for barocaloric applications such as cooling, heating, and energy storage using soft organic salts.

### BACKGROUND

Since the invention of vapor-compression cooling two hundred years ago, cooling technologies have played a foundational role in powering economic growth and enabling access to improved living conditions across the world. As a result, there are over 5 billion cooling appliances worldwide, and the cooling sector consumes 20% of global electricity. However, the vapor compression cycles of volatile refrigerants have become a large driver of climate change, because these refrigerants—hydrofluorocarbons (HFCs) with annual production over 1,100 ktons worldwide—have global warming potential (GWP) over 1,000 times that of carbon dioxide. In particular, direct emission of HFCs, currently responsible for 1.5% of global greenhouse gas emission, is predicted to dramatically increase, up to 20% by 2050. Furthermore, transitioning into low-GWP refrigerants (such as hydrofluoroolefins) is facing critical challenges related to low efficiency and safety, and may lead to hitherto unknown environmental effects in the long term, owing to their degradation pathways in the atmosphere.

### SUMMARY

Recognized herein is a need for new compositions, systems, and methods for barocaloric heat transfer (e.g., cooling, heating, heat pumping) and storage.

Provided herein are compositions, systems, and methods, for barocaloric cooling using soft organic salts (e.g., ammonium or phosphonium salts).

An aspect of the disclosure provides a barocaloric system. The barocaloric system includes a source of compression and a matrix including organic layers including compounds of formula (I):

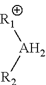

and a counterion,
where R₁ and R₂ are optionally substituted polyfluorocarbyl or hydrocarbyl groups, and A=N or P.

In some embodiments, the counterion is a monoanionic species (e.g., a halide (e.g., F—, Cl—, Br—, or I—), an alkyl or polyfluoroalkyl sulfonate (e.g., triflate), a carboxylate (e.g., an alkanoate, e.g., ethanoate, propanoate, etc.), NO₃—, ClO₃—, ClO₄—, H₂PO₄—, HSO₄—, CN—, HCOO—, N₃—, N(CN)₂—, BF₄—, BH₄—, PF₆—, SCN—, or OCN—, or combinations thereof. In some embodiments, the counterion is a polyanion (e.g., a dianion).

In some embodiments, R₁≠R₂. In some embodiments, at least one of R₁ and R₂ is optionally substituted C_{≥3} hydrocarbyl or polyfluorocarbyl. In some embodiments, R₁ includes a linear chain of n atoms starting at a carbon of R₁ bonded to A and R₂ includes a linear chain of m atoms starting at a carbon of R₂ bonded to A, where n and m are from 1-36 atoms and where n>m. In some embodiments, R₁ and/or R₂ comprises a carbon-carbon double or triple bond. In some embodiments, R₁ and/or R₂ includes two or more methylene or perfluoromethylene subunits separated by O or S. In some embodiments, R₁ is Me or F₃C—, and R₂ includes optionally substituted C₃ hydrocarbyl or polyfluoroalkyl. In certain embodiments, R₁ includes an ether or thioether linkage (e.g., a polyethylene glycol). In some embodiments, R₁ is an optionally substituted hydrocarbyl group, and R₂ is an optionally substituted perfluorocarbyl group (e.g., where R₁ is an alkyl group, and R₂ is a perfluoroalkyl group).

In some embodiments, the compound of formula (I) is a compound of formula: (CₙH₂ₙ₊₁)(CₘH₂ₘ₊₁)AH₂X, where A=N or P, X=a counterion (which may be monoanionic or polyanionic), where m is 4-33 and n is 7-36, and n−m≥3. In some embodiments, the compound of formula (I) is a compound of formula: (CₙH₂ₙ₊₁)(CH₂CₘF₂ₘ₊₁)AH₂X or (CₙH₂ₙ₊₁)(CₘF₂ₘ₊₁)AH₂X; where A=N or P, X=a counterion (which may be monoanionic or polyanionic), and where m is 1-36 and n is 1-36. In some embodiments, the compound of formula (I) is a compound of formula: (CₙH₂ₙ₊₁)(CₘH₂ₘCH═CH₂)AH₂X, where A=N or P, X=a counterion (which may be monoanionic or polyanionic), m is 1-34, and n is 1-36.

In particular embodiments, the compound of formula (I) is (C₆H₁₃)NH₂(CH₃)Br, (C₈H₁₇)NH₂(CH₃)Br, (C₁₀H₂₁)NH₂(CH₃)Br, (C₁₂H₂₅)NH₂(CH₃)Br, (C₆H₁₃)(CH₃)NH₂Cl, (C₈H₁₇)(CH₃)NH₂Cl, (C₁₂H₂₅)(CH₃)NH₂Cl, (C₆H₁₃)NH₂(CH₂C₅F₁₁H₂)Br, (C₁₀H₂₁)NH₂(CH₂C₉F₁₉)Cl, (C₁₀H₂₁)NH₂(CH₂C₉F₁₉)Br, (C₁₀H₂₁)NH₂(CH₂C₉F₁₉)I, (C₁₀H₂₁)NH₂(C₁₀H₁₉)Br, (C₂H₅)NH₂(C₆H₁₃)Br, (C₃H₇)NH₂(C₆H₁₃)Br, (C₄H₉)NH₂(C₆H₁₃)Br, (C₅H₁₁)NH₂(C₆H₁₃)Br, or (C₁₂H₂₅)(CH₃)NH₂Cl.

In some embodiments, the system includes a pressure transmitting medium. In some embodiments, the pressure transmitting medium comprises a gas. In some embodiments, the gas comprises an inert gas or a fluorinated gas. In some embodiments, the pressure transmitting medium comprises nitrogen, argon, krypton, xenon, methane, ethane, propane, butane, 2-methylpropane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, or a combination thereof. In some embodiments, the pressure transmitting medium is a gas (e.g., nitrous oxide, cyclopropane, acetylene, R-134a, HFO-1234ze, or ethylene).

In some embodiments, the pressure transmitting medium comprises a liquid. In some embodiments, the pressure transmitting medium comprises a perfluorocarbon, an ionic liquid, an aqueous solution, an aqueous salt solution, a. In some embodiments, the pressure transmitting medium comprises fluorocarbon oil, silicone oil, pentane, hexane, methanol, ethanol, alkylsilane (e.g., Daphne 7474), perfluorocarbon (e.g., Fluorinert), water, hydraulic oil, mercury (Hg), mineral oil, glycerin, ethylene glycol, transformer oil, kerosene (a mixture of hydrocarbons), a hydrocarbon, silicone grease, liquid ammonia, liquid nitrogen, sodium-potassium alloy, gallium, indium, a liquid crystal, polyalphaolefin, liquid paraffin, an alkane, grease, petroleum jelly (e.g., Vaseline), phosphate ester, polyol ester, propylene glycol, brake fluid, automatic transmission fluid, vegetable oil, synthetic oil, corn syrup, or a combination thereof.

In some embodiments, the composition is compressed at less than 100 bar (e.g., less than 30 bar, e.g., 1-30 bar, 20-50 bar, 30-60 bar, 50-75 bar, 70-100 bar, 90-100 bar, e.g., about 50 bar, 40 bar, 30 bar, 10 bar, 5 bar, or 1 bar). In some embodiments, the composition is compressed at about 100-2000 bar. In some embodiments, the pressure transmitting medium has a solubility in n-decane of at least 0.15 volume of gas per volume of n-decane at atmospheric pressure. In certain embodiments of the system, the compound of formula (I) does not have the formula: (CₙH₂ₙ₊₁)(CₘH₂ₘ₊₁)NH₂X, where n is 1-3 or 4-36 and m=4-36; and where X is a monoanionic species. In some embodiments, the compound of formula (I) is not (C₁₂H₂₅)(CH₃)NH₂Br or (C₁₂H₂₅)(CH₃)NH₂Cl.

In some embodiments, the barocaloric system further comprises a substrate, wherein the matrix is deposited on the substrate. In some embodiments, the substrate comprises a binder, a shape-memory alloy, a thermally conductive additive, a thermally conductive scaffold, a carbon-based scaffold, a metal-based scaffold, a heat exchanger, a pipe, a tank, or a combination thereof. In some embodiments, the thermally conductive additive comprises aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and graphene derivatives, hybrid graphene aerogels (HGA), sulphonated graphene (SG), graphite foams, carbon nanofibers (CNF), metallic nanoparticles, porous metals, graphene/ceramic composites, metal nanoparticles, metallic particles/beads, or a combination thereof.

In another aspect, the disclosure provides a method of heat transfer employing a barocaloric cycle. The barocaloric cycle can be a conventional barocaloric cycle or an inverted barocaloric cycle. The method includes applying compression to induce an exothermic or endothermic phase transition in a matrix including an organic layer including compounds of formula (I):

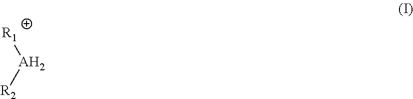

and a counterion (e.g., a monoanionic counterion (e.g., a halide (e.g., F—, Cl—, Br—, or I—), an alkyl or polyfluoroalkyl sulfonate (e.g., triflate), a carboxylate (e.g., an alkanoate, e.g., ethanoate, propanoate, etc.), NO₃—, ClO₃—, ClO₄—, H₂PO₄, HSO₄—, CN—, HCOO—, N₃—, N(CN)₂—, BF₄—, BH₄—, PF₆—, SCN—, or OCN—), where R₁ and R₂ are optionally substituted polyfluorocarbyl or hydrocarbyl groups, and A=N or P. The method further includes providing or removing heat energy to/from the compressed matrix. The method further includes removing the compression to allow reversion of the phase change.

In some embodiments, the phase change is an exothermic phase change to an ordered state, and heat energy is removed from the compressed matrix.

In some embodiments, the compression is provided via a pressure transmitting medium, the phase change is an endothermic phase change to a disordered state, and heat energy is provided to the compressed matrix.

In some embodiments, the pressure transmitting medium comprises a gas. In some embodiments, the gas comprises an inert gas or a fluorinated gas. In some embodiments, the pressure transmitting medium comprises a liquid. In some embodiments, the pressure transmitting medium comprises a perfluorocarbon, an ionic liquid, an aqueous solution, an aqueous salt solution, or a combination thereof.

In some embodiments, the pressure transmitting medium comprises nitrogen, argon, krypton, xenon, methane, ethane, propane, butane, 2-methylpropane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, or a combination thereof. In some embodiments, the pressure transmitting medium is a gas (e.g., nitrous oxide, cyclopropane, acetylene, R-134a, HFO-1234ze, or ethylene). In some embodiments, the pressure transmitting medium comprises fluorocarbon oil, silicone oil, pentane, hexane, methanol, ethanol, alkylsilane (e.g., Daphne 7474), perfluorocarbon (e.g., Fluorinert), water, hydraulic oil, mercury (Hg), mineral oil, glycerin, ethylene glycol, transformer oil, kerosene (a mixture of hydrocarbons), a hydrocarbon, silicone grease, liquid ammonia, liquid nitrogen, sodium-potassium alloy, gallium, indium, a liquid crystal, polyalphaolefin, liquid paraffin, an alkane, grease, petroleum jelly (e.g., Vaseline), phosphate ester, polyol ester, propylene glycol, brake fluid, automatic transmission fluid, vegetable oil, synthetic oil, corn syrup, or a combination thereof.

In some embodiments, the composition is compressed at less than 100 bar (e.g., less than 30 bar, e.g., 1-30 bar, 20-50 bar, 30-60 bar, 50-75 bar, 70-100 bar, 90-100 bar, e.g., about 50 bar, 40 bar, 30 bar, 10 bar, 5 bar, or 1 bar). In some embodiments, the pressure transmitting medium has a solubility in n-decane of at least 0.15 volume of gas per volume of n-decane at atmospheric pressure.

In some embodiments, the compression is hydrostatic or mechanical. The heat may be removed by a heat sink.

In some embodiments, the providing or removing heat energy to or from the compressed matrix is facilitated by a heat transfer medium. In some embodiments, the heat transfer medium comprises a heat transfer fluid. In some embodiments, the heat transfer fluid comprises ethylene glycol, propylene glycol, eutectic mixtures of biphenyl and diphenyl oxide (e.g., Dowtherm A, Therminol), silicone oil, mineral oil, polyalphaolefins (PAO), pentaerythritol tetraalkanoates, hydrogenated terphenyls, diphenyl ether, biphenyl, mineral oil (e.g., Paratherm), perfluoropolyether (e.g., Galden), perfluoroalkanes (e.g., Fluorinert), molten salts (e.g., Hitec), potassium formate (e.g., Dynalene), mono- and dibenzyltoluene (e.g., Marlotherm), NaK (sodium-potassium alloy), a eutectic salt, a refrigerant, or a combination thereof.

In some embodiments, the heat transfer fluid can further comprise an additive, wherein the additive comprises a nanoparticle, a carbon nanotube, graphene, graphite, a metallic particle, boron nitride, diamond powder, carbon black, fullerene, a hydrotreated mineral oil, organosilane, a polymeric stabilizer, a surfactant, an antioxidants, an anti-foaming agent, a corrosion inhibitor, or a combination thereof.

In some embodiments, R₁≠R₂. In some embodiments, at least one of R₁ and R₂ is optionally substituted C₃ hydrocarbyl or polyfluorocarbyl. In some embodiments, R₁ includes a linear chain of n atoms starting at a carbon of R₁ bonded to A, and R₂ includes a linear chain of m atoms starting at a carbon of R₂ bonded to A, where n and m are from 1-36 atoms and where n>m.

In some embodiments of the method, the compound of formula (I) does not have the formula: (CₙH₂ₙ₊₁)(CₘH₂ₘ₊₁)NH₂X, where n is 1-3 or 4-36 and m=4-36; and where X is a monoanionic species. In some embodiments, the compound of formula (I) is not (C₁₂H₂₅)(CH₃)NH₂Br or (C₁₂H₂₅)(CH₃)NH₂Cl.

In some embodiments of the method, the matrix is deposited on a substrate. In some embodiments, the substrate comprises a binder, a shape-memory alloy, a thermally conductive additive, a thermally conductive scaffold, a carbon-based scaffold, a metal-based scaffold, a heat exchanger, a pipe, a tank, or a combination thereof. In some embodiments, the thermally conductive additive comprises aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and graphene derivatives, hybrid graphene aerogels (HGA), sulphonated graphene (SG), graphite foams, carbon nanofibers (CNF), metallic nanoparticles, porous metals, graphene/ceramic composites, metal nanoparticles, metallic particles/beads, or a combination thereof.

In some embodiments, the matrix comprises a soft organic material. In some embodiments, the soft organic material comprises bilayers of long-chain organic cations linked through charge-assisted hydrogen bonds to charge-balancing anions. In some embodiments, the soft organic material undergoes a thermally induced, solid-solid phase transition. In some embodiments, the thermally induced, solid-solid phase transition occurs near room temperature. In some embodiments, the thermally induced, solid-solid phase transition occurs between low-entropy, low-temperature and high-entropy, high-temperature states. In some embodiments, the thermally induced, solid-solid phase transition is driven by conformational disordering of hydrocarbon layers.

Another aspect of the disclosure provides compounds of formula (I):

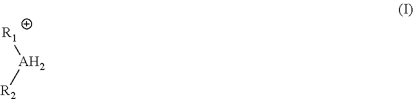

and a counterion, where R₁ and R₂ are optionally substituted polyfluorocarbyl or hydrocarbyl groups, and A=N or P.

In some embodiments, the counterion is a monoanionic counterion (e.g., a halide (e.g., F—, C—, Br—, or I—), an alkyl or polyfluoroalkyl sulfonate (e.g., triflate), a carboxylate (e.g., an alkanoate, e.g., ethanoate, propanoate, etc.), NO₃, ClO₃—, ClO₄—, H₂PO₄—, HSO₄—, CN—, HCOO—, N₃, N(CN)₂—, BF₄—, BH₄—, PF₆—, SCN—, or OCN—). In some embodiments, the counterion is a polyanion (e.g., a dianion).

In some embodiments, R₁≠R₂. In some embodiments, at least one of R₁ and R₂ is optionally substituted C_{≥3} hydrocarbyl or polyfluorocarbyl. In some embodiments, R₁ includes a linear chain of n atoms starting at a carbon of R₁ bonded to A and R₂ includes a linear chain of m atoms starting at a carbon of R₂ bonded to A, where n and m are from 1-36 atoms and where n>m. In some embodiments, R₁ and/or R₂ includes a carbon-carbon double or triple bond. In some embodiments, R₁ and/or R₂ includes two or more methylene or perfluoromethylene subunits separated by O or S. In some embodiments, R₁ is Me or F₃C—, and R₂ includes optionally substituted C_{≥3} hydrocarbyl or polyfluoroalkyl. In certain embodiments, R₁ includes an ether or thioether linkage (e.g., a polyethylene glycol). In some embodiments, R₁ is an optionally substituted hydrocarbyl group, and R₂ is an optionally substituted perfluorocarbyl group (e.g., where R₁ is an alkyl group, and R₂ is a perfluoroalkyl group).

In some embodiments, the compound of formula (I) is a compound of formula: (CₙH₂ₙ₊₁)(CₘH₂ₘ₊₁)AH₂X, where A=N or P, where m is 4-33 and n is 7-36, and where n−m≥3. In some embodiments, the compound of formula (I) is a compound of formula: (CₙH₂ₙ₊₁)(CH₂CₘF₂ₘ₊₁)AH₂X or (CₙH₂ₙ₊₁)(CₘF₂ₘ₊₁)AH₂X, where A=N or P, X=a counterion (which may be monoanionic or polyanionic) and where m is 1-36 and n is 1-36. In some embodiments, the compound of formula (I) is a compound of formula: (CₙH₂ₙ₊₁)(CₘH₂ₘCH═CH₂)AH₂X, where A=N or P, X=a counterion (which may be monoanionic or polyanionic) and where m is 1-34 and n is 1-36.

In particular embodiments, the compound of formula (I) is (C₆H₁₃)NH₂(CH₃)Br, (C₈H₁₇)NH₂(CH₃)Br, (C₁₀H₂₁)NH₂(CH₃)Br, (C₁₂H₂₅)NH₂(CH₃)Br, (C₆H₁₃)(CH₃)NH₂Cl, (C₈H₁₇)(CH₃)NH₂Cl, (C₁₂H₂₅)(CH₃)NH₂Cl, (C₆H₁₃)NH₂(CH₂C₅Fu H₂)Br, (C₁₀H₂₁)NH₂(CH₂C₉F₁₉)Cl, (C₁₀H₂₁)NH₂(CH₂C₉F₁₉)Br, (C₁₀H₂₁)NH₂(CH₂C₉F₁₉)I, (C₁₀H₂₁)NH₂(C₁₀H₁₉)Br, (C₂H₅)NH₂(C₆H₁₃)Br, (C₃H₇)NH₂(C₆H₁₃)Br, (C₄H₉)NH₂(C₆H₁₃)Br, (C₅H₁₁)NH₂(C₆H₁₃)Br, or (C₁₂H₂₅)(CH₃)NH₂Cl.

In certain embodiments, the compound of formula (I) does not have the formula: (CₙH₂ₙ₊₁)(CₘH₂ₘ₊₁)NH₂X, where n is 1-3 or 4-36 and m=4-36; and where X is a monoanionic species. In some embodiments, the compound of formula (I) is not (C₁₂H₂₅)(CH₃)NH₂Br or (C₁₂H₂₅)(CH₃)NH₂Cl.

Another aspect of the disclosure provides a method of storing heat. The method includes providing a composition including a matrix including an organic layer including compounds of formula (I):

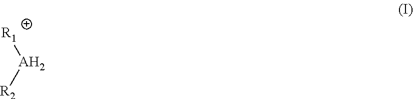

and a counterion, where R₁ and R₂ are optionally substituted polyfluorocarbyl or hydrocarbyl groups, A=N or P; the composition being in an ordered state. The method further includes subjecting the composition to a first pressure change that induces a first phase change in the composition to a disordered state, thereby storing energy.

In some embodiments, the method includes subjecting the composition to a second pressure change to induce a second phase change to an ordered state and release heat energy. In some embodiments, the first pressure change is a reduction in pressure. In some embodiments, the first pressure change is provided via a pressure transmitting medium and the first pressure change is an increase in pressure.

In some embodiments, the pressure transmitting medium comprises a gas. In some embodiments, the gas comprises an inert gas or a fluorinated gas. In some embodiments, the pressure transmitting medium comprises a liquid. In some embodiments, the pressure transmitting medium comprises a perfluorocarbon, an ionic liquid, an aqueous solution, an aqueous salt solution, or a combination thereof.

In certain embodiments, the pressure transmitting medium includes a gas. In some embodiments, the pressure transmitting medium comprises nitrogen, argon, krypton, xenon, methane, ethane, propane, butane, 2-methylpropane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, or a combination thereof. In some embodiments, the pressure transmitting medium comprises fluorocarbon oil, silicone oil, pentane, hexane, methanol, ethanol, alkylsilane (e.g., Daphne 7474), perfluorocarbon (e.g., Fluorinert), water, hydraulic oil, mercury (Hg), mineral oil, glycerin, ethylene glycol, transformer oil, kerosene (a mixture of hydrocarbons), a hydrocarbon, silicone grease, liquid ammonia, liquid nitrogen, sodium-potassium alloy, gallium, indium, a liquid crystal, polyalphaolefin, liquid paraffin, an alkane, grease, petroleum jelly (e.g., Vaseline), phosphate ester, polyol ester, propylene glycol, brake fluid, automatic transmission fluid, vegetable oil, synthetic oil, corn syrup, or a combination thereof. In some embodiments, the pressure change is provided by hydrostatic or mechanical compression.

In some embodiments, the counterion is a halide, a sulfonate, a carboxylate, or is selected from NO₃—, ClO₃—, ClO₄—, H₂PO₄—, HSO₄—, CN—, HCOO—, N₃—, N(CN)₂—, BF₄—, BH₄—, PF₆—, SCN—, or OCN—. In some embodiments, R₁≠R₂. In some embodiments, at least one of R₁ and R₂ is optionally substituted C_{≥3} hydrocarbyl or polyfluorocarbyl. In some embodiments, R₁ includes a linear chain of n atoms starting at a carbon of R₁ bonded to A, and R₂ includes a linear chain of m atoms starting at a carbon of R₂ bonded to A, where n and m are from 1-36 atoms and where n>m.

In some embodiments of the method, the compound of formula (I) does not have the formula: (CₙH₂ₙ₊₁)(CₘH₂ₘ₊₁)NH₂X, where n is 1-3 or 4-36 and m=4-36; and where X is a monoanionic species. In some embodiments, the compound of formula (I) is not (C₁₂H₂₅)(CH₃)NH₂Br or (C₁₂H₂₅)(CH₃)NH₂Cl.

In some embodiments of the method, the matrix is deposited on a substrate. In some embodiments, the substrate comprises a binder, a shape-memory alloy, a thermally conductive additive, a thermally conductive scaffold, a carbon-based scaffold, a metal-based scaffold, a heat exchanger, a pipe, a tank, or a combination thereof. In some embodiments, the thermally conductive additive comprises aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and graphene derivatives, hybrid graphene aerogels (HGA), sulphonated graphene (SG), graphite foams, carbon nanofibers (CNF), metallic nanoparticles, porous metals, graphene/ceramic composites, metal nanoparticles, metallic particles/beads, or a combination thereof.

### DEFINITIONS

The term “about,” as used herein, refers to ±10% of a recited value.

The term “hydrocarbyl,” as used herein, means straight chain or branched saturated or unsaturated groups of carbons. Hydrocarbyl groups can include alkyl (saturated), alkenyl (unsaturated with at least one carbon double bond and no carbon triple bonds), and alkynyl (unsaturated with at least one carbon triple bond). Alkyl groups are exemplified by n-, sec-, iso- and tert-butyl, neopentyl, nonyl, decyl, and the like, and may be substituted with one or more, substituents. Hydrocarbyl groups of a composition may include 1 or more carbon atoms, e.g., greater than 2, e.g., 6-15, such as 8-12, or 4-36 in the main chain. Carbon atoms in the main chain may or may not be interrupted with one or more heteroatoms, e.g., O, S, or N.

The term “polyfluorocarbyl,” as used herein, means straight chain or branched saturated or unsaturated groups of carbons where at least two hydrogens are replaced by fluorine. Hydrocarbyl groups can include polyfluoroalkyl (saturated), polyfluoroalkenyl (unsaturated with at least one carbon double bond and no carbon triple bonds), and polyfluoroalkynyl (unsaturated with at least one carbon triple bond).

Polyfluorocarbyl groups may be polyfluoroalkyl groups, e.g., perfluoroalkyl groups (i.e., wherein all hydrogens are replaced with fluorine). Polyfluoroalkyl groups may include a mixture of methylene (CH₂) and difluoromethylene (CF₂) units; for example, a methylene is connected to ‘A’, but the rest of the chain is perfluorinated. Polyfluoroalkyl groups can be, for example methyl, ethyl, n- or iso-propyl, n-, sec-, iso- and tert-butyl, neopentyl, nonyl, decyl, and the like. Polyfluoroalkyl groups can be substituted with one or more, substituents. Polyfluorocarbyl groups of a composition may include 1 or more carbon atoms, e.g., greater than 2, e.g., 6-15, such as 8-12, or 4-36 in the main chain. Carbon atoms in the main chain may or may not be interrupted with one or more heteroatoms, e.g., O, S, or N.

By “aryl” is meant an aromatic cyclic group in which the ring atoms are all carbon. Aryl groups can include phenyl, naphthyl, and anthracenyl. Aryl groups may be optionally substituted with one or more substituents.

By “carbocyclyl” is meant a non-aromatic cyclic group in which the ring atoms are all carbon. Carbocyclyl groups can include cyclopropyl, cyclobutyl, cyclopentyl, cyclohexyl, cycloheptyl, and cyclooctyl.

Carbocyclyl groups may be optionally substituted with one or more substituents. A carbocyclyl group may or may not be saturated.

By “halo” is meant, fluoro, chloro, bromo, or iodo.

By “heteroaryl” is meant an aromatic cyclic group in which the ring atoms include at least one carbon and at least one O, N, or S atom, provided that at least three ring atoms are present. Heteroaryl groups can include oxazolyl, isoxazolyl, tetrazolyl, pyridyl, thienyl, furyl, pyrrolyl, imidazolyl, pyrimidinyl, thiazolyl, indolyl, quinolinyl, isoquinolinyl, benzofuryl, benzothienyl, pyrazolyl, pyrazinyl, pyridazinyl, isothiazolyl, benzimidazolyl, benzothiazolyl, benzoxazolyl, oxadiazolyl, thiadiazolyl, and triazolyl. Heteroaryl groups may be optionally substituted with one or more substituents.

By “heterocyclyl” is meant a non-aromatic cyclic group in which the ring atoms include at least one carbon and at least one O, N, or S atom, provided that at least three ring atoms are present. Heterocyclyl groups can include epoxide, thiiranyl, aziridinyl, azetidinyl, thietanyl, dioxetanyl, morpholinyl, thiomorpholinyl, piperazinyl, piperidinyl, pyrrolidinyl, tetrahydropyranyl, tetrahydrofuranyl, dihydrofuranyl, tetrahydrothienyl, dihydrothienyl, dihydroindolyl, tetrahydroquinolyl, tetrahydroisoquinolyl, pyranyl, pyrazolinyl, pyrazolidinyl, dihydropyranyl, tetrahydroquinolyl, imidazolinyl, imidazolidinyl, pyrrolinyl, oxazolidinyl, isoxazolidinyl, thiazolidinyl, isothiazolidinyl, dithiazolyl, and 1,3-dioxanyl. Heterocyclyl groups may be optionally substituted with one or more substituents.

By “polyethylene glycol” is meant a group of formula —(CH₂CH₂O)ᵣR, wherein R is H or C₁₋₆ alkyl and r is 1-18.

Optional substituents include halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; wherein each Rₐ is independently H, optionally substituted C₁₋₃₆ hydrocarbyl (e.g., C₁₋₃₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; or optionally substituted C₁₋₉ heteroaryl having one to four heteroatoms independently selected from O, N, and S. Cyclic groups may also be substituted with C₁₋₃₆ hydrocarbyl (e.g., C₁₋₃₆ alkyl).

### BRIEF DESCRIPTION OF THE DRAWINGS

FIG. 1 is a schematic illustrating a hypothetical barocaloric cooling cycle with soft organic salts.

FIGS. 2(a)-2(b) show preliminary high-pressure differential scanning calorimetry data for a soft organic salt (C₆H₁₃)₂NH₂Br. FIG. 2(a) shows DSC measurements for (C₆H₁₃)₂NH₂Br. FIG. 2(b) shows the pressure-temperature diagram determined from the HP-DSC experiments.

FIGS. 3(a)-3(c) show example X-ray diffraction studies for phase transitions in (C₆H₁₃)₂NH₂Br (“dC₆Br”).

FIG. 3(a) Single-crystal X-ray diffraction structures obtained at 100 K. FIG. 3(b) shows C—H⋅⋅⋅Br and N—H⋅⋅⋅Br hydrogen bonding interactions (shown in dotted lines) confine the di-hexylammonium cation. The confinement area defined by the bromide anion is 29 Å². FIG. 3(c) shows variable-temperature powder X-ray diffraction patterns obtained upon cooling at ambient pressure, with an X-ray wavelength of 0.45213 Å.

FIGS. 4(a)-4(c) show example phase transitions of (C₆H₁₃)₂NH₂Br (“dC₆Br”) under applied pressures. FIG. 4(a) shows high-pressure DSC measurements under applied hydrostatic pressure with heating and cooling rates of 2 K min⁻¹ using He as the pressure-transmitting medium. FIG. 4(b) shows pressure-temperature (P, 7) phase diagram determined from the isobaric HP-DSC experiments. Phase boundaries were determined for both heating (red) and cooling (blue). FIG. 4(c) shows variable-temperature powder X-ray diffraction patterns obtained upon cooling at 300 bar, with an X-ray wavelength of 0.45213 Å.

FIG. 5 shows example powder X-ray diffraction patterns for (C₆H₁₃)₂NH₂Cl (“dC₆Cl”), (C₆H₁₃)₂NH₂Br (“dC₆Br”), (C₆H₁₃)₂NH₂I (“dC₆I”) at the high-temperature disordered phase (320 K). Large diffuse scattering background signals are observed for all three compounds indicates that the disordered phase is dynamically disordered. It was noted that the interlayer distances decrease as the size of halide increases.

FIG. 6 shows example phase transitions of (C₆H₁₃)₂NH₂Cl (“dC₆Cl”) under applied pressures. High-pressure DSC measurements under applied hydrostatic pressure with heating and cooling rates of 2 K min⁻¹ using He as the pressure-transmitting medium. The phase transition can be sensitive to pressure, with pressure dependence of transition temperature (d Tₜᵣ/dP) of 30 K/kbar.

FIG. 7 shows example phase transitions of (C₆H₁₃)₂NH₂I (“dC₆I”) under applied pressures. High-pressure DSC measurements under applied hydrostatic pressure with heating and cooling rates of 2 K min⁻¹ using He as the pressure-transmitting medium. Phase transition can be sensitive to pressure, with pressure dependence of transition temperature (d Tₜᵣ/dP) of 24 K/kbar.

FIG. 8 shows example reversible conventional barocaloric effects in dialkylammonium halide salts. Transition entropy changes and Pᵣₑᵥ (minimum pressure required to induce non-zero isothermal entropy changes) are plotted for (C₆H₁₃)₂NH₂Cl (“dC₆Cl”), (C₆H₁₃)₂NH₂Br (“dC₆Br”), (C₆H₁₃)₂NH₂I (“dC₆I”). Note that Pᵣₑᵥ is calculated using Pᵣₑᵥ=(ΔT_{hys})/(dT/dP). For comparison, reversible conventional barocaloric effects in 2-D perovskites are shown as well.

FIG. 9 shows example powder X-ray diffraction patterns for (CH₃)NH₂((CH₂)₅CH₃)Br (“C₁C₆—Br”) (left, disordered phase, collected at room temperature) and (CH₃)NH₂((CH₂)₇CH₃)Br (“C₁C₈—Br”) (right, mix of ordered and disordered phases, collected at room temperature).

FIG. 10 shows example X-ray crystal structures of C₁C₁₀—Br (left) and C₁C₁₂—Br (right).

FIG. 11 shows an example of a general approach of manipulation of local symmetry in organo-ammonium salts.

FIG. 12 shows an example of the synthesis of asymmetric dialkylammonium salts.

FIG. 13 shows an example of a generalized synthetic route to functionalized dialkylamines. The resulting amines can react with hydrohalic acid to provide functionalized dialkylammonium halide salts.

FIG. 14 shows an example of a structural characterization of [(CₙH₂ₙ₊₁)(CH₃)NH₂Br](n=6, 8, 10, 12). The powder X-ray diffraction patterns (left) and single-crystal structures obtained at 100 K (right) feature layered structures, where each organic cation is confined by hydrogen bonds with charge-balancing Br anions.

FIGS. 15(a) and (b) show an example of a structural characterization of (C₁₂H₂₅)(CH₃)NH₂Br (“(C₁₂C₁)Br”). The single-crystal structure obtained at 100 K in FIG. 15(a)(viewed along b-axis) features a layered structure, where each organic cation is confined by charge-balancing Br anions. FIG. 15(b) shows an enlarged crystal structure showing the nitrogen-bound hydrogens and their bonds to nearby Br anions.

FIG. 16 shows an example of a structural characterization of (C₁₂H₂₅)(CH₃)NH₂Cl (“C₁₂-C₁Cl”). The single-crystal structure obtained at 100 K in FIG. 16 (viewed along b-axis) features a layered structure, where each organic cation is confined by charge-balancing C₁ anions.

FIGS. 17(a) and 17(b) show an example of the results of differential scanning calorimetry (DSC) measurements on (C₁₂-C₁)Br. FIG. 17(a) shows DSC measurements for (C₁₂H₂₅)(CH₃)NH₂Br (“C₁₂-C₁—Br”) under applied hydrostatic pressure with heating and cooling rates of 2 K min⁻¹ using He as the pressure-transmitting medium. FIG. 17(b) shows the pressure-temperature (P, 7) phase diagram determined from the isobaric HP-DSC experiments. Phase boundaries were determined for both heating (bottom) and cooling (top).

FIGS. 18(a) and 18(b) show example results of DSC measurements on C₁₂C₁—Cl. FIG. 18(a) shows DSC measurements for (C₁₂H₂₅)(CH₃)NH₂Br (“(C₁₂C₁—Cl)”) under applied hydrostatic pressure with heating and cooling rates of 2 K min⁻¹ using He as the pressure-transmitting medium. FIG. 18(b) shows the pressure-temperature (P, 7) phase diagram determined from the isobaric HP-DSC experiments. Phase boundaries were determined for both heating (bottom) and cooling (top).

FIGS. 19(a) and 19(b) show example results of DSC measurements on (“C₉C₁—Cl”). FIG. 19(a) shows DSC measurements for (C₈H₁₇)(CH₃)NH₂Br (“C₈-C₁—Br”) under applied hydrostatic pressures (up to 80 bar) with heating and cooling rates of 2 K min⁻¹ using He as the pressure-transmitting medium. FIG. 19(b) shows the pressure dependence of heating transition temperatures up to 80 bar.

FIG. 20 shows example DSC measurements for (C₈H₁₇)(CH₃)NH₂Cl (“C₈C₁—Cl”) under ambient pressure with heating and cooling rates of 4 K min⁻¹ using N₂ as the pressure-transmitting medium.

FIG. 21 shows preliminary XRD experiments on (C₆H₁₃)(CH₃)NH₂X (X═Cl, Br) (“C₆C₁—X”). The powder X-ray diffraction indicates that these two compounds are isostructural, both featuring layered structures, where each organic cation is confined by hydrogen bonds with charge-balancing halide anions.

FIG. 22 shows example DSC measurements for (C₆H₁₃)(CH₃)NH₂Br (“C₆C₁—Br”) under ambient pressure with heating and cooling rates of 4 K min⁻¹ using N₂ as the pressure-transmitting medium.

FIGS. 23(a) and 23(b) show example DSC measurements for (C₆H₁₃)(CH₃)NH₂Br (“C₆C₁—Br”). FIG. 23(a) shows the DSC measurements under applied hydrostatic pressures (up to 80 bar) with heating and cooling rates of 2 K min⁻¹ using He as the pressure-transmitting medium. FIG. 23(b) shows the pressure dependence of heating transition temperatures up to 80 bar. Pressure sensitivity of major and minor transitions correspond to 41 K/kbar and 15 K/kbar, respectively.

FIGS. 24(a)-24(d) show an example of asymmetric dialkylammonium bromide salts [(CₙH₂ₙ₊₁)(C₆H₁₃)NH₂Br](n=2, 3, 4, 5; CₙC₆—Br) identified by mass spectrometry. FIG. 24(a) shows C₂C₆—Br. FIG. 24(b) shows C₄C₆—Br. FIG. 24(c) shows C₄C₆—Br. FIG. 24(d) shows C₅C₆—Br.

FIG. 25 shows example DSC measurements for (C₆H₁₃)(C₂H₅)NH₂Br (“C₆C₂—Br”) under ambient pressure with heating and cooling rates of 4 K min⁻¹ using N₂ as the pressure-transmitting medium.

FIGS. 26(a) and 26(b) show an example of a structural characterization of fluorinated asymmetric dialkylammonium salts using X-ray crystallography techniques. FIG. 26(a) shows the single-crystal structure of [(C₁₀H₂₁)NH₂(CH₂CF₁₉)]Br obtained at 100 K (viewed along b-axis) features a layered structure, where each organic cation is confined by charge-balancing Br anions. FIG. 26(b) shows powder X-ray diffraction patterns for (C₆H₁₃)NH₂(CH₂C₅F₁₁H₂)Br, (C₁₀H₂₁)NH₂(CH₂C₉F₁₉)Br, and (C₁₀H₂₁)NH₂(CH₂C₉F₁₉)I.

FIG. 27 shows example thermal characterization of fluorinated, asymmetric dialkylammonium bromide salt (C₁₀H₂₁)NH₂(CH₂C₉F₁₉)Br using differential scanning calorimetry.

FIG. 28 shows example characterization of fluorinated, asymmetric dialkylammonium bromide salt (C₁₀H₂₁)NH₂(CH₂C₉F₁₉)Br using mass spectrometry.

FIG. 29 shows example thermal characterization of an alkene-functionalized, asymmetric dialkylammonium bromide salt (C₁₀H₂₁)NH₂(C₁₀H₁₉)Br (with terminal alkene) using differential scanning calorimetry.

FIGS. 30(a)-(b) show an example characterization of the alkene-functionalized, asymmetric dialkylammonium bromide salt (C₁₀H₂₁)NH₂(C₁₀H₁₉)Br by mass spectrometry. FIG. 30(a) shows an example experimental mass spectrum stacked above a corresponding calculated isotope distribution pattern of the target asymmetric dialkylammonium bromide salt (C₁₀H₂₁)NH₂(C₁₀H₁₉)Br. FIG. 30(b) shows the full experimental mass spectrum of the asymmetric dialkylammonium bromide salt (C₁₀H₂₁)NH₂(C₁₀H₁₉)Br showing a lack of extraneous peaks thus indicating purity.

FIG. 31 shows example di-n-alkylammonium cations comprising the di-n-alkylammonium bromide salt series CₙC₁₀—Br, where the length of one alkyl substituent is fixed at 10 carbons and the length of the other alkyl substituent is denoted by n.

FIG. 32 shows example thermally induced phase transition behavior in CₙC₁₀—Br salts.

FIG. 33 shows example transition enthalpies, entropies, and temperatures for CₙC₁₀—Br salts that undergo a single, solid-solid phase transition. Salts are labeled by their respective n values on the plot above. n=5 and 7 have been omitted due to undergoing multiple transitions.

FIG. 34 shows example molar entropy changes in CₙC₁₀—Br salts as a function of n. n=5 and 7 have been omitted due to undergoing multiple transitions.

FIG. 35 shows example molar entropy changes vs. thermal hysteresis in CₙC₁₀—Br salts. Salts are labeled by their respective n values on the plot above. n=5 and 7 have been omitted due to undergoing multiple transitions.

FIG. 36 shows an example of an experimental determination of transition pressure sensitivity in C₁C₁₀—Br under a He environment.

FIG. 37 shows an example of an experimental determination of transition pressure sensitivity in C₂C₁₀—Br under a He environment.

FIG. 38 shows an example of an experimental determination of transition pressure sensitivity in C₉C₁₀—Br under a He environment.

FIG. 39 shows example 100 K structures of CₙC₁₀—Br salts for n=1, 2, and 9.

FIG. 40 shows example powder X-ray diffraction (PXRD) patterns of CₙC₁₀—Br salts collected at 30 °C. At 30 °C, salts are in the ordered phase for n=1, 2, 3, 4, 9, and 10; salts are in the disordered phase for n=5, 6, 7, and 8.

FIG. 41 illustrates an example overview of soft organic salts as refrigerants for solid-state barocaloric cooling and heat-pumping cycles. The illustration on the left depicts how the pressure dependence of hydrocarbon order-disorder transitions in soft organic salts (e.g., dialkylammonium halides) can be leveraged to drive a barocaloric cooling cycle. In this example, each cooling cycle begins with an adiabatic (Brayton-like cycle) increase in pressure that induces a first-order phase transition from an expanded, high-entropy phase to a contracted, low-entropy phase. In this example, heat released during this exothermic transition is dissipated to a heat sink, returning the material to its original temperature but now at a lower entropy. In this example, the pressure is then adiabatically or isothermally decreased to reverse the phase transition and cool a heat source. The illustration on the right features examples of soft organic salts, including dialkylammonium halides. Chain length, halide, and overall symmetry can be simultaneously tuned through synthetic chemistry. A range of anions (beyond halide), and chemical functionalization can be also introduced to further tune the phase-change thermodynamics of the soft organic salts.

FIG. 42 shows example dialkylammonium halides as organic analogs of two-dimensional (2-D) metal-halide perovskites. In 2-D perovskites, each alkylammonium cation can be confined within a plane defined by four axial halides from corner-sharing metal-halide octahedra. To maintain the chain packing in the absence of metals, one can conceptualize merging two axially adjacent halides with alkylammonium headgroups. Such structures can be found in a class of materials known as dialkylammonium halides. In this conceptual illustration, spheres represent transition metal, halide, carbon, and nitrogen atoms. Hydrogen atoms are omitted for clarity.

FIGS. 43(a)-43(e) show example hydrocarbon order-disorder phase transitions in dihexylammonium bromide at ambient pressure. FIG. 43(a) shows single-crystal structure of low-temperature phase of (C₆H₁₃)₂NH₂Br obtained at 100 K featuring non-interdigitated bilayers of hexyl chains. FIG. 43(b) shows thermally-induced hydrocarbon order-disorder transitions between ordered and disordered dihexylammonium chains in the Br plane involving changes in conformational and rotational degrees of freedom. The structures of the ordered and disordered phases were obtained from single-crystal X-ray crystallography (left) and density functional theory calculation (right). FIG. 43(c) shows variable-temperature powder X-ray diffraction (PXRD) patterns for (C₆H₁₃)₂NH₂Br at 1 bar of He obtained during cooling, with an X-ray wavelength of 0.45213 Å. FIG. 43(d) shows differential scanning calorimetry (DSC) traces for a powder sample of (C₆H₁₃)₂NH₂Br at 1 bar with heating (bottom) and cooling (top) rates of 2 K min⁻¹ obtained at ambient pressure. FIG. 43(e) shows, in this example, that specific volumes obtained from variable-temperature PXRD are used to measure the volume change, ΔVₜᵣ, that accompanies the order-disorder transition for (C₆H₁₃)₂NH₂Br, and to determine thermal expansivity (a) for both low-temperature (LT) and high-temperature (HT) phases.

FIGS. 44(a)-44(c) show an example of a series of experiments that characterize dihexylammonium halides. FIG. 44(a) shows isobaric entropy changes for (C₆H₁₃)₂NH₂X (X═Cl, Br, I), referred to as (Cₙ)₂X [(Cₙ)₂=dialkylammonium], are plotted as a function of temperature at ambient pressure, with a reference entropy (S₀) at 260 K, for heating and cooling transitions. Phase-change entropy values are shown in the inset. FIG. 44(b) shows powder X-ray diffraction (PXRD) patterns for the high-temperature (HT) phase at 320 K. Interlayer spacing calculated from the PXRD patterns are displayed. FIG. 44(c) shows a comparison of transition entropy changes (ΔSₜᵣ) and volume changes (ΔVₜᵣ) for hydrocarbon solid-solid transitions in 2-D perovskite (C₉)₂CuBr₄ (C₉=nonylammonium) and dialkylammonium halides (diamond symbols) and for melting transitions in n-alkanes (circles). The pressure sensitivity of phase transitions was calculated using the Clausius-Clapeyron relationship and indicated by shading from the bottom of gradient (low dTₜᵣ/dP) to the top of the gradient (high dTₜᵣ/dP).

FIGS. 45(a)-(c) show example phase transitions in dihexylammonium halides at applied pressure. FIG. 45(a) shows example differential scanning calorimetry (DSC) measurements under applied hydrostatic pressures for (C₆)₂Br with heating and cooling rates of 0.5 K min⁻¹. FIG. 45(b) shows an example pressure-temperature (P, T) phase diagram determined from the isobaric HP-DSC experiments for (C₆)₂C₁ (left), (C₆)₂Br (center), (C₆)₂I (right). Phase boundaries were determined for both heating (top) and cooling (bottom), with hysteresis region highlighted in between the heating and cooling traces. All isobaric HP-DSC experiments were carried out using He as the pressure-transmitting medium. FIG. 45(c) shows, in this example, the relationship between phase-change entropy (ΔSₜᵣ) and pressure hysteresis (ΔP_{hys}) for (C₆)₂X (X═Cl, Br, I). ΔP_{hys} values were calculated using experimentally determined thermal hysteresis (ΔT_{hys}) and pressure sensitivity (d Tₜᵣ/dP), with ΔP_{hys}=ΔT_{hys}×(dTₜᵣ/dP)¹. Note that both ΔSₜᵣ and ΔP_{hys} values exhibit a volcano trend.

FIGS. 46(a)-46(d) show an example quasi-direct analysis. FIG. 46(a) shows, in this example, isothermal entropy change (ΔSᵢₜ) calculated via the quasi-direct method for (C₆)₂C₁. FIG. 46(b) shows, in this example, isothermal entropy change (ΔSᵢₜ) calculated via the quasi-direct method for (C₆)₂Br. FIG. 46(c) shows, in this example, isothermal entropy change (ΔSᵢₜ) calculated via the quasi-direct method for (C₆)₂₁. In FIGS. 46(a)-46(c), the shaded area indicates the reversible isothermal entropy change (ΔSᵢₜ,rev) that can be accessible within each operating pressure. The temperature window over which ΔSᵢₜ,rev can be available is denoted by the bidirectional arrow for 150-bar operating pressure. ΔS_{it,direct} values measured from pressure swing experiments were compared with the isothermal entropy curves calculated from the quasi-direct analysis of isobaric HP-DSC experiments. FIG. 46(d) shows, in this example, the maximum reversible isothermal entropy change (ΔSit,rev,max) calculated from the quasi-direct analysis of isobaric HP-DSC measurements plotted against the operating pressure (ΔP). Reversible isothermal entropy changes are inaccessible at operating pressures below pressure hysteresis (ΔPhys). ΔPhys values determined from isobaric HP-DSC are represented by dashed lines for (C₆)₂C₁ (middle), (C₆)₂Br (bottom), and (C₆)₂I (top).

FIGS. 47(a)-47(f) show an example of direct evaluation of barocaloric effects in dihexylammonium halides.

FIG. 47(a) shows, in this example, direct evaluation of pressure-induced hydrocarbon transitions through quasi-isothermal differential scanning calorimetry (DSC) experiments for (C₆)₂Cl. FIG. 47(b) shows, in this example, direct evaluation of pressure-induced hydrocarbon transitions through quasi-isothermal DSC experiments for (C₆)₂Br. FIG. 47(c) shows, in this example, direct evaluation of pressure-induced hydrocarbon transitions through quasi-isothermal DSC experiments for (C₆)₂₁. In FIGS. 47(a)-47(c), heat flow signals were recorded over time during three cycles of applying and removing a hydrostatic pressure of 150 bar, with He as the pressure-transmitting medium. The pressure was increased linearly at a rate of 6 bar min⁻¹ and decreased asymptotically at an average rate of 13 bar min⁻¹. FIG. 47(d) shows, in this example, isothermal entropy changes directly measured from quasi-isothermal DSC (ΔS_{it,direct}) plotted against pressure cycle for (C₆)₂C₁. FIG. 47(e) shows, in this example, isothermal entropy changes directly measured from quasi-isothermal DSC (ΔS_{it,direct}) plotted against pressure cycle for (C₆)₂Br. FIG. 47(f) shows, in this example, isothermal entropy changes directly measured from quasi-isothermal DSC (ΔS_{it,direct}) plotted against pressure cycle for (C₆)₂₁. In FIGS. 47(d)-47(f), ΔS_{it,direct} values were calculated using ΔS_{it,direct}=q_{direct}/Tₛₑₜ, where q_{direct} and Tₛₑₜ denote the area under heat flow peak and set temperature for the pressure swing, respectively.

FIG. 48 shows example reversible barocaloric effects. Heat flow signals obtained from pressure swing differential scanning calorimetry (DSC) experiments are plotted as a function of pressure for (C₆)₂C₁ (top) and (C₆)₂I (bottom), with compression-induced exotherms (solid lines) and decompression-induced endotherms (dashed lines) obtained at average rates of 6 bar min⁻¹ and 13 bar min⁻¹, respectively. Onset pressures for compression-induced exotherms and decompression-induced endotherms are denoted by circles. Pressure hysteresis, calculated as the difference between the onset pressures, is indicated by bidirectional arrows.

FIGS. 49(a)-49(c) show example high-pressure powder X-ray diffraction (PXRD) patterns and Raman spectra. FIG. 49(a) shows, in this example, variable-temperature PXRD patterns for (C₆)₂Br under 300 bar of He, obtained during cooling with an X-ray wavelength of 0.45213 Å. The onset temperature for the contracting ordering transition is indicated by a dashed line. FIG. 49(b) shows variable-pressure Raman spectra, collected during compression-decompression cycle between 1 bar and 1000 bar for (C₆)₂Br at 312 K, with water as the pressure-transmitting medium. The spectra for C—H stretching regions are shown, with onset pressures for compression-induced ordering and decompression-induced disordering transitions highlighted by circles embedded along the vertical arrows on the right edge of the graph. FIG. 49(c) shows, in this example, high-pressure PXRD and Raman experiments extend the pressure-temperature (P, T) phase diagram for (C₆)₂Br up to 1,000 bar. Onset temperatures and pressures identified from PXRD and Raman experiments are in agreement with the phase boundaries determined from isobaric HP-DSC.

FIGS. 50(a) and 50(b) show an example nanocalorimetry experiment. FIG. 50(a) shows in this example a hydrocarbon phase transition in a thin-film sample of (C₁₀)₂Br [(C₁₀)₂=didecylammonium] investigated by nanocalorimetry with a heating rate of 3500 K s⁻¹ under vacuum over 11,000 cycles. An optical image of the sample directly deposited onto the nanocalorimetry sensor used in this example is displayed in the inset (scale bar=500 μm). FIG. 50(b) shows in this example that heating-induced endothermic transitions persisted throughout thermal cycling, albeit with a small decrease in the transition peak area. Note that the attenuation of the heat flow signal arises from sublimination of the sample and not material fatigue.

FIG. 51 shows an example where thermal energy storage mechanism can leverage pressure sensitivity and thermal hysteresis. The transition temperature of dialkylammonium halide salts can be tuned through the application of pressure, as described in the pressure-temperature phase diagram of (C₆)₂Br [(C₆)₂=dihexylammonium](left). The tunable transition temperature can be utilized to enhance the performance of thermal storage. In the case of (C₆)₂Br [(C₆)₂=dihexylammonium], the compound can store energy near ambient temperature (23 °C) at a pressure of 150 bar. The stored energy is observed to be robust across a range of conditions (1-150 bar; 16-23 °C) near ambient environment. Because of the thermal hysteresis, the material can be cooled to 16 °C during decompression without releasing the stored heat (dashed arrow). Around ambient condition, the stored heat can be released upon the application of pressure (solid arrow). This storage mechanism can be demonstrated using high-pressure calorimetry experiment over three cycles (right). Through this mechanism as described in this example, dialkylammonium halides can store heat when the external environment is hot and release heat on-demand, when the external environment is cold.

FIG. 52 shows an example comparison of phase-change entropies (ΔSₜᵣ) and transition temperature (Tₜᵣ) for n-alkanes (melting transitions), 2-D perovskites (solid-solid transition; square symbols), and dialkylammonium halides (solid—solid transition; diamond symbols). A vaporization entropy of a gas refrigerant R134a is shown as a reference.

FIG. 53 shows example chain length dependence of molar transition entropies for (Cₙ)₂Cl (top), (Cₙ)₂Br (middle), and (Cₙ)₂I (bottom). The linear increase of transition entropy (ΔSₜᵣ) may suggest that the phase transition in dialkylammonium halides may be driven by conformational disorder.

FIG. 54 shows example variable-temperature powder X-ray diffraction (PXRD) patterns collected at 1 bar of He, with an X-ray wavelength of 0.45213 Å during cooling for [(C₆H₁₃)₂NH₂Cl](denoted here as dC₆Cl; top). In this example, temperature dependence of specific volume was plotted (bottom).

FIG. 55 shows example variable-temperature powder X-ray diffraction (PXRD) patterns collected at 1 bar of He, with an X-ray wavelength of 0.45213 Å during cooling for [(C₆H₁₃)₂NH₂₁](denoted here as dC₆I; top). In this example, temperature dependence of specific volume was plotted (bottom).

FIG. 56 shows example variable-temperature powder X-ray diffraction (PXRD) patterns collected at 1 bar of He, with an X-ray wavelength of 0.45213 Å during cooling for [(C₆H₁₃)₂NH₂Br](denoted here as dC₆Br; left), (C₈H₁₇)₂NH₂Br](denoted here as dC₈Br; center), and [(C₁₀H₂₁)₂NH₂Br](denoted here as dC₁₀Br; right). In this example, temperature dependences of specific volumes were plotted (bottom).

FIG. 57 shows example phase stabilities of [(C₆H₁₃)₂NH₂X](X═Cl, Br, I) probed by differential scanning calorimetry. These compounds can undergo high-entropy solid-solid transitions near ambient temperature and melt/decompose around 500 K.

FIG. 58(a) shows an example variable-temperature bright field optical microscope images of a thin film of (C₆)₂Br grown at 20 °C; the dashed boxes represent the area measured by atomic force microscopy (AFM) force spectroscopy. FIG. 58(b) shows an example variable-temperature dark field optical microscope images of a thin film of (C₆)₂Br grown at 20 °C. FIG. 58(c) shows, in an example, variable-temperature topographical maps of the denoted region measured by AFM force spectroscopy; in this example, upon heating, a 175-nm feature is visible in the scan region due to in-plane thermal expansion and contraction. FIG. 58(d) shows example elastic modulus topographical maps of the denoted region measured by AFM force spectroscopy; in this example, upon heating, a 175-nm feature is visible in the scan region due to in-plane thermal expansion and contraction.

FIG. 59(a) shows an example histogram of 13,056 elastic modulus values from mechanical maps of the film at each temperature, showing softening of the material upon heating; in this example, the 20 °C histogram has a greater spread of values as the film was grown in a metastable state partway through the phase transition.

FIG. 59(b) shows example force-distance curves measured by AFM force spectroscopy at each temperature and fit by the Hertz model.

FIG. 60 shows an example comparison of transition entropy, ΔSₜᵣ, and reversible pressure, ΔPᵣₑᵥ, for certain barocaloric materials. ΔPᵣₑᵥ refers to the minimum pressure required to achieve a reversible entropy change, and is calculated as ΔPᵣₑᵥ=ΔT_{hys}|dT/dP|(ΔT_{hys}=thermal hysteresis). The example comparison shows that dialkylammonium halides can represent a unique class of materials that display both large entropy changes (>200 J K⁻¹ kg⁻¹) and high reversibility (ΔPᵣₑᵥ ~100 bar).

### DETAILED DESCRIPTION

Barocaloric effects originate from the coupling between degrees of freedom and volume of the lattice. A barocaloric effect or cycle can be a conventional barocaloric effect or cycle or an inverted barocaloric effect or cycle. In conventional barocaloric materials, increase in internal degrees of freedom can be accompanied by volume expansion. This coupling, which can be strong for materials that undergo first-order phase transitions, can allow the materials to undergo transitions between a low-entropy (contracted) state at high pressure and a high-entropy (expanded) state at low pressure. The pressure-driven switching between the two entropic states can give rise to thermal changes-which can manifest as temperature changes under adiabatic conditions (ΔT_{ad}) or as entropy changes under isothermal conditions (ΔSₜ). When driven by cyclic changes in pressure, the solid-state refrigerants can pump heat from a low-temperature heat source to a high-temperature heat sink, through the thermal changes.

Driving strong conventional barocaloric effects at low operating pressures, although critical to achieving high efficiency and scalability, is still challenging. This is primarily because it has been tremendously difficult to identify a phase transition that features the combination of large entropy change, high pressure sensitivity, and low hysteresis.

In an inverted barocaloric effect, a PTM can directly interact with the barocaloric material (for example by being absorbed in the organic layers). Compression of the barocaloric material can induce an endothermic order-to-disorder transition. Decompression can induce an ordering transition. The solubility of PTM molecules can be larger for an expanded or disordered phase of the material. Because the solubility increases in proportion to PTM pressure, compression can drive the disordering transition. In some embodiments, a barocaloric effect can result in a barocaloric material undergoing a volume contraction upon transition to a higher entropy phase, or it can result in a volume expansion upon transition to a higher entropy phase. In some embodiments, a barocaloric material can comprise a lattice structure. The lattice structure can comprise a lattice volume. A disordering transition can be accompanied by an increase in lattice volume or a decrease in lattice volume.

Hydrocarbon chains—when molecularly aligned on a 2-D array—may present unique chemical environments that are particularly well-suited for promoting strong barocaloric effects. The flexibility of hydrocarbon chains imparts an exceedingly large number of degenerate configurations to the lattice, and the 2-D nature of the confined chains can tightly couple the structural degrees of freedom to volume.

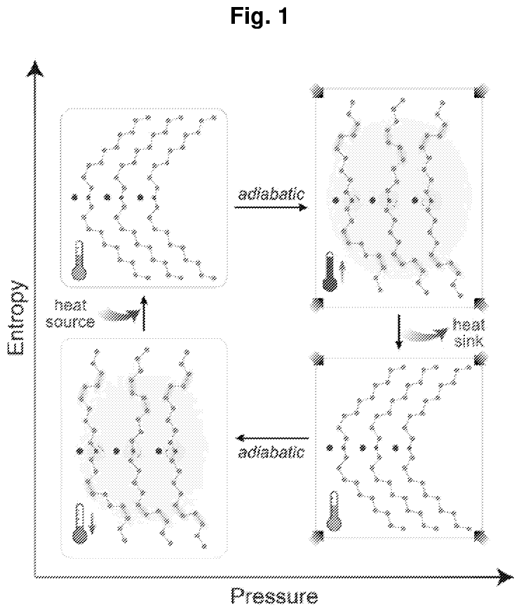

In a caloric cooling cycle, the stimulus is applied to a caloric material to induce a phase change, which is accompanied by a large increase in temperature (FIG. 1). Once the temperature has re-equilibrated, the stimulus is removed, reverting the caloric material to its original phase and lowering its temperature.

Because these phase transitions occur entirely in the solid state, refrigeration cycles can be achieved without using a volatile fluid. Barocaloric materials can undergo pressure-induced thermal changes. As such, barocaloric materials offer a simple and energy-efficient method to achieve solid-state cooling.

Barocaloric materials can comprise, for example, natural rubbers, shape-memory alloys, fast-ion conductors, and plastic crystals. Some barocaloric materials suffer from low thermodynamic efficiencies, lack of mechanical durability, and the need to operate at non-ambient temperatures.

A barocaloric material can comprise a matrix. A barocaloric material can comprise a soft organic material.

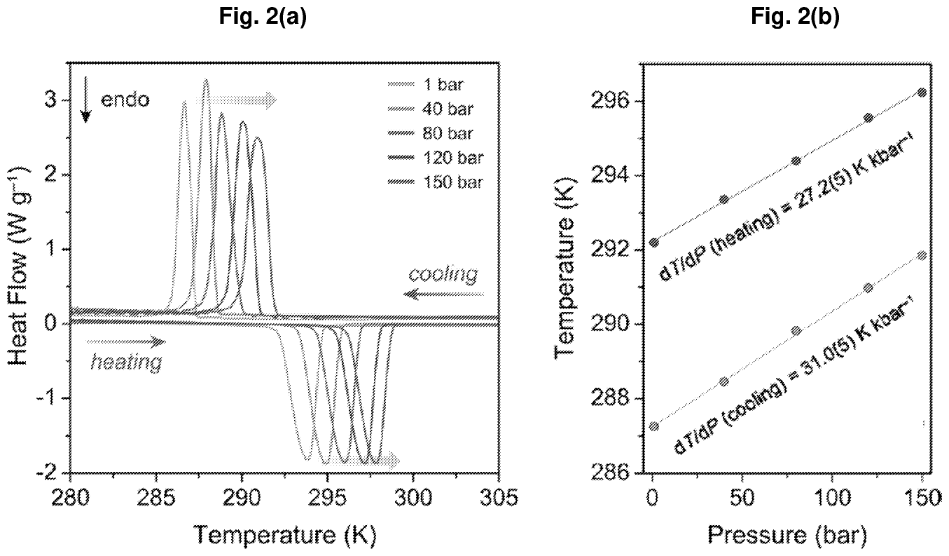

In some embodiments, the matrix can comprise a soft organic material. Soft organic materials, which contain bilayers of long-chain organic cations linked through charge-assisted hydrogen bonds to charge-balancing anions, feature tremendous structural and chemical diversity through judicious selection of the cationic and anionic moieties that constitute each material. Importantly, many of these compounds undergo thermally induced, solid-solid phase transitions near room temperature between low-entropy, low-temperature and high-entropy, high-temperature states driven by conformational disordering-effectively a partial melting transition in the solid state—of the hydrocarbon bilayers (FIGS. 2(a)-2(b)). As these order-disorder transitions involve substantial entropy changes (>300 J kg−1 K−1) and large volume changes (7-10%), that applying and removing pressure cyclically may lead to colossal di-alkylammonium halides (CₙH₂ₙ₊₁)₂NH₂X (X═Cl, Br, I)-denoted here as dCₙX-soft organic materials that feature bilayers of cationic alkyl chains, each of which is confined through hydrogen bonding with halides.

### Soft Organic Salts

In some embodiments, a soft organic salt may have the general formula (I):

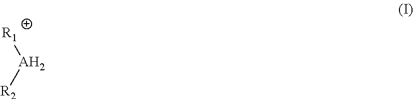

and a counterion,
where R₁ and R₂ are optionally substituted polyfluorocarbyl (e.g., perfluoroalkyl) or hydrocarbyl (e.g., alkyl) groups, and A=N or P. In some embodiments, a counterion can be a mixture of multiple anions. In some embodiments, the counterion is a monoanionic counterion (e.g., a halide (e.g., F—, Cl—, Br—, or I—), an alkyl or polyfluoroalkyl sulfonate (e.g., triflate), a carboxylate (e.g., an alkanoate, e.g., ethanoate, propanoate, etc.), NO₃—, ClO₃—, ClO₄—, H₂PO₄—, HSO₄—, CN—, HCOO—, N₃—, N(CN)₂—, BF₄—, BH₄—, PF₆—, SCN—, OCN—, or a combination thereof. In some embodiments, the counterion is a polyanion (e.g., a dianion or trianion). In some embodiments, a soft organic salt may be an ammonium or phosphonium salt. R₁ and R₂ may be the same or different. For example, R₁ and R₂ may be alkyl groups of different lengths, or one of R₁ or R₂ may include a different functional group (e.g., a carbon-carbon double or triple bond, an alcohol, an aryl group, an ether or thioether, an ester or thioester, etc.). Alternatively, or in addition, one of R₁ or R₂ may be a polyfluorocarbyl group (e.g., a perfluoroalkyl group) and the other a hydrocarbyl group (e.g., an alkyl group). At least one of R₁ and R₂ may include an optionally substituted C_{≥3} (e.g., C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, etc.) hydrocarbyl or polyfluorocarbyl chain. The difference in chain length (e.g., in the longest chain length counted from ‘A’) of R₁ and R₂ may be, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 25 atoms (e.g., carbon atoms, or alternatively, carbon, oxygen, sulfur atoms, e.g., when one or both of R₁ or R₂ includes O or S atoms in the chain, e.g., a polyethylene glycol). In particular embodiments, R₁ is Me or F₃C—, and R₂ is an optionally substituted C₃ hydrocarbyl or polyfluoroalkyl. R₁ and/or R₂ may be a polyether or polythioether, i.e., where two or more methylene or perfluoromethylene subunits of R₁ and/or R₂ are separated by an O or S, e.g., a polyethylene glycol (or polythioethylene) chain. Hydrocarbyl or polyfluorocarbyl chains may include one or more (e.g., 1, 2, 3, 4, 5, 6, 7, 8, 9, 10, 11, 12, 13, 14, 15, 16, or 17)C—C double bonds (e.g., alkenyl groups). Hydrocarbyl or polyfluorocarbyl chains may include one or more (e.g., 1, 2, 3, 4, etc.)C—C triple bonds (i.e., alkynyl groups). Double or triple bonds may be between any two consecutive C atoms in a chain, e.g., the terminal two C atoms. Double or triple bonds may be in the main chain or in a side chain.

In some embodiments, a soft organic salt composition may have a formula: (CₙH₂ₙ₊₁)(CₘH₂ₘ₊₁)AH₂X, wherein A=N or P, X=a counterion (which may be monoanionic or polyanionic), wherein m is 4-33 and n is 7-36, and wherein n−m≥3. Alternatively, compounds described herein may have a formula: (CₙH₂ₙ₊₁)(CH₂CₘF₂ₘ₊₁)AH₂X or (CₙH₂ₙ₊₁)(CₘF₂ₘ₊₁)AH₂X; where A=N or P, X=a counterion (which may be monoanionic or polyanionic), and where m is 1-36 and n is 1-36. Alternatively, compounds described herein may have a formula: (CₙH₂ₙ₊₁)(CₘH₂ₘCH═CH₂)AH₂X, where A=N or P, X=a counterion (which may be monoanionic or polyanionic), and where m is 1-34 and n is 1-36.

In some embodiments, a soft organic salt composition can include: (C₆H₁₃)NH₂(CH₃)Br, (C₈H₁₇)NH₂(CH₃)Br, (C₁₀H₂₁)NH₂(CH₃)Br, (C₁₂H₂₅)NH₂(CH₃)Br, (C₆H₁₃)(CH₃)NH₂Cl, (C₈H₁₇)(CH₃)NH₂Cl, (C₁₂H₂₅)(CH₃)NH₂Cl, (C₆H₁₃)NH₂(CH₂C₅F₁₁H₂)Br, (C₁₀H₂₁)NH₂(CH₂C₉F₁₉)Cl, (C₁₀H₂₁)NH₂(CH₂C₉F₁₉)Br, (C₁₀H₂₁)NH₂(CH₂C₉F₁₉)I, (C₁₀H₂₁)NH₂(C₁₀H₁₉)Br, (C₂H₅)NH₂(C₆H₁₃)Br, (C₃H₇)NH₂(C₆H₁₃)Br, (C₄H₉)NH₂(C₆H₁₃)Br, (C₅H₁₁)NH₂(C₆H₁₃)Br, or (C₁₂H₂₅)(CH₃)NH₂Cl. A soft organic salt composition can also include these compounds with a different counterion, for example, a counterion listed herein.

In certain embodiments, the compound of formula (I) does not have the formula: (CₙH₂ₙ₊₁)(CₘH₂ₘ₊₁)NH₂X, where n is 1-3 or 4-36 and m=4-36 and where X is a monoanionic species. In some embodiments, the compound of formula (I) is not (C₁₂H₂₅)(CH₃)NH₂Br or (C₁₂H₂₅)(CH₃)NH₂Cl.

Soft organic salts may form layered structures, e.g., where the organic cation is spatially confined by H-bonds or coulombic effects by the charge-balancing counterions. The layered structures may form or be incorporated within a matrix.

The matrix may be incorporated into any suitable form, for example, a foam (e.g., an open-celled foam), a powder (e.g., a fluidized powder), pellets, a surface coating (e.g., on one of the other forms described herein), beads (e.g., beads of the barocaloric material, or multilayered beads having the barocaloric material as a component, e.g., as a coating), a frit (e.g., sintered pellets, beads, particles, powder, etc., having high porosity, or e.g., a frit of another sintered material, such as ceramic or metal, having a coating of the barocaloric material), crystals, a porous gel, a packed column, etc.

Barocaloric materials including the matrices and organic salts described herein may be shaped using one or more additives, e.g., binders, thermally conductive additives (e.g., graphite flakes), etc. Barocaloric materials may be provided in a physical form that affords high surface area while allowing for fluid flow.

Barocaloric materials including the matrices and organic salts described herein may also be provided in a form that confers high thermal conductivity.

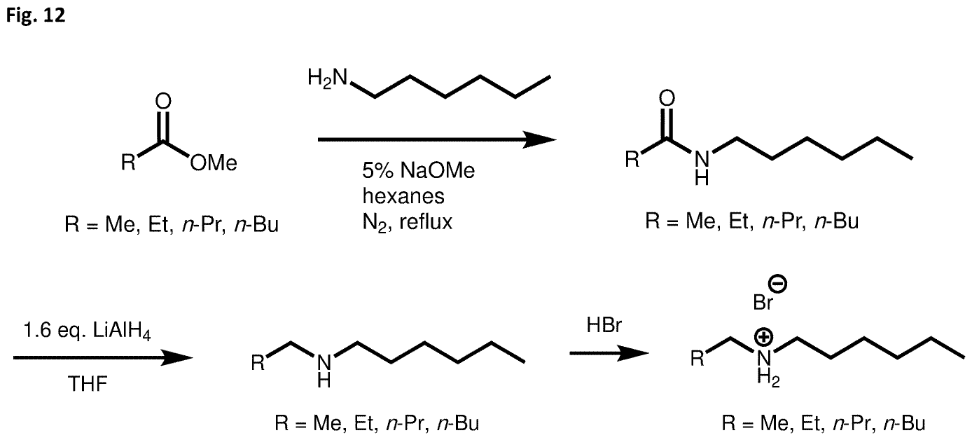

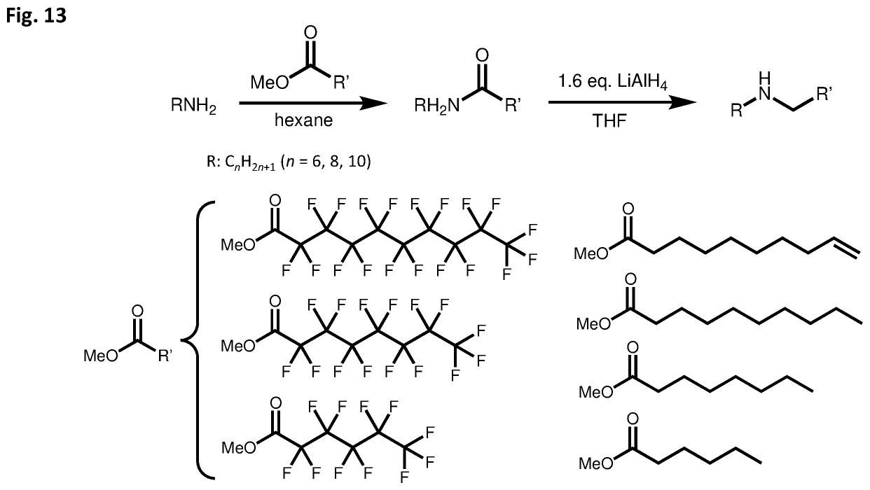

Asymmetric soft organic ammonium salts may be synthesized as shown in FIGS. 12 and 13. Briefly, a primary amine undergoes a condensation reaction with a base-deprotected hydrocarbyl or polyfluorocarbyl ester to produce an amide, which is then reduced to form a secondary amine.

Subsequent reaction with an acid (e.g., HBr) affords the salt. The variety of primary amines, esters, and acids available can allow for many possible soft organic salts to be prepared by this method. Phosphonium salts can also be prepared.

### Pressure Transmitting Medium (PTM)

A PTM can be a fluid. In some embodiments, a PTM can be a gas. In some embodiments, a PTM can be a liquid. In some embodiments, a PTM can comprise an inert gas or a fluorinated gas. In some embodiments, a PTM can comprise a perfluorocarbon, an ionic liquid, an aqueous solution, an aqueous salt solution, or a combination thereof.

PTMs may induce changes in thermal properties of materials with long alkyl chains (e.g., soft organic salts) by permeating into and interacting with or being dissolved in the materials of the composition, e.g., by permeating into free volume in the organic layer. PTMs that can permeate into the composition can be inert gases that can also interact with the composition at the microscopic level (e.g., non-covalently interact, e.g., via van der Waal's-type interactions, e.g., via dispersion forces). Both the extent of permeation (e.g., amount of gas molecules in the free volume/interacting with the composition) and degree and nature of interaction (e.g., strength of interaction, e.g., determined by a molecule or atom's size, shape, polarizability, etc.) can determine the effect of the PTM on thermal transitions of the composition. PTMs can include nitrogen, argon, krypton, xenon, neon, methane, ethane, propane, cyclopropane, chloroform, dichloromethane, butane, 2-methylpropane, sulfur hexafluoride, or carbon dioxide. Other gases include ethylene, nitrous oxide, anesthetic gases (e.g., halothane, isoflurane, desflurane, sevoflurane), acetylene, hydrofluorocarbons (e.g., R-134a), hydrofluoroolefins (e.g., HFO-1234ze) and nonhalogenated ethers (i.e., diethyl ether). The PTM may not be a gas; for example, PTM liquids include an oil (e.g., a fluorocarbon oil, silicone oil, etc.), liquid hydrocarbons (e.g., pentane, hexane), alcohols (e.g., methanol, ethanol), alkylsilane (e.g., Daphne 7474), perfluorocarbons (e.g., Fluorinert). ionic liquids, and aqueous salt solutions, e.g., liquid hydrocarbons (e.g., pentane, hexane), alcohols (e.g., methanol, ethanol), alkylsilane (e.g., Daphne 7474), perfluorocarbons, ionic liquids, and aqueous salt solutions.

In some embodiments, a pressure-transmitting medium (PTM) can comprise CO2, ethane, propane, n-butane, 2-methylpropane, n-pentane, ethene, propene, or a combination thereof.

In some embodiments, the pressure transmitting medium comprises a gaseous refrigerant. In some embodiments, the gaseous refrigerant increases in temperature when compressed, or undergoes an exothermic gas-to-liquid phase transition when compressed. In some embodiments, the gaseous refrigerant decreases in temperature when expanded, or undergoes an endothermic liquid-to-gas phase transition when expanded. In some embodiments, the gaseous refrigerant comprises CO2, ethane, propane, n-butane, 2-methylpropane, n-pentane, ethene, propene, hydrofluorocarbons, or a combination thereof.

In some embodiments, a pressure-transmitting medium (PTM) can comprise an oil, a liquid hydrocarbon, an alcohol, a perfluorocarbon, an ionic liquid, an aqueous solution, an aqueous salt solution, or a combination thereof. In some embodiments, a PTM can comprise fluorocarbon oil, silicone oil, pentane, hexane, methanol, ethanol, alkylsilane (e.g., Daphne 7474), perfluorocarbon (e.g., Fluorinert), water, hydraulic oil, mercury (Hg), mineral oil, glycerin, ethylene glycol, transformer oil, kerosene (a mixture of hydrocarbons), a hydrocarbon, silicone grease, liquid ammonia, liquid nitrogen, sodium-potassium alloy, gallium, indium, a liquid crystal, polyalphaolefin, liquid paraffin, an alkane, grease, petroleum jelly (e.g., Vaseline), phosphate ester, polyol ester, propylene glycol, brake fluid, automatic transmission fluid, vegetable oils (e.g., canola oil, olive oil), synthetic oils, corn syrup, or a combination thereof.

In some embodiments, the pressure transmitting medium comprises a gas, an inert gas, a fluorinated gas, a liquid, a supercritical fluid, an ionic liquid, an aqueous salt solution, a liquid hydrocarbon, an alcohol, an oil, a perfluorocarbon, or a combination thereof. In some embodiments, the pressure transmitting medium comprises nitrogen, argon, krypton, xenon, methane, ethane, propane, butane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, water, ethylene glycol, an alcohol, an ionic liquid, or a combination thereof. In some embodiments, the pressure transmitting medium comprises nitrous oxide, cyclopropane, chloroform, dichloromethane, halothane, isoflurane, desflurane, sevoflurane, acetylene, R-134a, HFO-1234ze, diethyl ether, ethylene, or a combination thereof. Alternatively, a pressure transmitting medium may not permeate or induce changes in the provided materials or systems.

### Heat Transfer Fluids

In some embodiments described herein, the transfer of heat energy can be facilitated by a heat transfer medium. In some embodiments, the heat transfer medium can be a heat transfer fluid. In some embodiments, the transfer of heat can result in a heating or cooling effect. In some embodiments, the transfer of heat can provide heat energy to a matrix. In some embodiments, the transfer of heat can remove heat energy from a matrix. In some embodiments, the heat transfer fluid can circulate through the matrix. In some embodiments, a heat transfer fluid can further comprise an additive to enhance thermal conductivity.

A heat transfer fluid can comprise ethylene glycol, propylene glycol, eutectic mixtures of biphenyl and diphenyl oxide (e.g., Dowtherm A, Therminol), silicone oil, mineral oil, polyalphaolefins (PAO), pentaerythritol tetraalkanoates, hydrogenated terphenyls, diphenyl ether, biphenyl, mineral oil (e.g., Paratherm), perfluoropolyether (e.g., Galden), perfluoroalkanes (e.g., Fluorinert), molten salts (e.g., Hitec), potassium formate (e.g., Dynalene), mono- and dibenzyltoluene (e.g., Marlotherm), NaK (sodium-potassium alloy), a eutectic salt, refrigerants (such as R-134a, R-41 Oa, R-22), or a combination thereof.

In some embodiments, a thermal transfer fluid can further comprise an additive, wherein the additive can comprise nanoparticles (e.g., Al₂O₃, CuO, SiC, TiO₂), carbon nanotubes, graphene, graphite, metallic particles, boron nitride, diamond powder, carbon black, fullerene, hydrotreated mineral oils, organosilanes, polymeric stabilizers, surfactants, antioxidants, anti-foaming agents, corrosion inhibitors, or a combination thereof.

### Methods

The methods provided herein may be used in heat energy transfer, e.g., in cooling or heating, or heat energy storage.

In some embodiments, the methods may include providing heat energy (e.g., from a room, an AC system, heat transfer medium, heat pump, heat sink, etc.) to a composition (e.g., a soft organic salt). The heat energy may cause alkyl chains in the composition to undergo a phase transition (e.g., from an ordered to a disordered state, e.g., in a thermal energy storage system) or there may be no phase transition until pressure is applied (e.g., in a barocaloric cooling system). Methods may be applied to refrigeration or heating.

In a conventional barocaloric system (e.g., a cooling or heating system) or method, providing compression to the composition may release latent heat in the composition, which may be removed, e.g., via a heat sink, e.g., a high surface area, high conductivity medium in thermal contact with the composition which may be itself cooled by, e.g., a fan. Removal of the heat is performed while the composition is still compressed, and removal of the compression allows the composition to return to a disordered state, cooling the composition as the endothermic transition occurs. At this point the cycle may be repeated with input of new heat energy.

When compression is applied to induce a barocaloric effect, the compression may be less than 100 bar (e.g., less than 30 bar, e.g., 1-30 bar, 20-50 bar, 30-60 bar, 50-75 bar, 70-100 bar, 90-100 bar, e.g., about 50 bar, 40 bar, 30 bar, 10 bar, 5 bar, or 1 bar). In some embodiments, the composition can be compressed at a pressure range of about 100 bar to about 2,000 bar. In some embodiments, the composition can be compressed at a pressure range of about 100 bar to about 200 bar, about 100 bar to about 300 bar, about 100 bar to about 500 bar, about 100 bar to about 1,000 bar, about 100 bar to about 1,500 bar, about 100 bar to about 2,000 bar, about 200 bar to about 300 bar, about 200 bar to about 500 bar, about 200 bar to about 1,000 bar, about 200 bar to about 1,500 bar, about 200 bar to about 2,000 bar, about 300 bar to about 500 bar, about 300 bar to about 1,000 bar, about 300 bar to about 1,500 bar, about 300 bar to about 2,000 bar, about 500 bar to about 1,000 bar, about 500 bar to about 1,500 bar, about 500 bar to about 2,000 bar, about 1,000 bar to about 1,500 bar, about 1,000 bar to about 2,000 bar, or about 1,500 bar to about 2,000 bar. In some embodiments, the composition can be compressed at a pressure range of about 100 bar, about 200 bar, about 300 bar, about 500 bar, about 1,000 bar, about 1,500 bar, or about 2,000 bar. In some embodiments, the composition can be compressed at a pressure range of at least about 100 bar, about 200 bar, about 300 bar, about 500 bar, about 1,000 bar, or about 1,500 bar. In some embodiments, the composition can be compressed at a pressure range of at most about 200 bar, about 300 bar, about 500 bar, about 1,000 bar, about 1,500 bar, or about 2,000 bar.

In a barocaloric thermal energy storage system, heat energy is provided to a composition (e.g., a soft organic salt) causing it to undergo a phase transition to a disordered state. The disordered state is then modified by a change in the applied pressure in order to change the temperature at which heat is released.

In some embodiments, the methods may include providing heat energy (e.g., from a room, an AC system, heat transfer medium, heat pump, heat sink, etc.) to a composition including a PTM and a matrix as described herein. The composition is under compression and in a disordered state where PTM atoms or molecules have permeated the matrix. Decompression of the composition allows for a transition to an ordered state with exothermic release of heat.

Released heat in the composition may be removed, e.g., via a heat sink, e.g., a high surface area, high conductivity medium in thermal contact with the composition which may be itself cooled by, e.g., a fan.

Removal of the heat is performed while the composition is decompressed. Recompression allows the matrix to return to a disordered state, cooling the composition as the endothermic transition occurs. At this point the cycle may be repeated with input of new heat energy.

In some embodiments, the methods may also include selecting or otherwise controlling the pressure transmitting medium to modulate the barocaloric cycle. For example, selecting a gas (e.g., a high polarizability gas) that sufficiently permeates and interacts with the composition at the microscopic level as the PTM to change the temperature of phase transitions in the barocaloric material, or to induce inverted barocaloric effects. Methods may include modulating the barocaloric cycle by altering a ratio of polarizable and on-polarizable PTM materials (e.g., gases) used as a mixed in a PTM. Methods may include selecting a PTM that does not interact, or minimally interacts, with the composition, e.g., to not induce changes in thermal properties, or to revert changes caused by an interacting gas.

### Systems and Additional Components

In some embodiments, a system is provided. A system may include components to provide compressive force to the composition, e.g., pumps, pistons, actuators (e.g., mechanical, hydraulic, or pneumatic, etc., actuators), presses (e.g., mechanical, hydraulic, or pneumatic, etc., presses), piezoelectric actuators, levers, etc. Systems may also include components to transfer or remove heat energy, e.g., pumps, heat sinks, thermoelectrics, fans, chiller pumps, etc. A system may also include a power source, e.g., to power the source of compressive force, the cooling or heat transfer components, etc. A system may include a pressure transmitting medium (PTM), e.g., a gas. The PTM may be a non- or minimally-interacting gas (e.g., a low polarizability gas, e.g., He) or a polarizable gas (e.g., nitrogen, argon, krypton, xenon, methane, ethane, propane, butane, 2-methylpropane, sulfur hexafluoride, or carbon dioxide.). Other PTMs are described herein.

A system may include a pump for controlling a pressure transmitting medium (e.g., a mixture of gases), such as pumps, gas reservoirs (e.g., tanks, cylinders, etc.), pressure sensors, actuators, valves, etc. The PTM may not be a gas, for example, the PTM may be an oil, e.g., a fluorocarbon oil, silicone oil, etc.).

In general, systems may include a chamber to hold the composition, reservoirs in thermal contact with a heat sink and a heat source, tubing or other fluidic channels to create flow paths between the reservoirs and thermal contact with the chamber, and a pressure source. Additional reservoirs and sub paths may be present as described herein.

### Material Processability

In some embodiments, the barocaloric materials described herein can comprise soft organic salts. In some embodiments, the soft organic salts can be dissolved in a solution. In some embodiments, the soft organic salts can be solution processable. In some embodiments, solution processable materials can be materials that can be deposited on a substrate. In some embodiments, the soft organic salts described herein can be deposited on a substrate.

Soft organic salts described herein can be grown into crystalline films on a substrate, wherein the substrate can be a metallic surface. The soft organic salts, when deposited on a substrate, can modulate thermal properties of the substrate. In some embodiments, the soft organic salts can be thermally active.

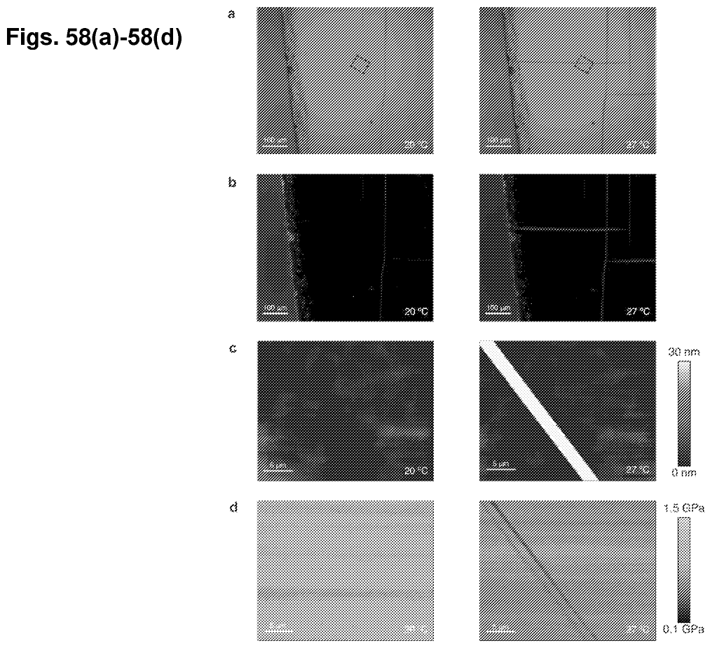

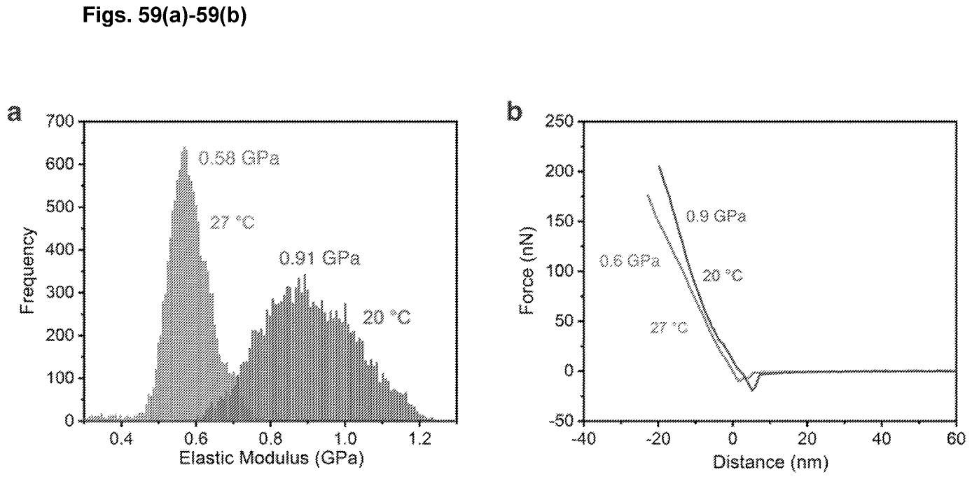

In some embodiments, the soft organic salts can be pressure sensitive. In some embodiments, the soft organic salts can be both thermally active and pressure sensitive. FIGS. 58 and 59 illustrate examples of soft organic salt deposition onto a substrate. In some embodiments, the soft organic salts can be deposited onto a heat exchanger, a pipe, a tank, a thermally conductive scaffold (carbon-based or metal-based), or a combination thereof.

The substrate can be a matrix (e.g., binders), other barocaloric material (e.g., shape-memory alloys), thermally conductive additive, or heat exchanger. The substrate can further comprise an additive that can improve a thermal conductivity of the substrate. Such an additive can comprise aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and its derivatives (such as MWCNT with exposed functional groups (—COOH, —NH₂, —OH)), graphene oxides (GO), hybrid graphene aerogels (HGA) that contain both GO and GNP, sulphonated graphene (SG), graphite foams, carbon nanofibers (CNF), metallic nanoparticles, porous metais, graphene/ceramic composites, metal nanoparticles (such as silver nanoparticles), metallic particles/beads, or a combination thereof. In some embodiments, soft organic salts can be deposited on a substrate further comprising an additive that can improve thermal conductivity of the substrate.

### EXAMPLES

### Example 1—Symmetric Soft Organic Salts

dC₆Br was chosen as a representative example and investigated its phase transition at ambient pressure (FIGS. 2(a)-(b) and 3(a)-3(c)). As shown by differential scanning calorimetry (DSC) traces in FIGS. 2(a)-(b), the crystalline powder of dC₆Br undergoes thermally induced phase transitions at the transition temperature, Tₜᵣ, of 19 °C (during heating), with entropy change for the transition (ΔSₜᵣ) of 300 J K⁻¹ kg⁻¹ (78 K⁻¹ mol⁻¹). This result, supported by a low melting entropy of 20 J K⁻¹ mol⁻¹ and relatively high melting point of 250 °C, illustrates that a substantial fraction of lattice disordering occurs upon solid-solid phase transition, rather than melting transition. In addition, molar ΔSₜᵣ for dCₙBr (n=4-18) shows (linear) dependence to chain length n, indicating significant contributions of conformational disorder to the solid-state transition.

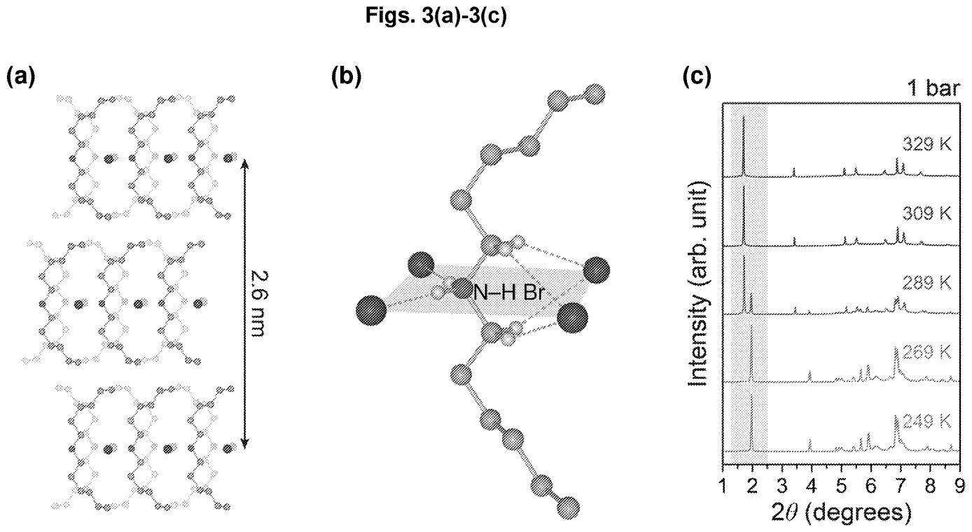

Structural changes that accompany the phase transitions of dC₆Br were then probed using X-ray diffraction. First, the structure of dC₆Br in the ordered, low-temperature (LT) phase was determined by single-crystal X-ray diffraction at 100 K (FIG. 3(a)). In monoclinic (C₂/c) phase, the di-hexylammonium cations, pack into non-interdigitated bilayers, held through weak van der Waals interactions, with interlayer spacing of 13.1 Å. As shown in FIG. 3(b), each cation is confined within a box defined by four Br anions, with an area of 28.7 Å², primarily through two in-plane N—H— —Br hydrogen bonding. The two hexyl chains, each of which protrudes out of the Br plane, are slightly distorted from each other, adopting a dihedral angle of 60° (FIG. 3(b), inset), occupying cross-sectional area of X Å² that is on par with the area of the Br box. Notably, both hexyl chains adopt C₂-C₃ torsion angles of 55°. The gauche bond appears to set an overall conformation to maximize the energetic driving within and between chains.

To investigate structural changes that accompany the phase transitions, variable-temperature powder X-ray diffraction (PXRD) experiments were performed. Upon cooling, dC₆Br undergoes a transition from an expanded, high-temperature (HT) phase (tetragonal 14/mmm) to a contracted LT phase, with a large volume change (ΔVₜᵣ) of 14% determined at the transition onset (290 K) (FIG. 3(c)). The temperature dependence of unit cell volume also features large thermal expansivity for both LT and HT phases, with 3.2×10⁻⁴ K⁻¹ and 4.0×10⁻⁴ K⁻¹, respectively. The volume change was largely attributed to anisotropic contraction along c-axis, with Δ_{c/c}=15.1%. Interestingly, the strong diffuse scattering background was observed in the HT-phase PXRD pattern, indicating that the cations might be dynamically disordered in the high-symmetry phase (FIG. 3(c)). NMR studies suggested that the di-alkyl cations—at least for short chain analogs of dCₙBr (n=2, 3, 4)-dynamically rotate along the chain axis in the HT phase, behaving as “low-dimensional” plastic crystals. For longer chain analogs dCₙX (n>5)—wherein large conformational degrees of freedom are likely to influence both dynamic motions and transition pathways-molecular models for the structural phase transitions have not been well established.

Furthermore, given that the energy barriers for molecular motions (such as rotation, conformation switching, translational self-diffusion) are influenced by chain length, it is particularly difficult to estimate the degree to which rotational motions-especially when coupled to dynamic changes in conformation-contributes to the phase transition.

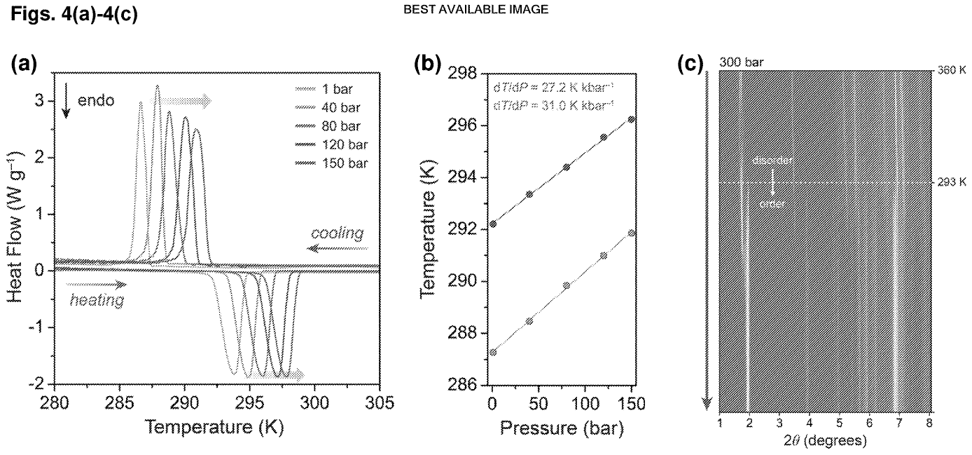

As the first step towards evaluating barocaloric effects in dC₆Br, the pressure dependence of the transition temperature (dT/dP) was estimated using the Clausius-Clapeyron relation (dT/dP=ΔVₜᵣ/ΔSₜᵣ). The dT/dP value for dC₆Br was calculated to be 42 K kbar⁻¹ (Table 1), suggesting that it displays an exceedingly high sensitivity to pressure when compared to existing barocaloric materials. Despite this exciting aspect, however, dC₆Br exhibits a moderate thermal hysteresis (ΔT_{hys}) of 4 K (FIG. 4(a)), which may negatively impact the reversibility of its pressure-driven phase transitions.

TABLE 1
Summary of barocaloric phase transitions of (C₆H₁₃)₂NH₂Cl (“dC₆Cl”),
(C₆H₁₃)₂NH₂Br (“dC₆Br”), and (C₆H₁₃)₂NH₂I (“dC₆I”).

| | (C₆H₁₃)₂NH₂Cl | (C₆H₁₃)₂NH₂Br | (C₆H₁₃)₂NH₂I |
|---|---|---|---|
| Tₜᵣ (K) | 279 | 293 | 284 |
| ΔSₜᵣ (J K⁻¹ kg⁻¹) | 215 | 302 | 199 |
| ΔSₜᵣ (J K⁻¹ mol⁻¹) | 48 | 81 | 62 |
| ΔT_{hys} (K) | 2.0-2.1 | 4-4.6 | 2.0-2.1 |
| ΔVₜᵣ (%) | 9.2 | 14.4 | 11.6 |
| (dT/dP)ᵢₙₜ (K | 47 | 42 | 44 |
| kbar⁻¹) | | | |
| (dT/dP)ₑₓₜ (K | 30 | 27 | 24 |
| kbar⁻¹) | | | |
| Halide Pocket (Å²) | ~25 | 29 | 30 |
| Pᵣₑᵥ (bar) | 46-73 | 96-149 | 55-100 |

Indeed, with these properties, Pᵣₑᵥ, a minimum pressure required to induce non-zero reversible isothermal entropy changes-calculated through a simple relationship Pᵣₑᵥ=ΔT_{hys}/(dT/dP)—is estimated to be 100 bar for dC₆Br. Note that the reversible pressure Pᵣₑᵥ—equivalent to pressure hysteresis (ΔP_{hys}) determined for Tₜᵣ, heating at ambient pressure—represents an energetic penalty to overcome the hysteresis for cyclic operations. This means that running cooling cycles with dC₆Br may require at least the pressure change of 100 bar. Though Pᵣₑᵥ of 100 bar is still very low especially among barocaloric materials that display large entropy changes (>100 J K⁻¹ kg⁻¹). Operating cooling cycles at the level of hundreds of bars may not be practical and may present significant safety and engineering challenges, especially for large-scale cooling applications.

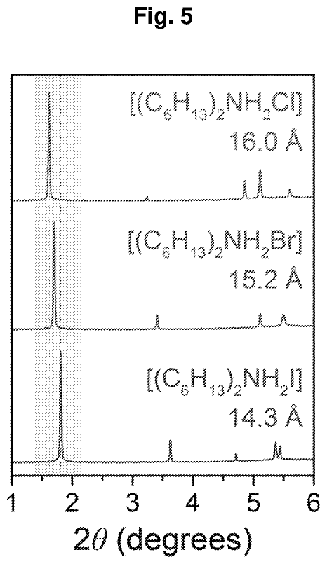

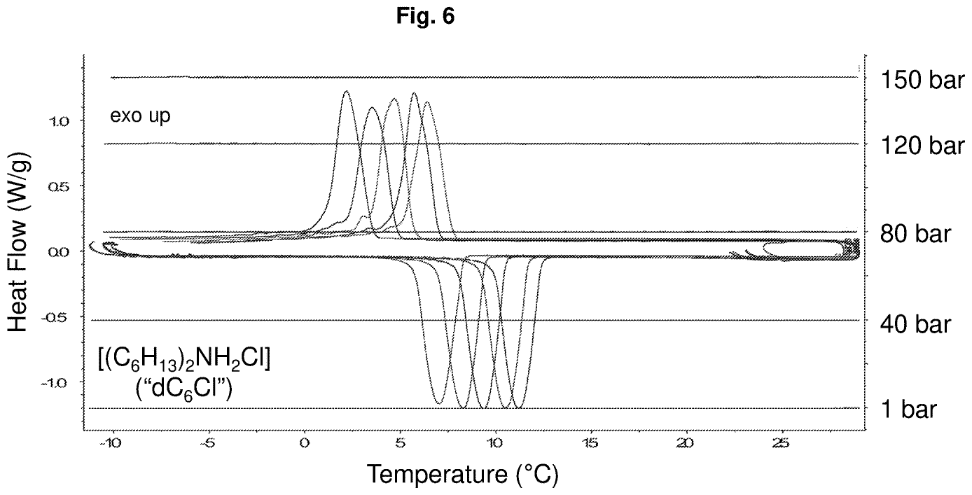

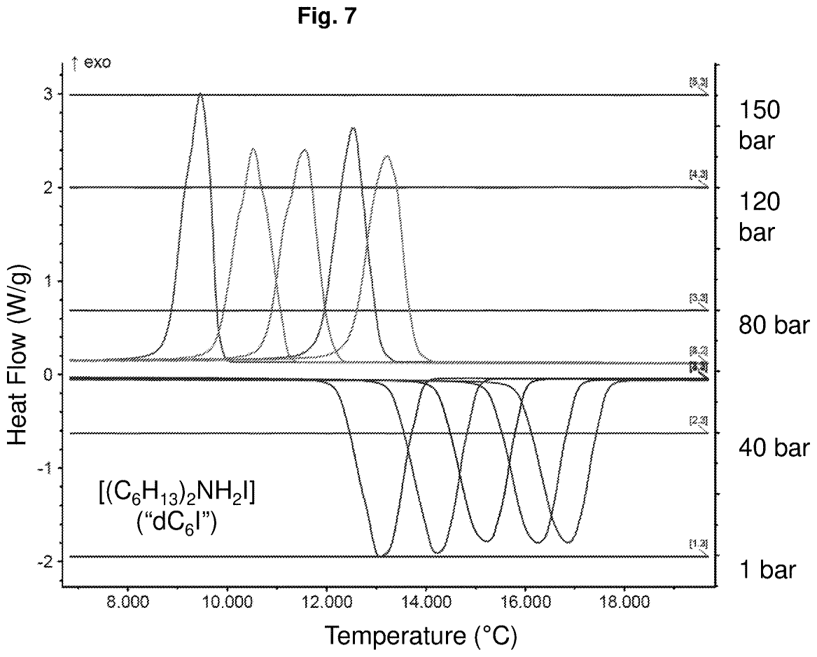

To identify materials with Pᵣₑᵥ far below 100 bar, a chemical strategy was developed that may reduce hysteresis without compromising pressure sensitivity and entropy change. Without being bound by a particular theory, chain confinements, which can be fine-tuned via halide substitution, should have direct impacts over phase-change thermodynamics in dC₆X. Towards this end, dC₆Cl and dC₆I were synthesized (FIG. 5). Ambient pressure DSC experiments show that dC₆Cl and dC₆I undergo solid-solid transitions at 6 °C and 12 °C (for heating) with ΔSₜᵣ of 203 J K⁻¹ kg⁻¹ (45 J K⁻¹ mol⁻¹) and 204 J K⁻¹ kg⁻¹ (64 J K⁻¹ mol⁻¹), respectively (FIGS. 6 and 7). Encouragingly, both compounds display a low ΔT_{hys} of 2 K.

Variable-temperature PXRD demonstrated that both dC₆Cl and dC₆I undergo large volume changes during the transitions, with 9.2% and 11.6%, respectively, and the changes also occur mostly through the contraction and expansion of interlayer spacing.

Notably, given the Clausius-Clapeyron relation, the entropy-volume correlation suggests that all three compounds may feature similarly high pressure sensitivity. In fact, dT/dP values for dC₆Cl and dC₆I are calculated to be 47 and 44 K kbar⁻¹, respectively. Excitingly, because of the low ΔT_{hys} of 2 K, their Pᵣₑᵥ values are predicted to be 46 and 55 bar, respectively, both of which are far lower than that of dC₆Br.

To experimentally evaluate barocaloric effects in dC₆X (X═Cl, Br, I), the pressure dependence of phase transitions was probed through isobaric DSC experiments. In these experiments, onset transition temperatures—as well as transition enthalpies and entropies—of thermally-induced transitions are measured as a function of pressure up to 150 bar, with He as the pressure-transmitting medium (PTM).

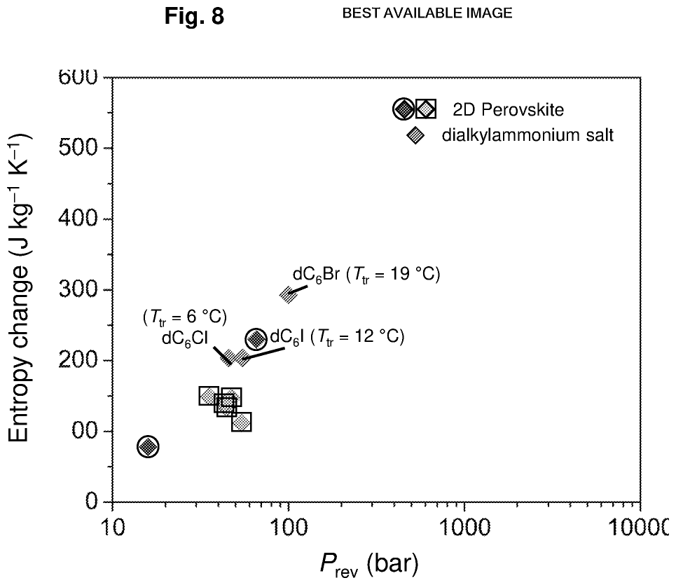

Interestingly, the directly measured dT/dP values for dC₆X (X═Cl, Br, I) were 29.5, 27.1, and 24.0 K kbar⁻¹, respectively, all of which are slightly lower than the values predicted from the Clausius-Clapeyron relation (FIGS. 4, 6, and 7). Accordingly, Pᵣₑᵥ values were thus higher than the predicted values, with 73, 149, and 93 bar for dC₆X (X═Cl, Br, I) (FIG. 8 and Table 1). Without being bound by a particular theory, the lower values of experimental dT/dP may be due to the use of He as PTM. As often observed in materials with large free volume (particularly those with long-chain hydrocarbon such as n-alkanes and 2-D perovskite), permeation of He into the lattice can lower the pressure response of a material. According to the quasi-direct analysis, dC₆X (X═Cl, B, I) are expected to manifest the full entropy change of transitions at 244, 294, and 199 bar, respectively—the pressures at which the transition cooling peak at the applied pressure surpasses the ambient-pressure heating peak. Note that the maximum possible magnitudes of adiabatic temperature changes (A T_{ad,max})—estimated through ΔT_{ad,max}=−TΔSₜᵣ/C_{P}—are 33, 58, and 45 K for dC₆X (X═Cl, Br, I), respectively.

Significantly, our evaluation revealed two interesting trends. First, the molar ΔSₜᵣ values for dC₆X (X═Cl, Br, I) show a volcano trend with the increasing size- and softness—of halides. Without being bound by a particular theory, the first large (50%) increase in ΔSₜᵣ may result from the increase in halide box sizes, from Cl (26 Å²) to Br (28 Å²), which coincides with weakening of confinement strength (Table 1). Because the energy barriers for orientational and conformational motions are likely to be lower in the Br box, the dihexyl cations in the HT phase may be able to access larger degrees of freedom in the Br box than in Cl box. Upon further increase in the halide box, to I (30 Å²), the energy barriers are lowered to a greater extent, such that the flexible cations can gain residual thermal motions even in the LT phase, resulting in a smaller difference in entropy in dC₆I than in dC₆Br. Although these explanations-consistent with the volume-entropy correlation in this system—are partially supported by heat capacity measurements, the dynamics of the system needs to be directly probed to elucidate the microscopic origins of this trend.

To compare the potential utility of dC₆X with existing barocaloric materials, ΔSₜᵣ and ΔPᵣₑᵥ are plotted in FIG. 8. Here, ΔPᵣₑᵥ was used as a metric for reversibility, because ΔP_{rwev} is an intrinsic materials property that allows for more consistent comparison across a wider range of existing materials. Remarkably, dC₆X, to the best of our knowledge, are the first materials to exhibit large entropy (>200 J K⁻¹ kg⁻¹) and low ΔPᵣₑᵥ (<100 bar), the combination of which leads to high (materials-level) thermodynamic efficiency for cooling.

Furthermore, dC₆X also featured excellent chemical and thermal stability, low-cost/scalable synthesis, light weight, high compatibility with water, and facile processability (into crystals and thin films). These properties—in combination with exceedingly high values of intrinsic dT/dP-present dC₆X as highly promising candidates for solid-state barocaloric cooling prototypes that can operate under low pressures.

Pressure-driven phase transitions in dCₙX revealed in our studies have exciting implications for a wide range of thermal science applications, even beyond barocaloric cooling. For instance, these materials can be utilized to realize pressure-tunable thermal energy storage (PT-TES) cycles-over a wide temperature range that is dynamically adjustable by application of low pressures on-demand. Excitingly, high-pressure DSC experiments (shown in FIG. 4) indicate that dC₆Br can store and release a large amount of thermal energy (88 J g⁻¹) at 23 °C (150 bar) and 16 °C (1 bar), respectively, operating at the temperature range that is ideally suitable for building thermal management.

### Example 2—Asymmetric Soft Organic Salts

Soft organic salts having asymmetric substitutions (i.e., R₁≠R₂) were also investigated.

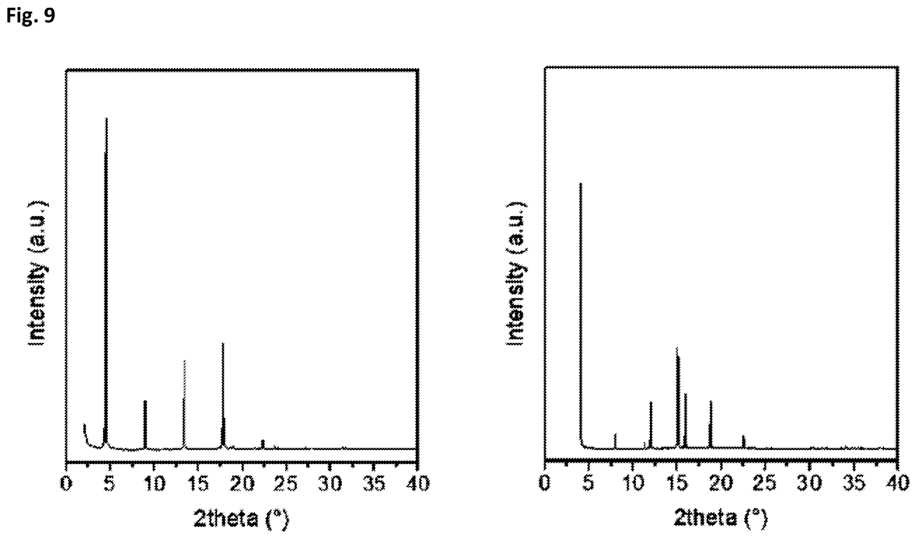

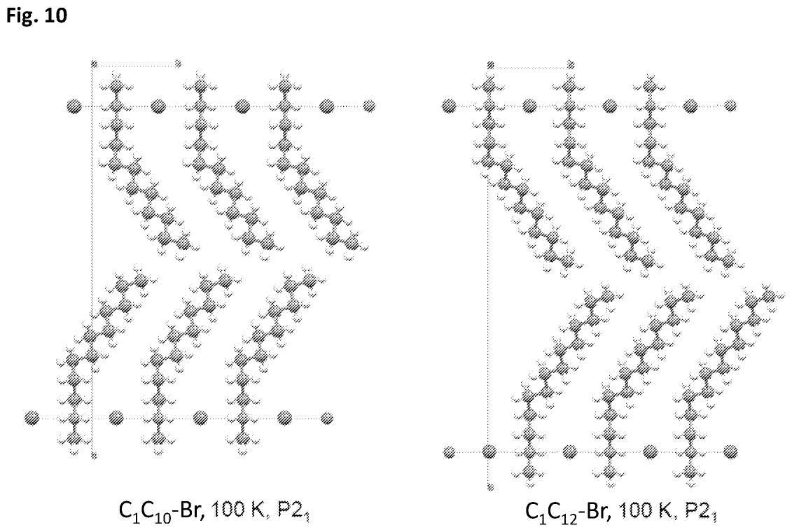

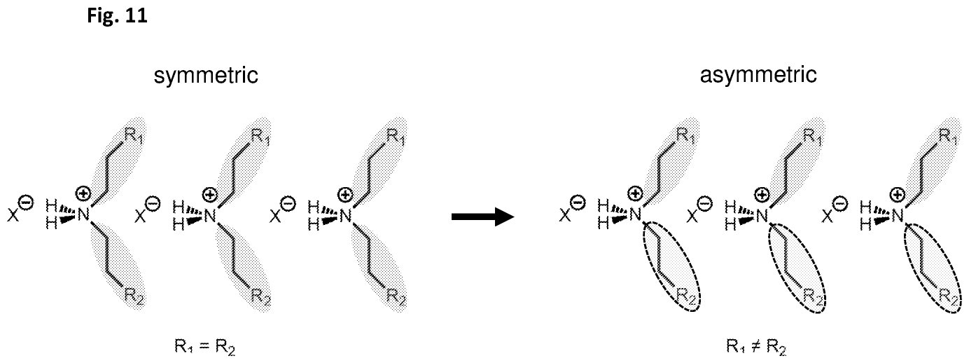

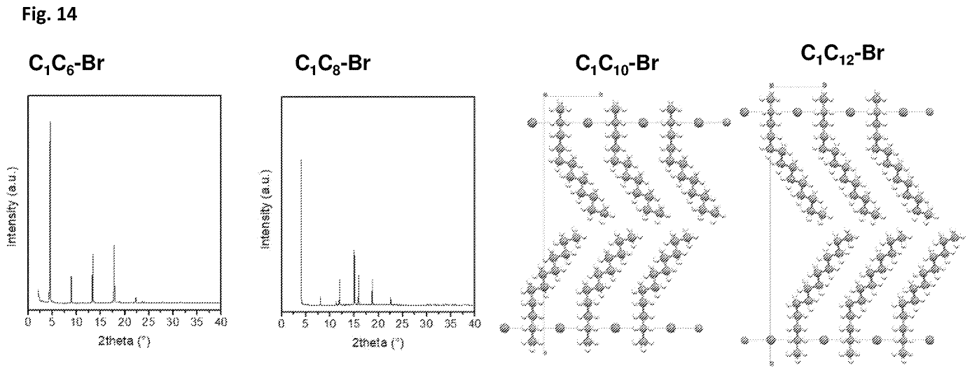

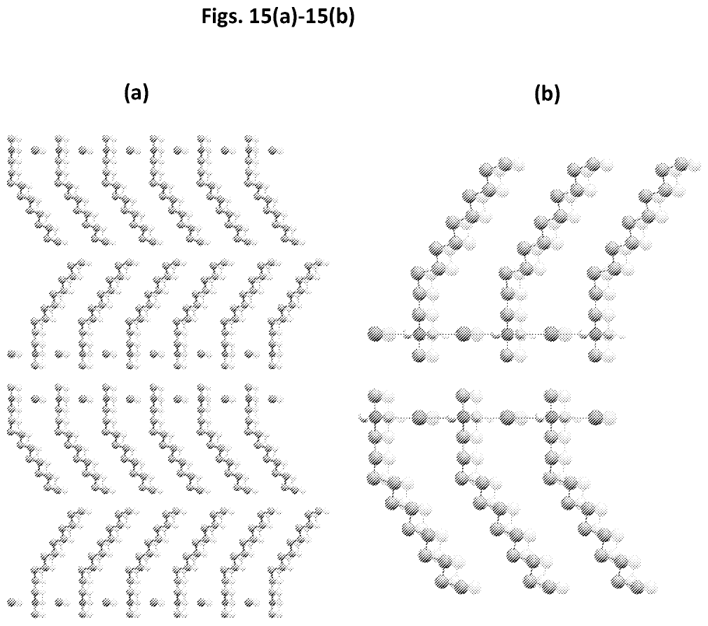

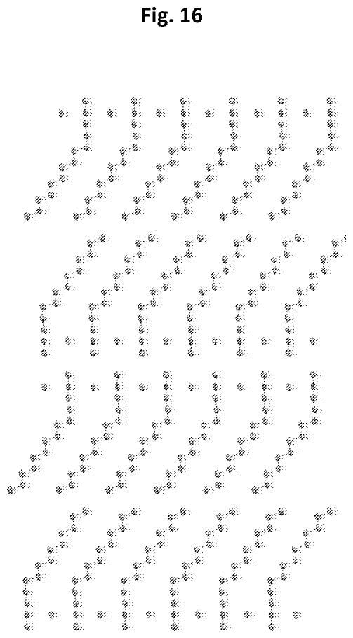

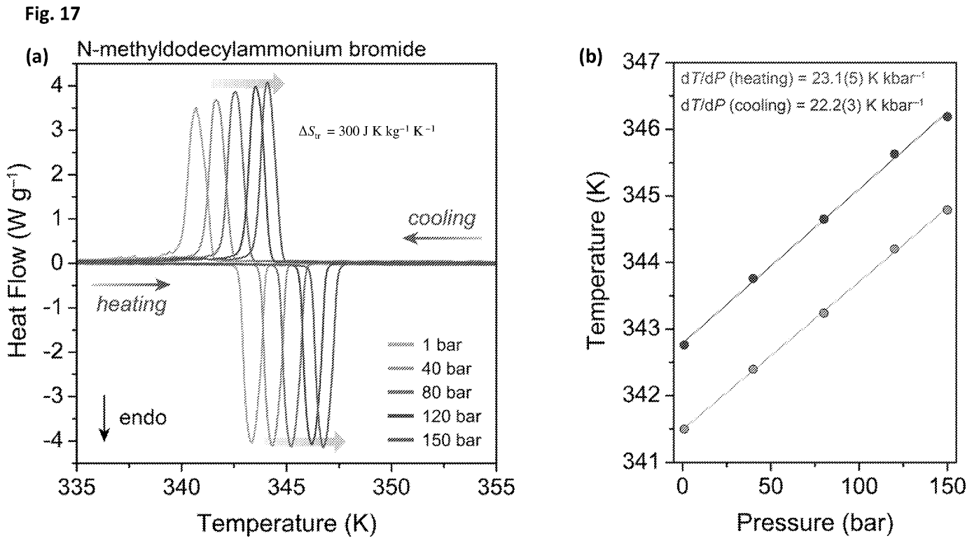

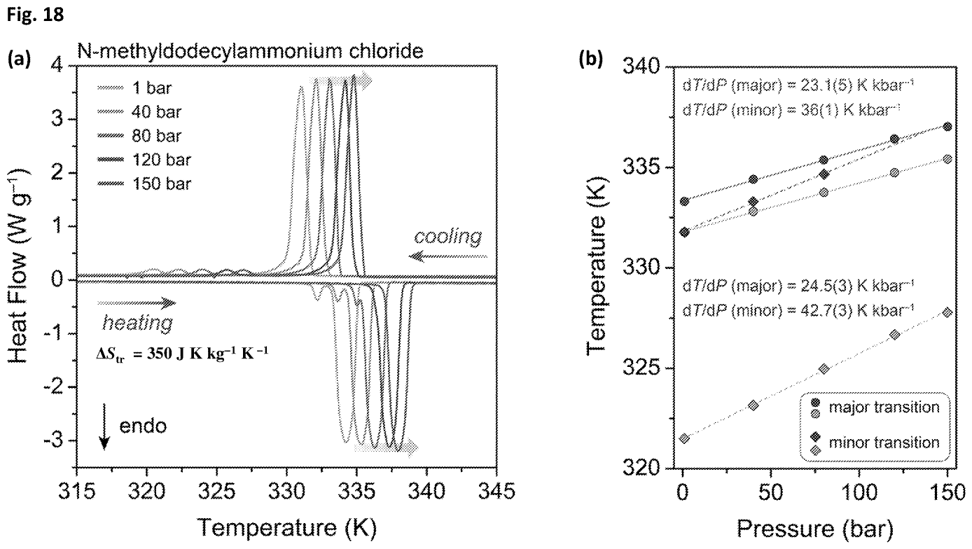

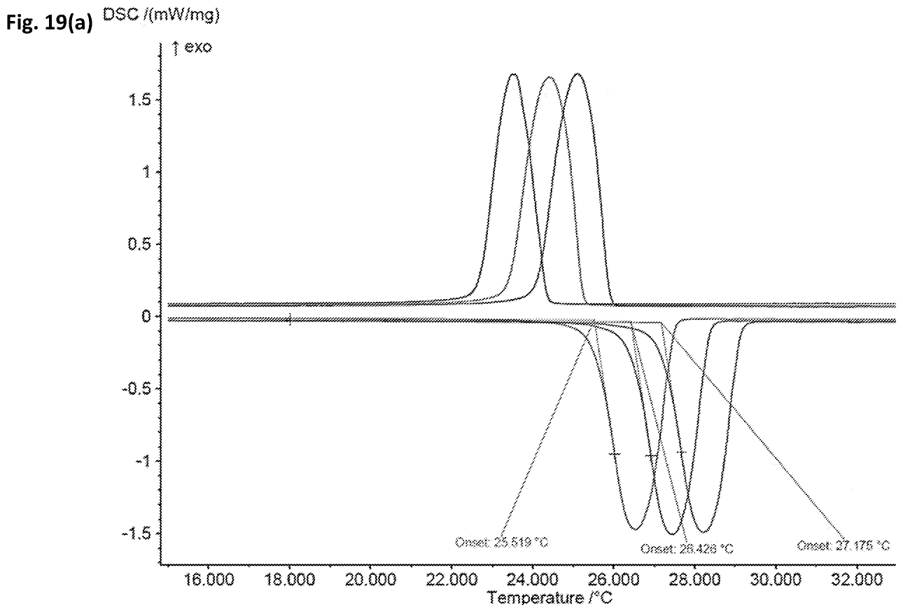

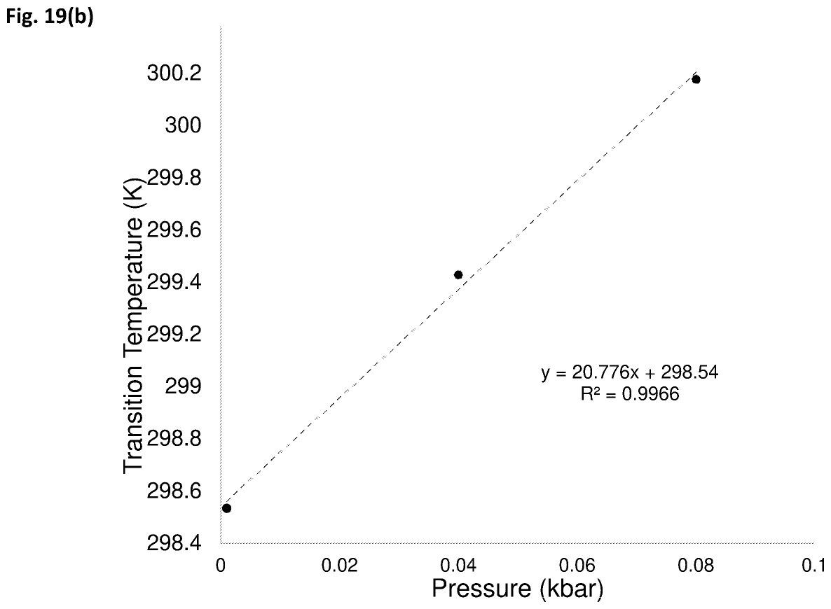

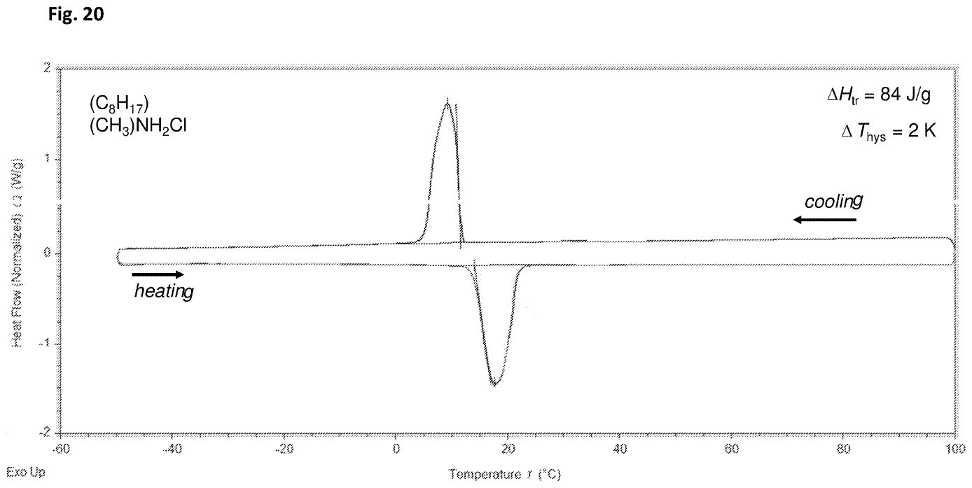

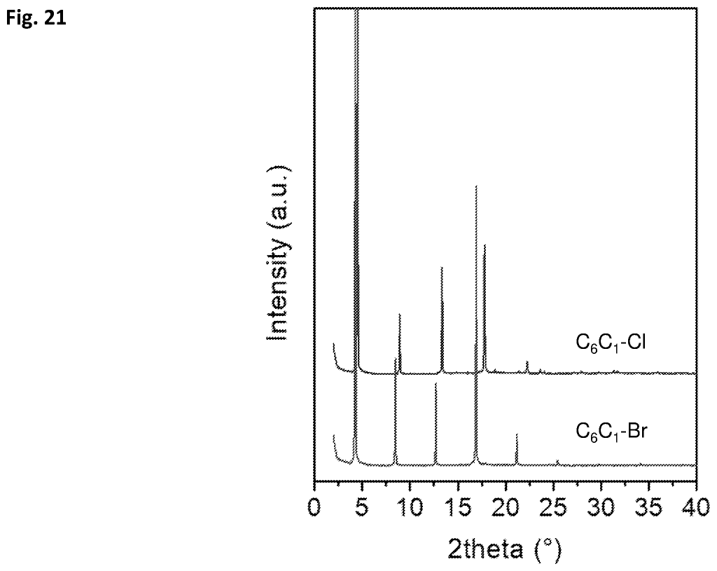

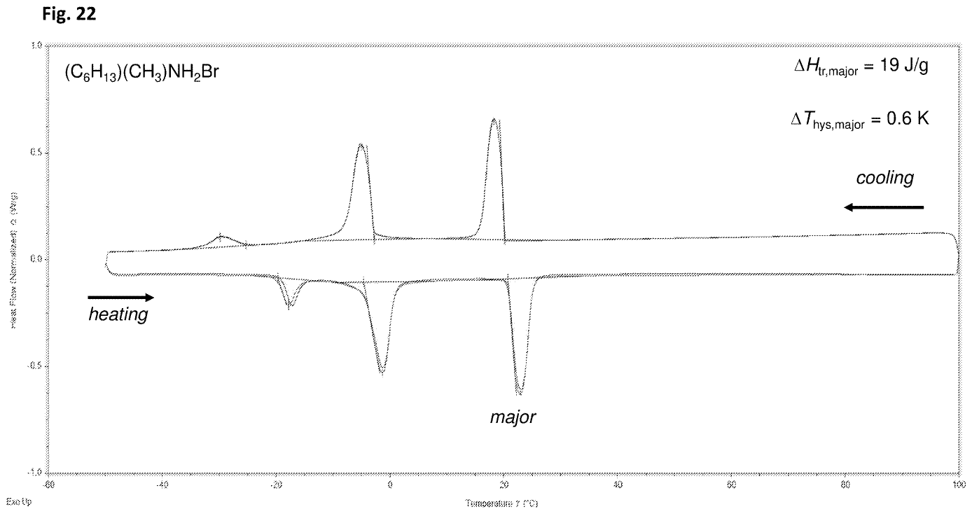

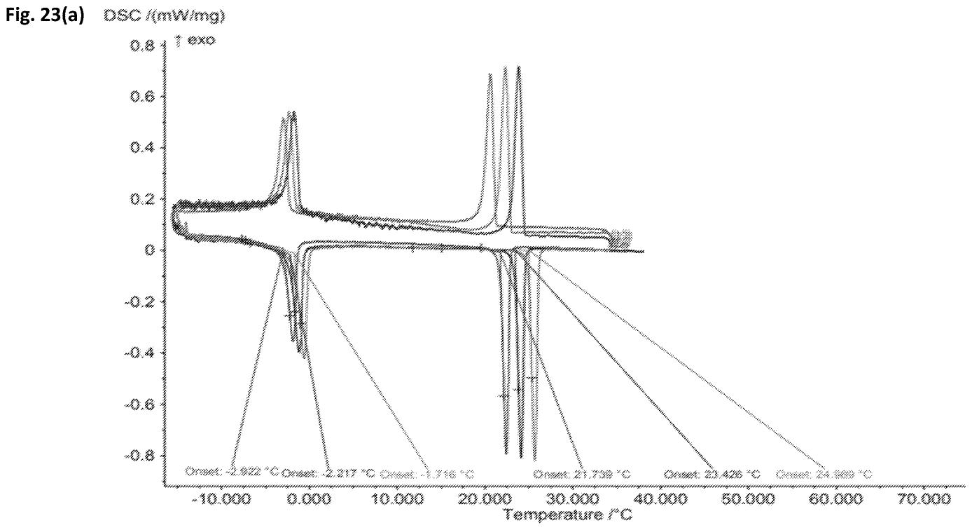

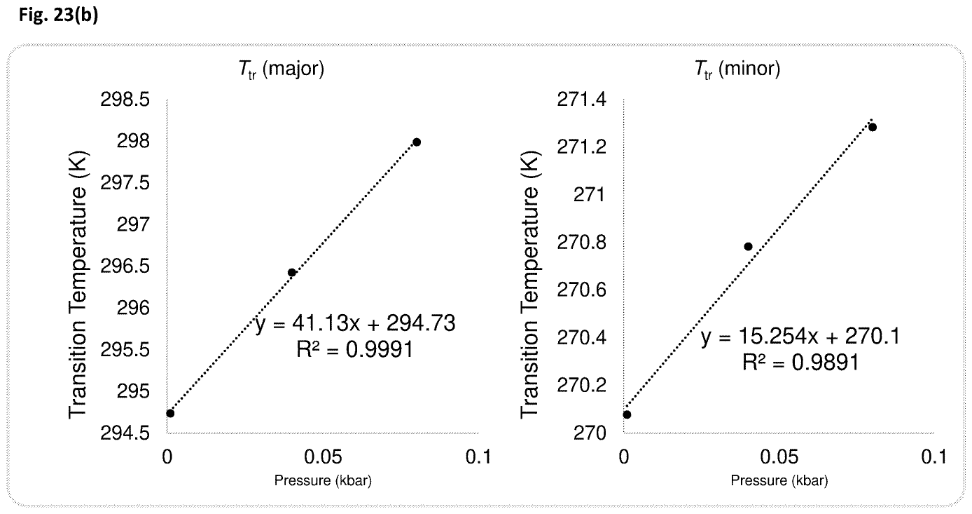

First, a series of asymmetric soft organic salts with one long alkyl chain and one methyl group were investigated. The results are shown in FIGS. 14-23(b) and summarized in Table 2 and Table 3. Powder and single crystal XRD structure information is also shown in FIGS. 9 and 10.

TABLE 2
Summary of thermodynamic properties of phase transitions in
[(CₙH₂ₙ₊₁)(CH₃)NH₂Br] (n = 6, 8, 10, 12)

| | Tₜᵣ | ΔT_{hys} | ΔHₜᵣ | ΔHₜᵣ | ΔSₜᵣ |
|---|---|---|---|---|---|
| | (K) | (K) | (J g⁻¹) | (kJ mol⁻¹) | (J kg⁻¹ K⁻¹) |
| Chemical | Transition | Thermal | Transition | Transition | Transition |
| Formula | Temp. | Hysteresis | Enthalpy | Enthalpy | Entropy |
| (C₆H₁₃)NH₂(CH₃)Br | 293.7 | 0.6 | 19.2 | 3.8 | 65.4 |
| | (major) | (major) | (major) | (major) | (major) |
| (C₈H₁₇)NH₂(CH₃)Br | 296.7 | 2.0 | 56.9 | 12.8 | 191.9 |
| (C₁₀H₂₁)NH₂(CH₃)Br | 322.4 | 1.0 | 78.0 | 19.7 | 242.1 |
| (C₁₂H₂₅)NH₂(CH₃)Br | 341.8 | 1.4 | 99.8 | 28.0 | 291.9 |
| | ΔSₜᵣ | ΔSₜᵣ | dTₜᵣ/dP | ΔVₜᵣ | |
| | (J kg⁻¹ K⁻¹) | (J mol⁻¹ K⁻¹) | (K kbar⁻¹) | (cm³ kg⁻¹) | |
| Chemical | Transition | Transition | Pressure | Volume | Pᵣₑᵥ |
| Formula | Entropy | Entropy | Sensitivity | Change | (bar) |
| (C₆H₁₃)NH₂(CH₃)Br | 65.4 | 12.8 | 41.1 | 26.9 | 15 |
| | (major) | (major) | (major) | | |
| (C₈H₁₇)NH₂(CH₃)Br | 191.9 | 43.0 | 20.8 | 39.9 | 90 |
| (C₁₀H₂₁)NH₂(CH₃)Br | 242.1 | 61.1 | 24.3 | 58.8 | 42 |
| (C₁₂H₂₅)NH₂(CH₃)Br | 291.9 | 81.8 | 22 | 64.2 | 63 |

Pᵣₑᵥ values represent the pressure required to induce non-zero reversible barocaloric effects.

All four compounds undergo reversible order-disorder transitions near room temperature with highly promising phase-change properties. In particular, because of low thermal hysteresis and high pressure sensitivity, these compounds display large barocaloric effects at low pressures, with reversible pressure (Pᵣₑᵥ) ranging between 15 to 90 bar.

TABLE 3
Phase-change properties of asymmetric dialkylammonium salts
(CₙH₂ₙ₊₁)(CH₃)NH₂X (X = Cl, Br; n = 6, 8).

| | Tₜᵣ | ΔT_{hys} | ΔHₜᵣ | ΔSₜᵣ | dTₜᵣ/dP |
|---|---|---|---|---|---|
| | (K) | (K) | (J g⁻¹) | (J kg⁻¹ K⁻¹) | (K kbar⁻¹) |
| | Transition | thermal | Transition | Transition | pressure |
| Chemical Formula | temperature | hysteresis | enthalpy | entropy | sensitivity |
| (C₆H₁₃)(CH₃)NH₂Cl | 274.1, 266.0 | 0.7, 5.0 | 28.9, 7.6 | 105.4, | 30-40 |
| | | | | 28.6 | (predicted) |
| (C₆H₁₃)(CH₃)NH₂Br | 293.7, 268.4, | 0.6, 1.9, | 19.2, 19.6, | 65.4, 73.0, | 41 (major) |
| | 253.3 | 5.6 | 3.9 | 15.4 | |
| (C₈H₁₇)(CH₃)NH₂Cl | 287 | 2 | 84 | 293 | 30-40 |
| | | | | | (predicted) |
| (C₈H₁₇)(CH₃)NH₂Br | 296.7 | 2 | 57 | 192 | 21 |

Characterizations through high-pressure differential scanning calorimetry (HP-DSC) indicate that these compounds all display high pressure sensitivity (d Tₜᵣ/dP) between 30-40 K kbar⁻¹ under helium environments. Note that values for multiple transitions are separated by commas.

TABLE 4
Phase-change properties of asymmetric dialkylammonium
salts (C₁₂H₂₅)(CH₃)NH₂X (X = Cl, Br).

| | | | | | ΔSₜᵣ | |
|---|---|---|---|---|---|---|
| | | | | ΔSₜᵣ | (J mol⁻¹ | |
| | | | ΔSₜᵣ | (J L⁻¹ K⁻¹) | K⁻¹) | dTₜᵣ/dP (K |
| | Tₜᵣ (°C) | | (J kg⁻¹ K⁻¹) | Volumetric | Molar ΔS | kbar⁻¹) |
| Chemical | major | ΔT_{hys} | Major | transition | per chain | major |
| Formula | (minor) | (°C) | (minor) | entropy | (total) | (minor) |
| (C₁₂H₂₅)(CH₃)NH₂Br | 69.6 | 1.4 | 300 | 351 | 84 | 23.1 |
| | | | | | | 22.2 |
| (C₁₂H₂₅)(CH₃)NH₂Cl | 61.1 | 2.5 | 350 | 363 | 83 | 23.1 (36) |
| | (58.6); | (10.5) | (14) | (15) | | 24.5 (42.7) |
| | 58.6 | | | | | |
| | (48.1) | | | | | |

Preliminary characterizations through high-pressure differential scanning calorimetry (HP-DSC) indicate that these candidate compounds all display high pressure sensitivity (d Tₜᵣ/dP) between 23-43 K kbar⁻¹ under Helium environments.

All of the investigated compounds underwent reversible order-disorder transitions near room temperature with highly promising phase-change properties.

Soft Organic Salts with Polyfluorocarbyl Substituents and Other Functional Groups

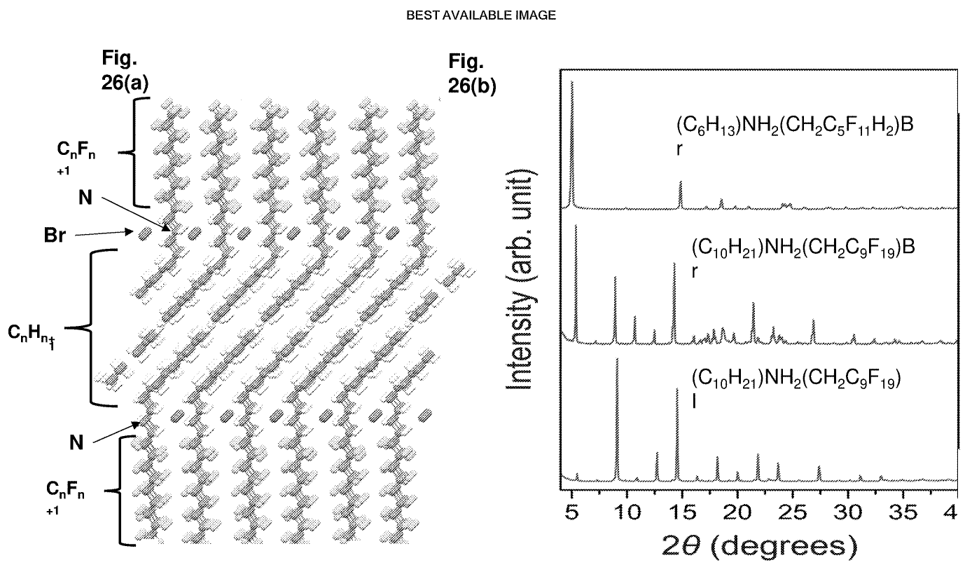

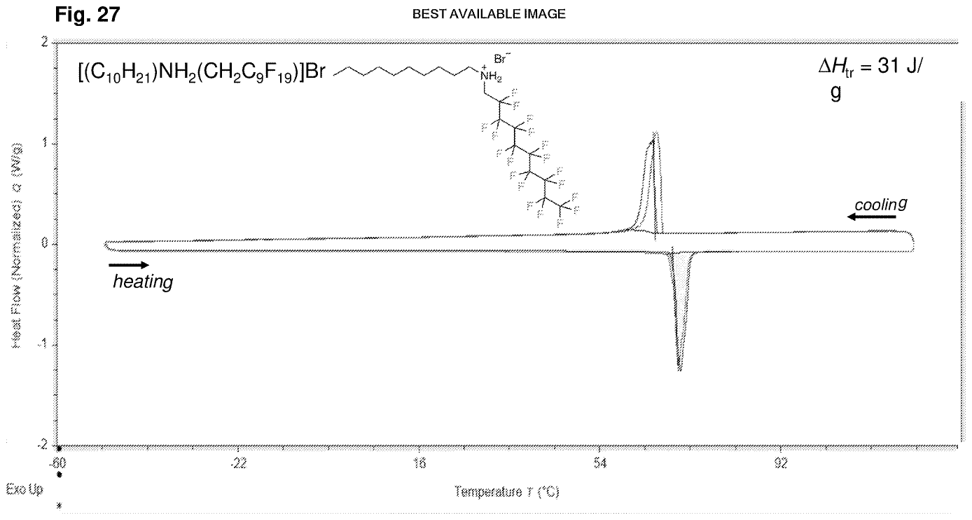

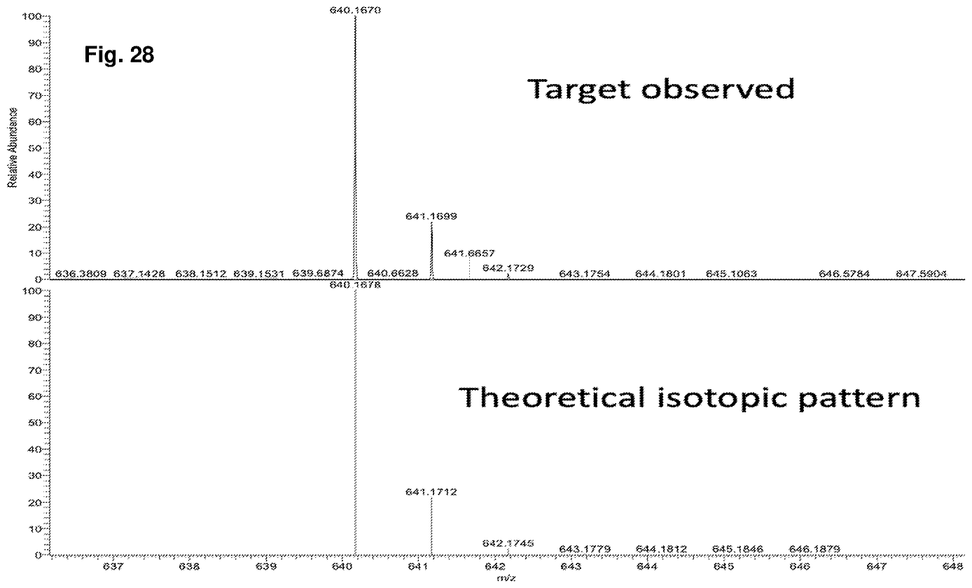

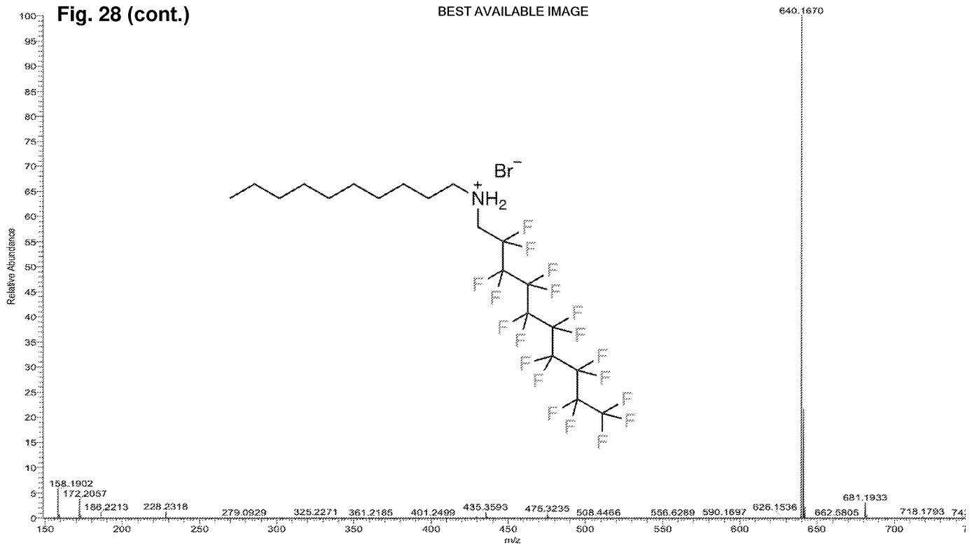

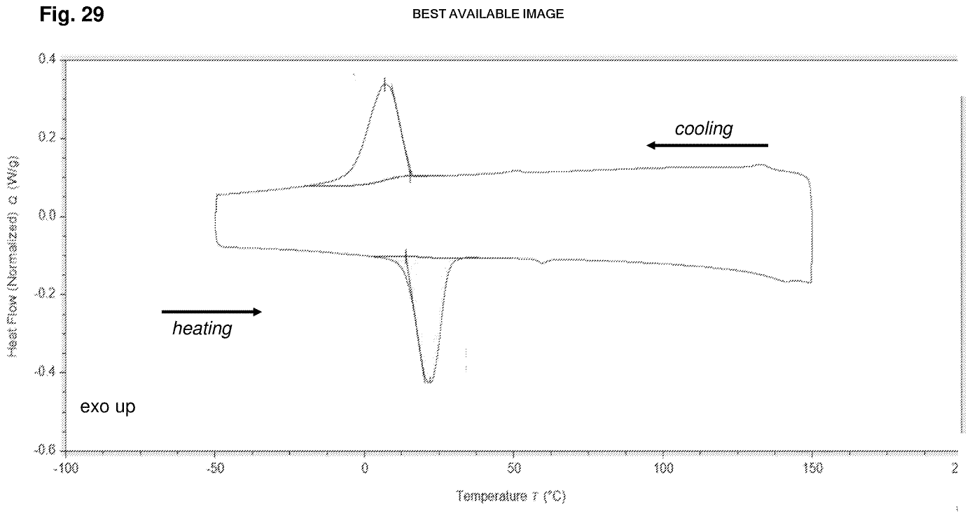

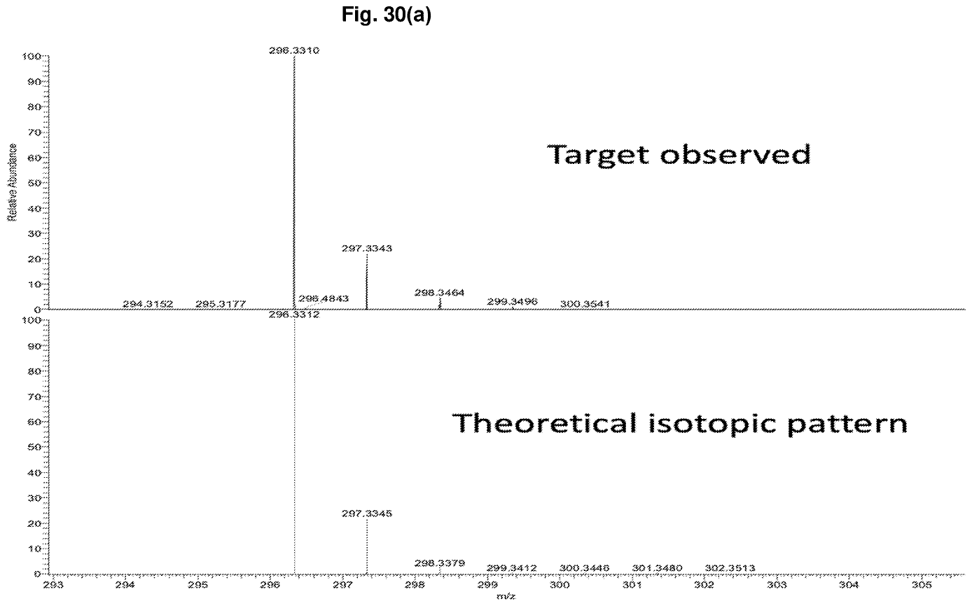

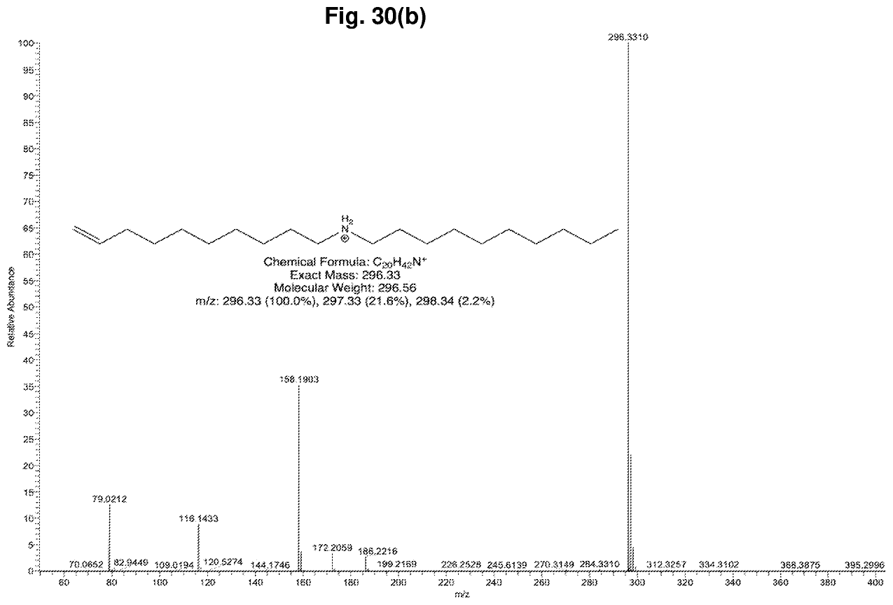

Alternate types of asymmetric soft organic salts were investigated (polyfluorocarbyl substituents and other functional groups). FIGS. 26(a) to 30 show the thermal and structural characterization of a series of asymmetric soft organic salts having polyfluorocarbyl groups. The results are summarized in Table 5.

Table 5 also shows the thermal characteristics of an asymmetric soft organic salt where one of the hydrocarbyl chains includes a terminal C═C. Two of the fluorinated compounds ((C₁₀H₂₁)NH₂(CH₂C₉F₁₉)Br and (C₁₀H₂₁)NH₂(CH₂C₉F₁₉)I) and the terminal alkene compound ((C₁₀H₂₁)NH₂((CH₂)₈CHCH₂)Br) show barocaloric phase transitions with low thermal hysteresis and high pressure sensitivity.

TABLE 5
Phase-change properties of asymmetric dialkylammonium salts with fluorinated chains.

| | Tₜᵣ | ΔT_{hys} | ΔHₜᵣ | ΔSₜᵣ | dTₜᵣ/dP |
|---|---|---|---|---|---|
| | (K) | (K) | (J g⁻¹) | (J kg⁻¹ K⁻¹) | (K kbar⁻¹) |
| | Transition | Thermal | Transition | Transition | Pressure |
| Chemical Formula | Temp. | Hysteresis | Enthalpy | Entropy | Sensitivity |
| (C₁₀H₂₁)NH₂(CH₂C₉F₁₉)Br | 343.6 | 4.9 | 31.1 | 91.0 | 26.5 |
| (C₁₀H₂₁)NH₂(CH₂C₉F₁₉)I | 333 | 5 | 20 | 60.1 | ~30 |
| | | | | | (predicted) |
| (C₁₀H₂₁)NH₂((CH₂)₈CHCH₂)Br | 287 | <1 | 38 | 132 | ~30 |
| | | | | | (predicted) |

Characterizations through high-pressure differential scanning calorimetry (HP-DSC) thus indicate that such compounds, even with fluorination, display high pressure sensitivity (dTₜᵣ/dP) around 30 K kbar⁻¹ under Helium environments.

Asymmetric Soft Organic Salts with Varying Chain Length

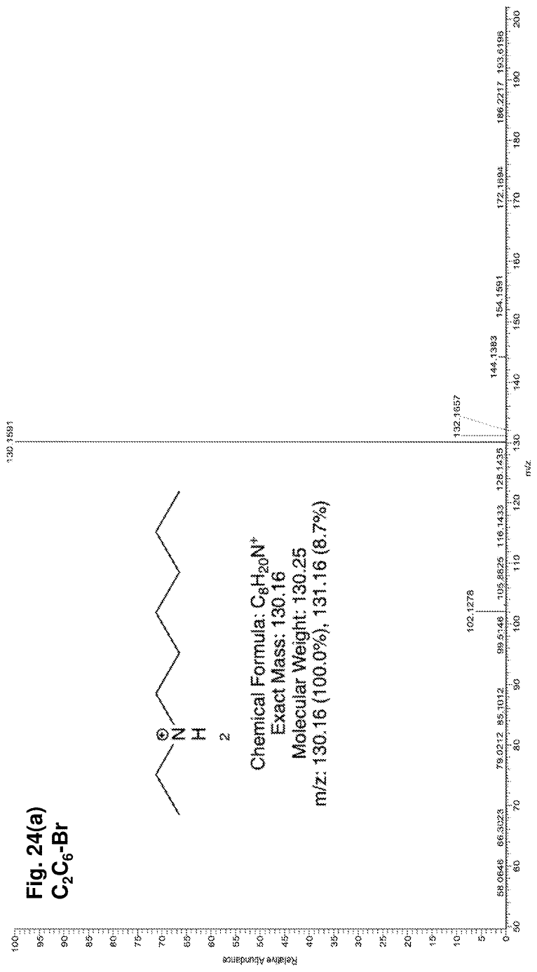

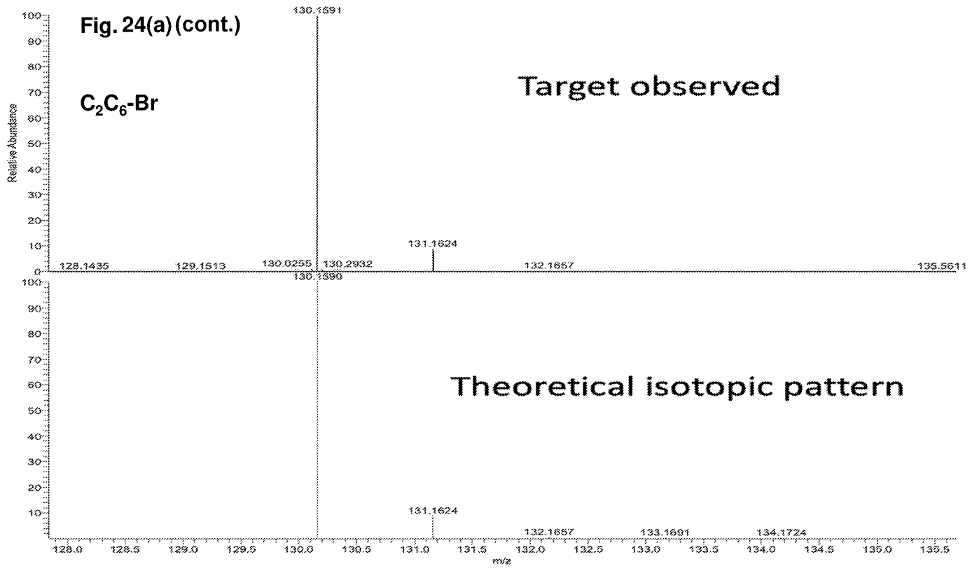

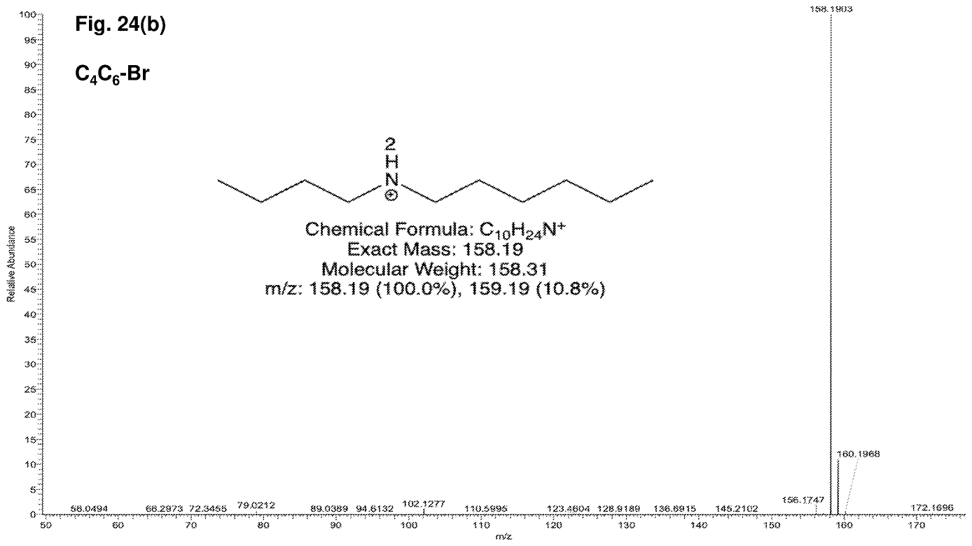

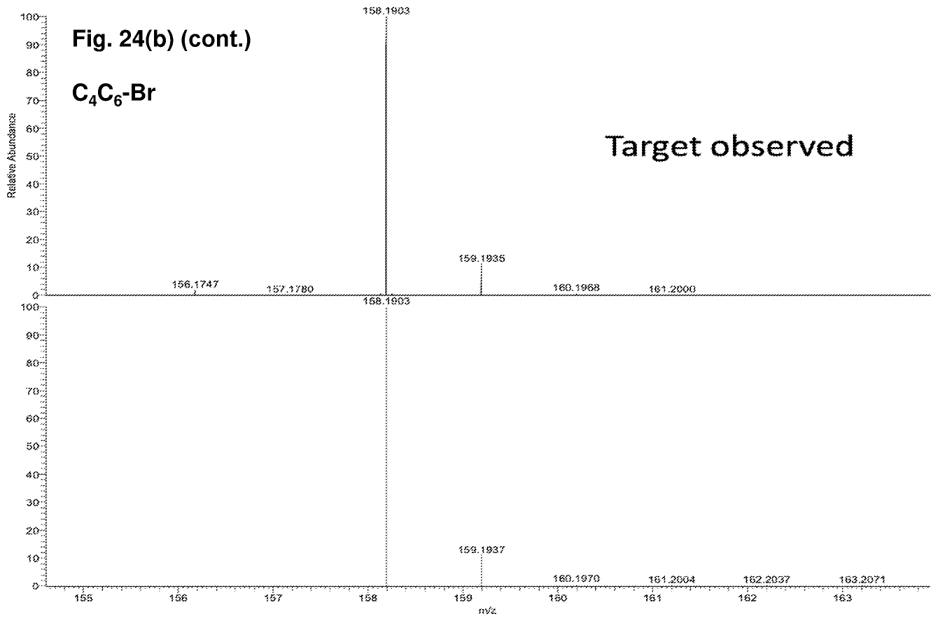

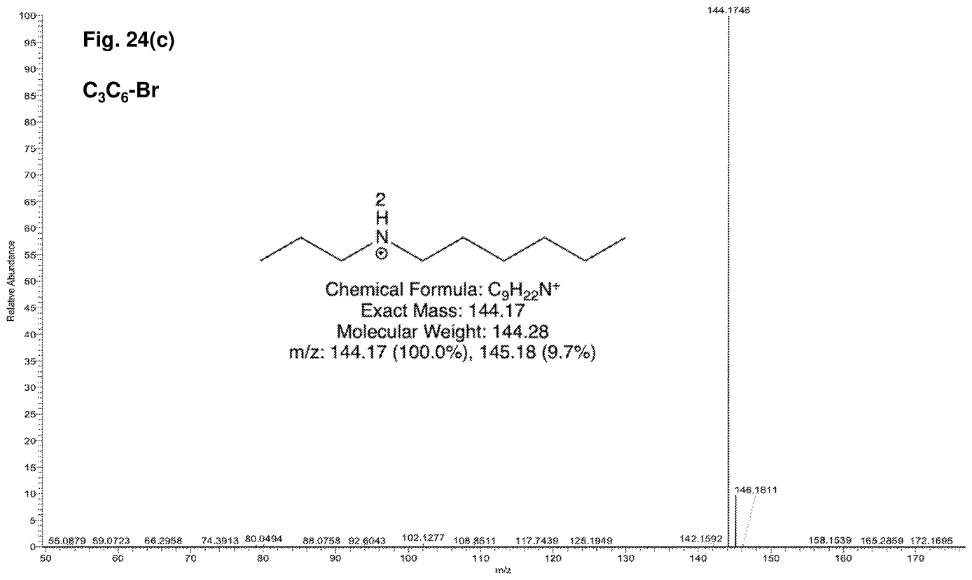

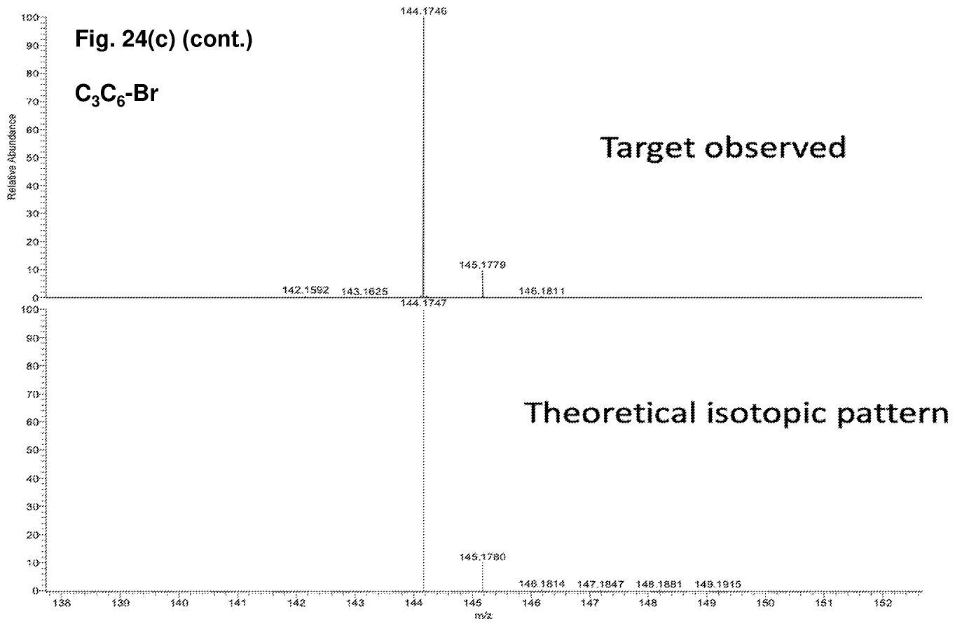

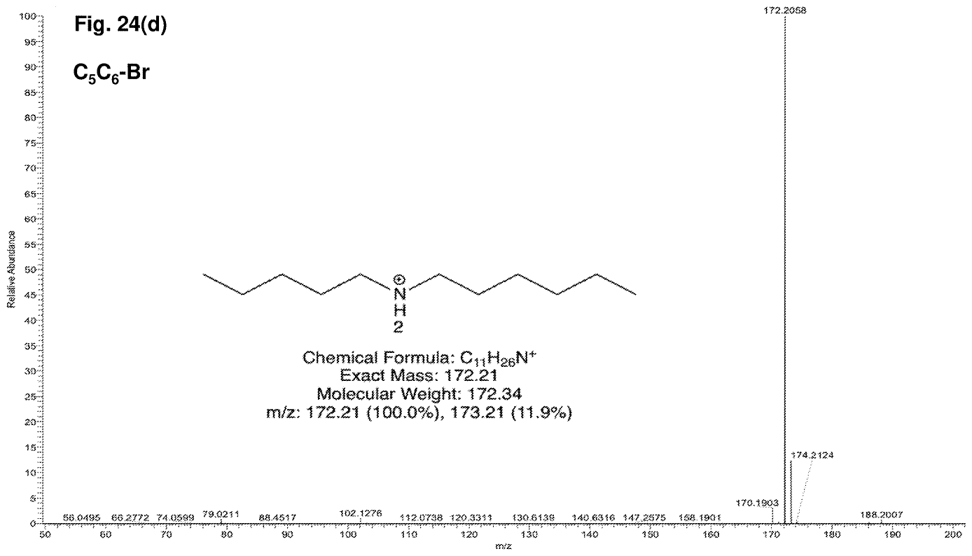

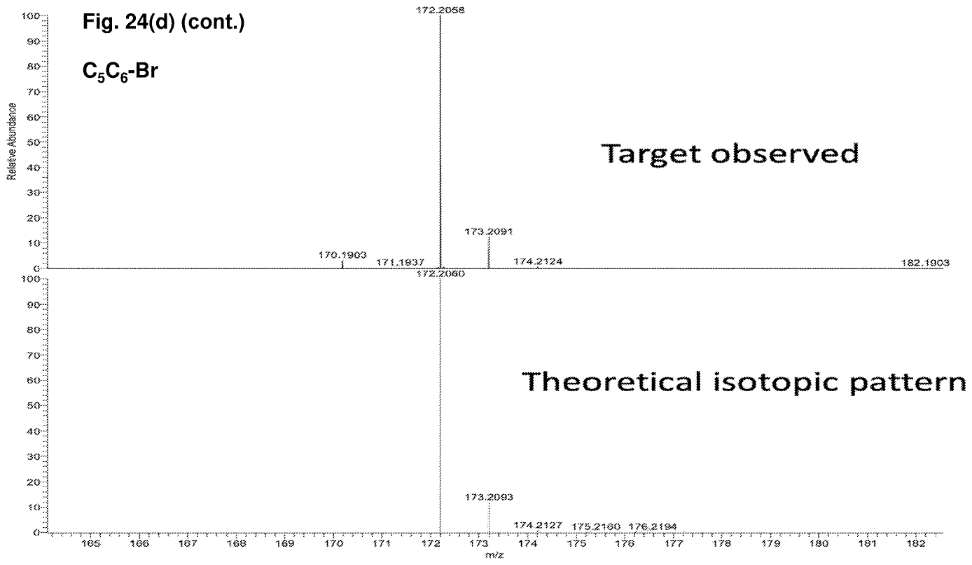

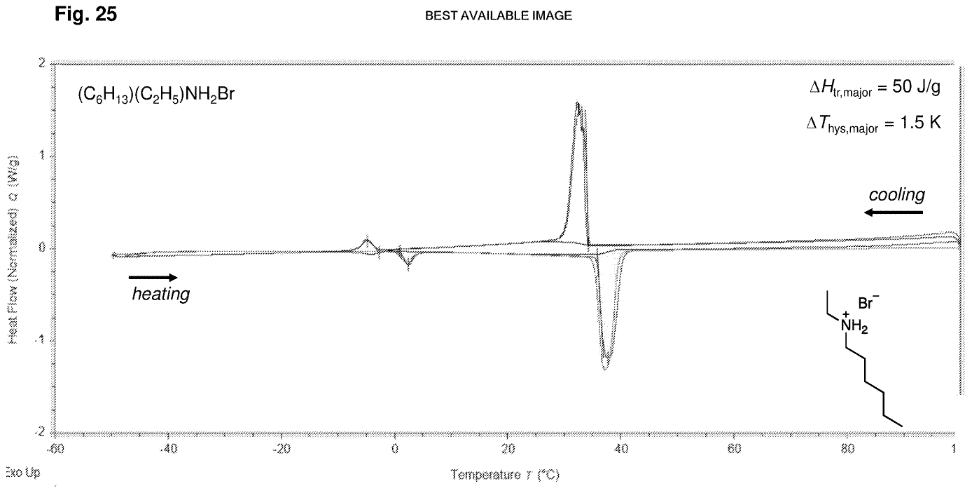

Next, a series of asymmetric soft organic bromide salts were synthesized and investigated, all having one (C₆H₁₃) substituent with the other substituent varied in length (from C₂ to C₅). The results are shown in FIGS. 24(a)-24(d) show the m/z data confirming the synthesis of the compounds. FIG. 25 shows a HP-DSC trace for compound C₂C—Br. The full results are collated in Table 6.

TABLE 6
Phase-change properties of asymmetric dialkylammonium
salts (with varying chain length).

| | Tₜᵣ | ΔT_{hys} | ΔHₜᵣ | ΔSₜᵣ | |
|---|---|---|---|---|---|
| | (K) | (K) | (J g⁻¹) | (J kg⁻¹ K⁻¹) | |
| | Transition | thermal | Transition | Transition | |
| Chemical Formula | temperature | hysteresis | enthalpy | entropy | Note |
| (C₂H₅)NH₂(C₆H₁₃)Br | 309, 274 | 1.5, 3 | 50, 6 | 162, 22 | |
| “C₂C₆—Br” | (minor) | | | | |
| (C₃H₇)NH₂(C₆H₁₃)Br | | | | | Broad |
| “C₃C₆—Br” | | | | | transitions |
| | | | | | at <220 K |
| (C₄H₉)NH₂(C₆H₁₃)Br | 247 | <1 | 5 | 20 | Major |
| “C₄C₆—Br” | | | | | transition |
| | | | | | at <220 K |
| (C₅H₁₁)NH₂(C₆H₁₃)Br | 240, | 2-4 | 35, ~5 | 146, | |
| “C₅C₆—Br” | 253 (minor) | | (minor) | 20-30 | |
| | | | | (minor) | |

Preliminary characterizations through high-pressure differential scanning calorimetry (HP-DSC) indicate that these candidate compounds, display high pressure sensitivity (dTₜᵣ/dP) around 30-40 K kbar⁻¹ under Helium environments.

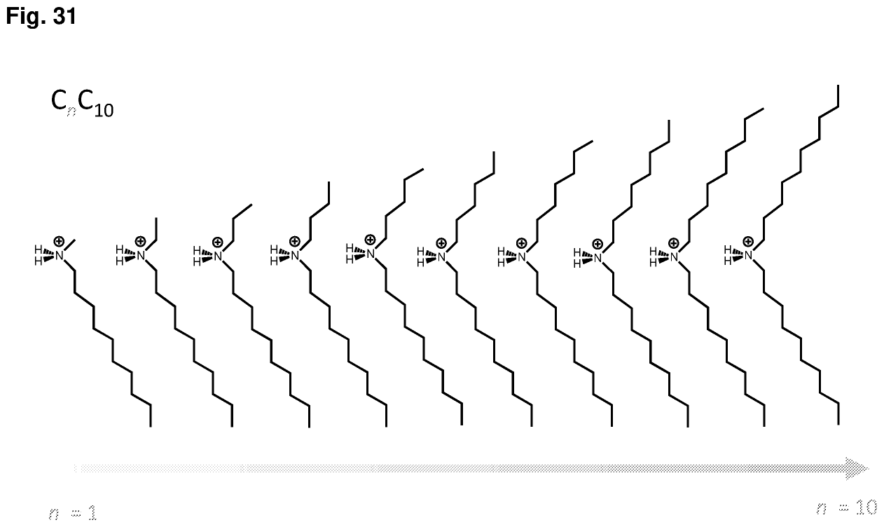

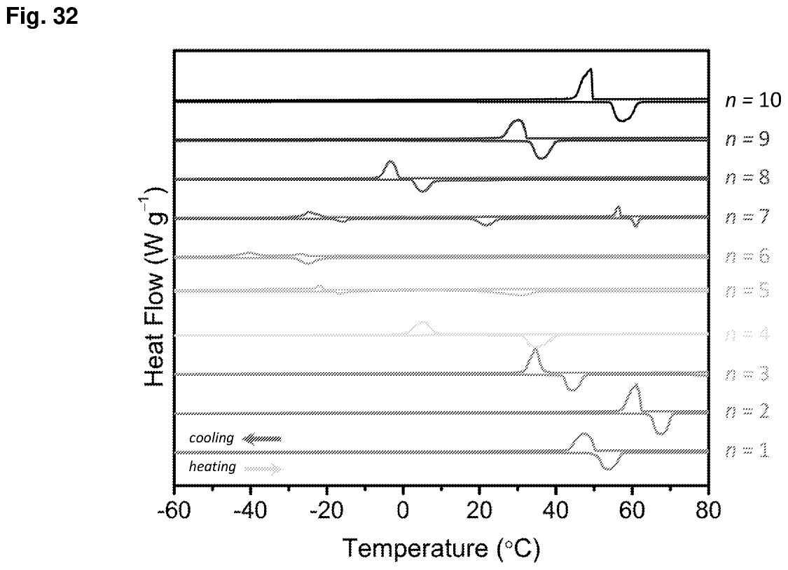

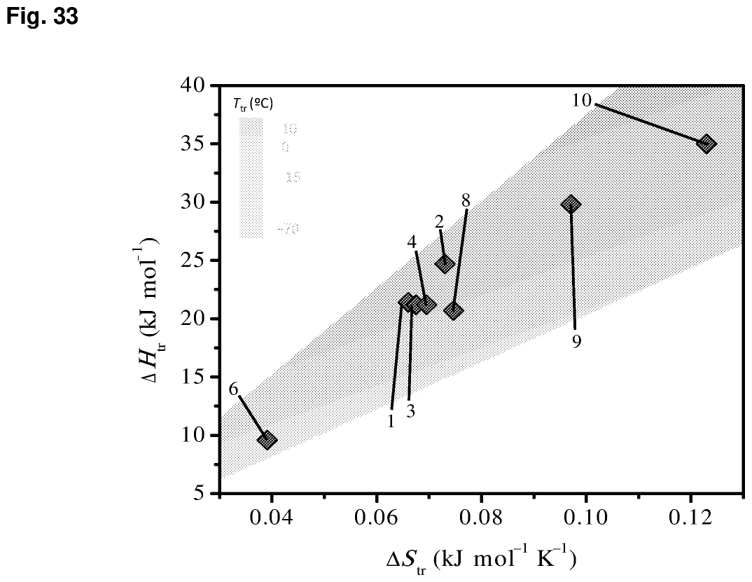

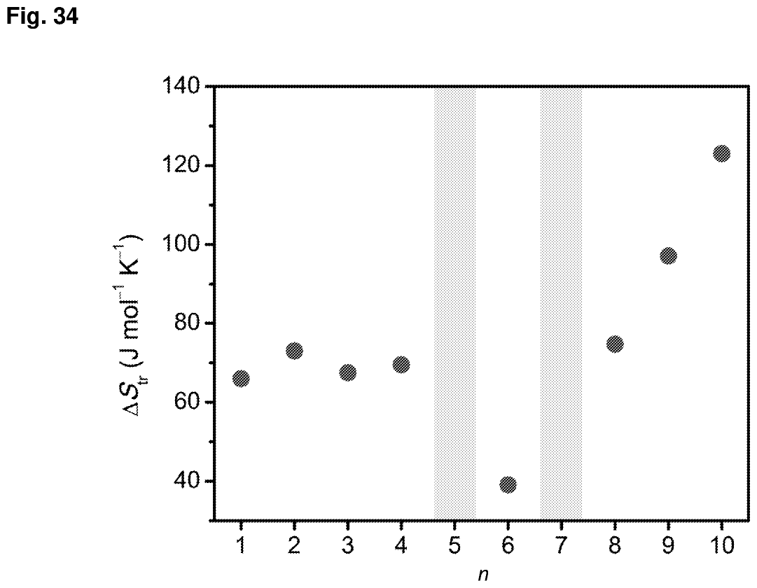

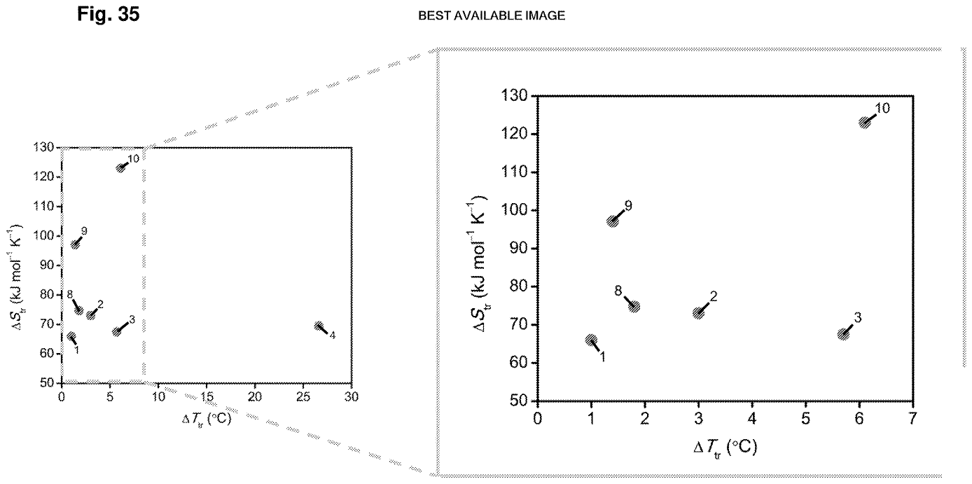

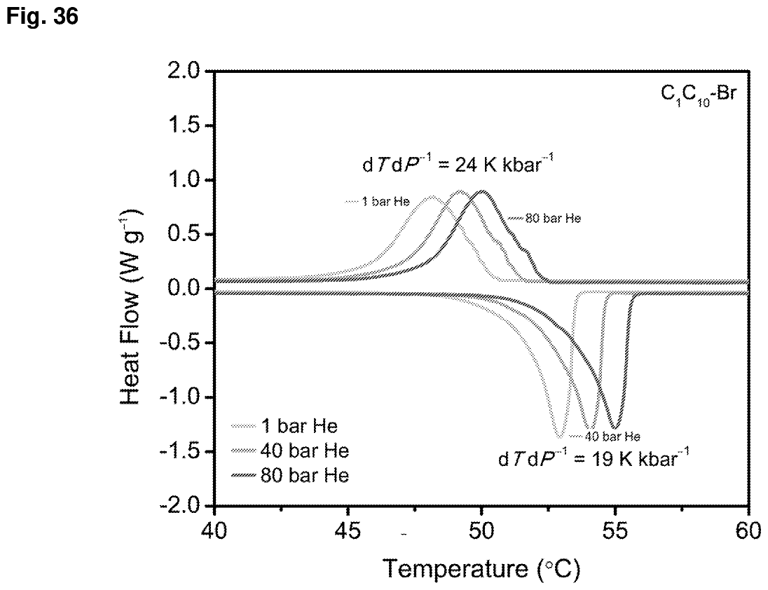

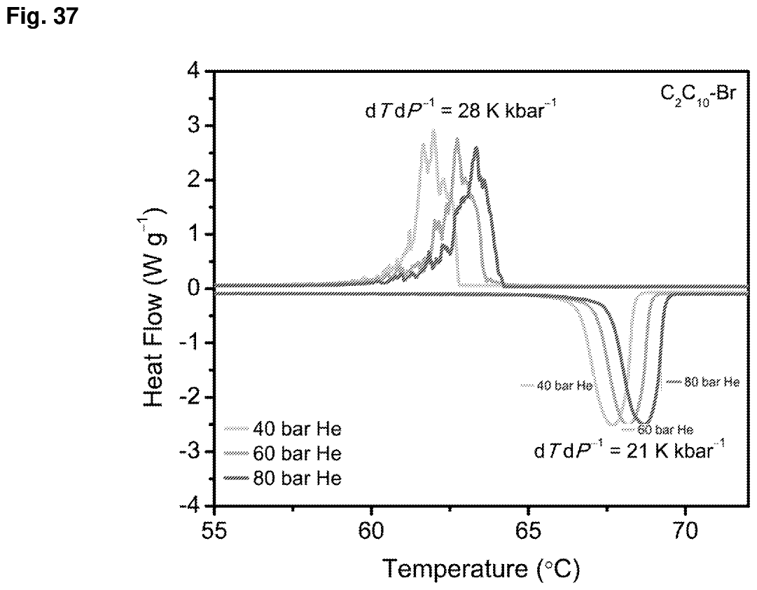

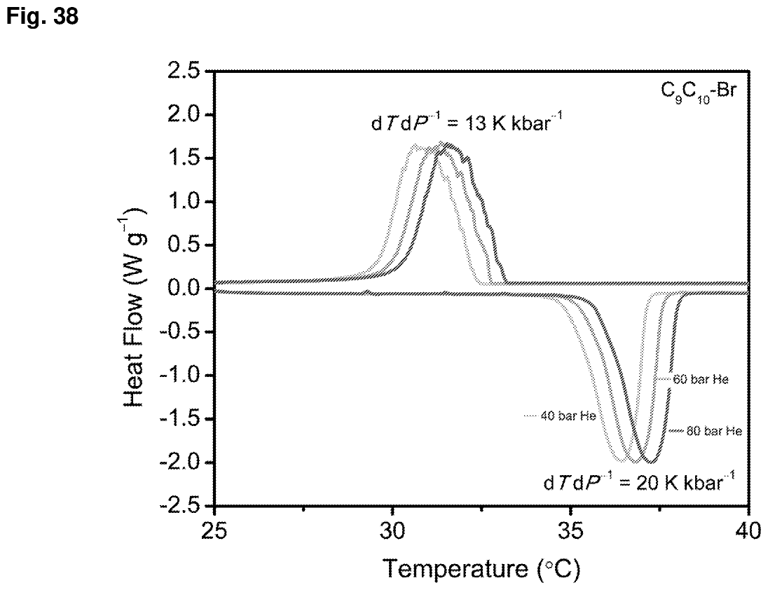

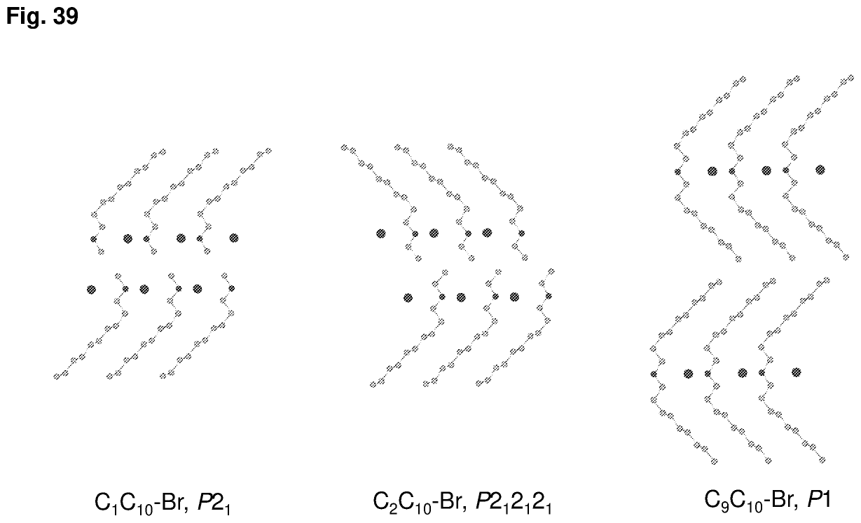

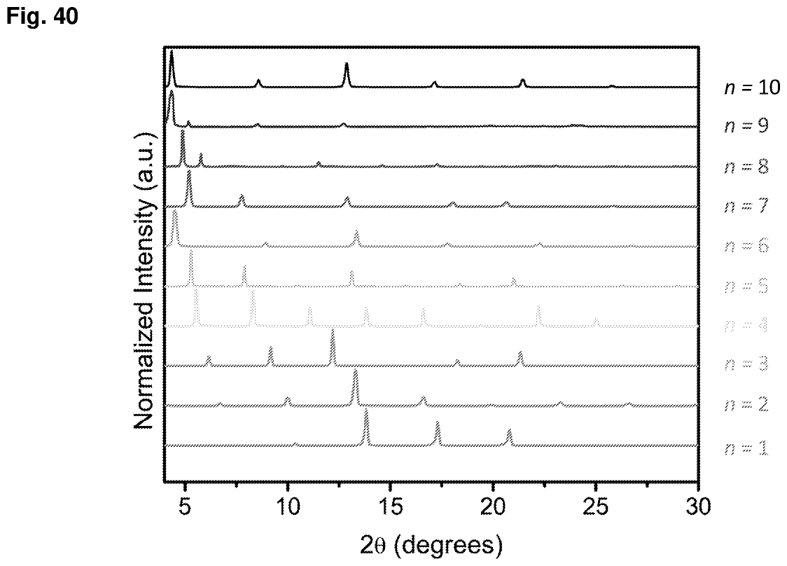

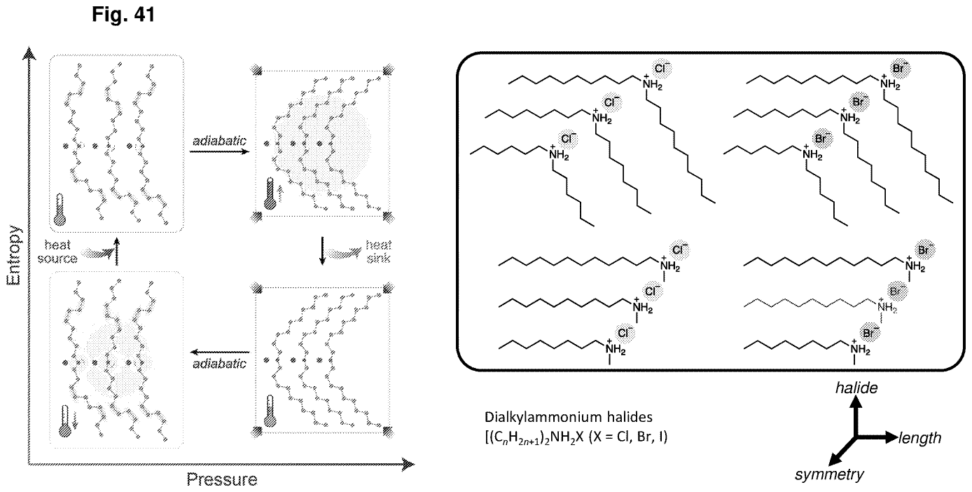

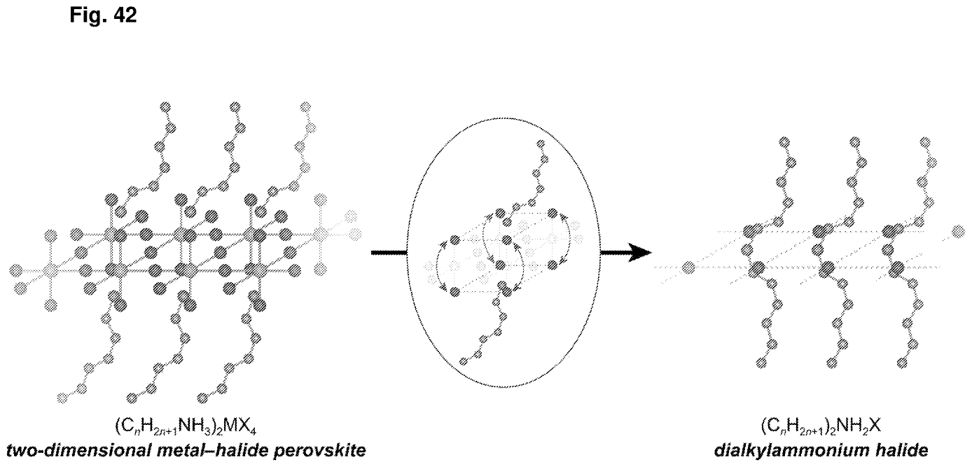

Another series of asymmetric soft organic bromide salts with di-n-alkylammonium cations comprising the di-n-alkylammonium bromide salt series CₙC₁₀—Br were synthesized and investigated (FIG. 31). In this series, the length of one alkyl substituent is fixed at 10 carbons, and the length of the other alkyl substituent is denoted by n. The results are shown in FIGS. 32-38. Crystal structure and powder XRD information are also shown in FIGS. 39 and 40.

### Single Crystal Structure Data

The crystal structures of several compounds at ambient pressure were determined by single-crystal X-ray diffraction, the results of which are shown in Table 7.

TABLE 7
Unit cell parameters for (asymmetric) dialkylammonium salts [(C₁₀H₂₁)(CH₃)NH₂Br],
[(C₁₂H₂₅)(CH₃)NH₂X] (X = Cl, Br), and [(C₁₀H₂₁)(C₁₀F₁₉H₂)NH₂Br]
obtained from single-crystal X-ray diffraction at ambient pressure at 100 K.

| Compound | a (Å) | b (Å) | c (Å) | α (°) |
|---|---|---|---|---|
| (C₁₀H₂₁)(CH₃)NH₂Br | 5.3412(2) | 5.3800(2) | 25.037(8) | 90 |
| (C₁₂H₂₅)(CH₃)NH₂Cl | 4.8858(3) | 5.2510(2) | 29.585(1) | 93.453(4) |
| (C₁₂H₂₅)(CH₃)NH₂Br | 5.3299(4) | 5.3390(4) | 28.010(2) | 90 |
| (C₁₀H₂₁)(C₁₀F₁₉H₂)NH₂Br | 49.264(6) | 5.2441(7) | 10.267(1) | 90 |

| | | | | Space |
|---|---|---|---|---|
| Compound | β (°) | γ (°) | V (Å³) | Group |
| (C₁₀H₂₁)(CH₃)NH₂Br | 94.026(5) | 90 | 717.679 | P2₁ |
| (C₁₂H₂₅)(CH₃)NH₂Cl | 94.633(4) | 90.810(4) | 755.012 | P1̅ |
| (C₁₂H₂₅)(CH₃)NH₂Br | 90.581(3) | 90 | 797.012 | P2₁ |
| (C₁₀H₂₁)(C₁₀F₁₉H₂)NH₂Br | 95.326(2) | 90 | 2641.03 | P2_{1/c} |

### Example 3—Barocaloric Effects in Dialkylammonium Halides

Example 3 described herein illustrates a series of experiments that characterize barocaloric effects in dialkylammonium halides. Non-limiting experimental methodologies include:

General. All compounds were synthesized and handled in air unless otherwise noted. Anhydrous diethyl ether was obtained from a Pure Process Technology anhydrous solvent system. Anhydrous ethanol and all other reagents were purchased from commercial vendors and used as received. Ultra-high purity (99.999%) gas was used for high-pressure experiments.

High-Pressure Differential Scanning Calorimetry (HP-DSC). DSC measurements over the pressure range from 1 to 150 bar were carried out in a Netzsch high-pressure DSC (DSC 204 HP Phoenix) equipped with a liquid nitrogen cooling system. The DSC sample cell is surrounded by an autoclave where the internal pressure and gas flow are regulated by an electronic pressure control device. The autoclave is connected to a circulating water bath that provides an additional source of external temperature control during experiments. Temperature and heat flow signals were calibrated at each measured pressure using an indium standard. Helium gas (ultra-high purity, 99.999%) or nitrogen gas (ultra-high purity, 99.999%) were used as a pressure-transmitting medium. All DSC samples were prepared in air. For powder samples, 3-5 mg of loosely packed ground single crystals were sealed in an aluminum pan with a pierced lid. An empty, aluminum pan with a pierced lid was used as a reference. All measurements were carried out under flowing gas with a flow rate of 50 mL min⁻¹. Unless otherwise noted, heating and cooling rates of 2 K min⁻¹ were used for isobaric measurements. To fully equilibrate samples at each pressure, samples were thermally cycled twice, and the DSC traces obtained from the second cycle were used for analysis.

Determination of Tₜᵣ, ΔHₜᵣ, and ΔSₜᵣ. Phase transition temperatures, Tₜᵣ, and enthalpies, ΔHₜᵣ, were determined using the TRIOS software from TA Instruments. Peaks were selected for analysis by defining a temperature range containing the peak of interest. The lower and upper bounds of the temperature range were chosen to encompass the phase transition, which starts with a deviation from the baseline and ends with a return to baseline. Prior to determination of Tₜᵣ or ΔHₜᵣ, a baseline, which models the heat flow in the absence of a phase transition, were generated to approximate the baseline in the transition region. Baselines were generated within the defined temperature range to determine the slope of the lower and higher temperature limits and shape of the baseline. Baselines were generated using mutual tangent slopes before and after the transition peak with a sigmoidal baseline, which was found to produce the most physically reasonable baselines. The extrapolated onset temperature was reported as the transition temperature. The onset temperature was determined by identifying the region of the onset transition peak that has the steepest slope, defining a tangent to that region, and then extending the tangent to the generated baseline. The intersection between the baseline and the tangent is reported as Tₜᵣ. Transition peaks were integrated between the upper and lower temperature limits with the baseline subtracted to provide ΔHₜᵣ, and phase transition entropies, ΔSₜᵣ, were calculated as ΔSₜᵣ=ΔHₜᵣ/Tₜᵣ. If physically reasonable limits were chosen, Tₜᵣ and ΔHₜᵣ did not depend strongly on the choice of the temperature limits, and such variations were within the error of the measurements, which is estimated to be ±0.04 °C for Tₜᵣ and <3% for ΔHₜᵣ based on repeated measurements of the melting transition of an indium standard.

Quasi-isothermal HP-DSC. During quasi-isothermal pressure cycling experiments, heat flow signals were measured as a function of time while applying or removing a hydrostatic He pressure of 150 bar.

The pressure was increased linearly at a rate of 2.3 bar min⁻¹ and decreased asymptotically at an average rate of 3 bar min⁻¹. He was used as the pressure transmitting medium to minimize the temperature fluctuation induced by pressure change, owing to its lower thermal conductivity.

Similar to the determination of the transition temperature, Tₜᵣ, the extrapolated onset pressures were defined as the transition pressure for pressure-induced endotherms and exotherms. Specifically, the onset pressure was determined by first generating baselines using mutual tangent slopes before and after the pressure-induced transition peak, with the intersection between the baseline and the tangent of the peak representing the onset point. The corresponding pressure at the onset time was reported as the phase transition pressure, and the pressure hysteresis was calculated as the difference between the phase transition pressures during compression and decompression.

During pressure cycling, quasi-isothermal conditions were maintained by adjusting the set temperature of the circulating water bath surrounding the autoclave to compensate for small temperature fluctuations induced by gas compression and decompression. Note that external thermal control measures were identical for all samples. Since the rate at which the pressure was decreased was faster than the rate it was increased, decompression resulted in a larger change in temperature (<0.5 K) than compression (<0.2 K). However, these small temperature changes were quickly recovered, such that the measured sample temperatures near the phase transition onsets were in close proximity during both compression and decompression (<0.1 K variation).

X-ray Crystallography. X-ray crystal structure data was collected from multi-faceted crystals of suitable size and quality selected from a representative sample of crystals of the same habit using an optical microscope. Each crystal was initially mounted at 100 K on a MiTiGen loop using Paratone-N oil. The reflections and intensities were collected using Apex Duo or Smart Apex II diffractometers with CCD detectors (MoKa radiation, A=0.71073 Å). All diffractometer manipulations were carried out using Bruker APEX3 software. Structure solution and refinement was carried out using XS, XT and XL software, embedded within OLEX2. For each structure, the absence of additional symmetry was confirmed using ADDSYM incorporated in the PLATON program.

Powder X-ray Diffraction. Powder X-ray diffraction data for soft organic salts were collected on beamline 17-BM-B, with an X-ray wavelength of 0.45185 Å. For variable temperature and pressure experiments, approximately 10 mg of sample was loaded into a sapphire capillary (1.52 mm×1.07 mm×50.8 mm, Saint-Gobain Crystals). Each capillary was attached to a custom-designed flow cell equipped with a gas valve, which was mounted onto the goniometer head. A syringe pump (Teledyne ISCO D65) was then connected via a 1/16″ gas line to the flow cell and used to control the hydrostatic pressure of He gas (ultra-high purity, 99.999%) from 90 to 300 bar. The internal sample temperature was monitored during PXRD experiments via a K-type thermocouple (0.1 K accuracy) that was in contact with the powder sample within the capillary. The sample temperature was controlled by an Oxford Cryostream (Oxford Cryostream 800+). Diffraction patterns were analyzed using the software TOPAS-Academic. Unit cell parameters of diffraction patterns were determined by using a standard peak search followed by indexing with a single value decomposition approach. A structureless Le Bail refinement was then performed to refine the unit cell parameters.

Computational details for DFT-calculated structures. DFT-calculated crystal structures were obtained using the Vienna ab initio simulation package (VASP). The generalized gradient approximation with Perdew-Burke-Ernzerhof (PBE) exchange-correlation functional (GGA-PBE), and the electron-ion interaction with projector augmented wave (PAW) pseudopotentials, and the DFT-D3 method of Grimme to consider the van der Waals (vdWs) interaction were used. We employed 600 eV as an energy cutoff for the plane wave part of the wave function, a gamma k-point grid of (3×3×3). In geometry optimizations, the total energy was converged to 10⁻⁴ eV, and the forces on each relaxed atom were less than 0.001 eV/Å. 4:13 High-pressure Raman spectroscopy. In situ Raman spectra were collected on a Renishaw InVia spectrometer using 633 and 785 nm excitations for the C—H stretching (2700-3100 cm⁻¹) and fingerprint (1200-1600 cm⁻¹) regions, respectively. The spectral resolution is −0.1 cm⁻¹. The spectrograph is calibrated using the Raman mode of silicon at 520.2 cm⁻¹. Measurements over pressure range from 1 to 1000 bar under constant temperature of 312K are carried out in a hydrostatic pressure microscopic cell (PMC-400, Syn-corp.) equipped with yttrium aluminum garnet (YAG) windows. Pressure is controlled with a manual hydraulic pump (HP-500, Syn-corp.) using deionized water as the pressure medium.

Temperature is controlled by recirculating water. The fluctuations of pressure and temperature are below 10 bar and 1 °C. Note that Raman spectrum of the di-n-hexylammonium cation is simulated with DFT using the PBEO functional, the aug-cc-pvdz basis set, and Grimme's D3 dispersion correction with Becke-Johnson damping. The calculation is performed with the Gaussian 16 code.

Solution growth of crystalline films onto substrates. Films of (C₆)₂Br were grown onto p-type<100> Si substrates by anti-solvent vapor assisted slow evaporation. (C₆)₂Br powder was dissolved into methanol, and sufficient solution was pipetted to fully cover the substrate surface. This was enclosed in a chamber alongside vials of diethyl ether and maintained at 20 °C on a TECA thermoelectric cold plate for several days until dry.

Topographic and mechanical characterization of (C₆)₂Br films. A Motic Panthera TEC microscope and an Instec precision temperature controller were used to perform variable temperature optical microscopy of films of (C₆)₂Br. Variable temperature atomic force microscopy (AFM) experiments were carried out on a Bruker JPK NanoWizard BioAFM, using the QI mode to simultaneously perform topographical imaging and force spectroscopy. AFM topographical images were processed in JPK Data Processing software by plane fitting, line levelling, and applying a median filter, showing a root mean square roughness over a 720-μm² area of 3.083 nm at 20 °C and 2.998 nm at 27 °C. AFM force spectroscopy was performed using a calibrated 32 N m⁻¹ tip with a quadratic pyramid geometry on a rectangular cantilever. Force-distance data was also processed in JPK Data Processing software, where all curves were fit by a Hertzian model with identical fitting parameters and calibrations. Elastic modulus maps were compiled by batch processing the force-data curve from each pixel in the topographical image, then applying median and low-pass filters. Histograms showing the frequency of fitted elastic modulus values from the mapped areas and their average values were binned and compiled through the JPK Data Processing software.

Nanocalorimetry measurement. All nanocalorimetry measurements were performed using a parallel nano-scanning calorimeter (PnSC) device. The device contains a 5×5 array of independently controlled nano-calorimeter sensors capable of thermal characterization of samples with very small thermal mass. Each sensor consists of tungsten thermistor in a four-point measurement configuration that serves both as heating element and as resistance thermometer. The tungsten thermistor is fully encapsulated in a thin freestanding silicon nitride membrane, which, in turn, is supported by a silicon frame. During a typical calorimetry measurement, a current is applied to the thermistor. The current and the voltage drop across the thermistor are used to determine the power supplied to the sensor and the resistance of the thermistor, which is calibrated to temperature by measuring the resistance as a function of temperature in a vacuum furnace.

This example shows that di-n-alkylammonium halide salts can undergo reversible hydrocarbon phase transitions accompanied by large entropy changes and pressure sensitivity, the combination of which can give rise to strong barocaloric effects near ambient temperature.

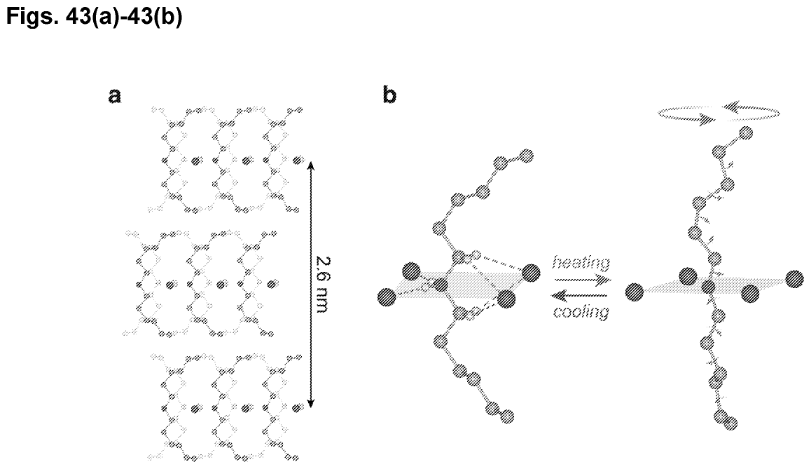

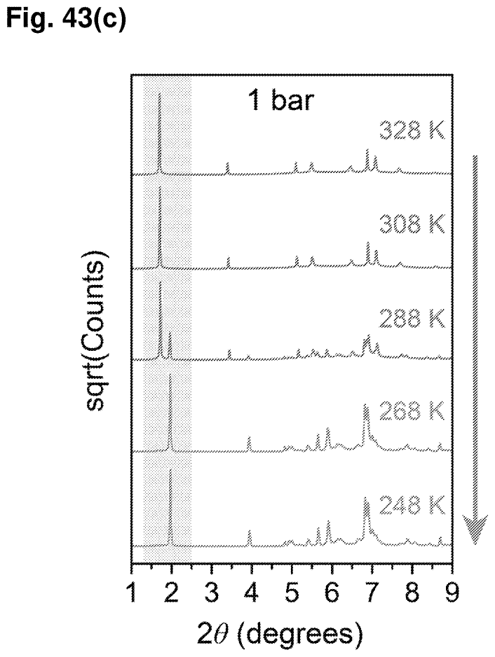

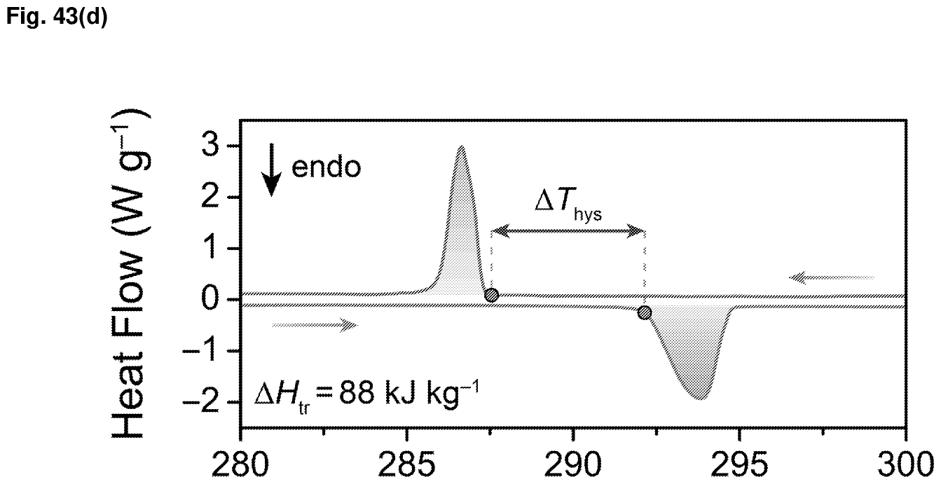

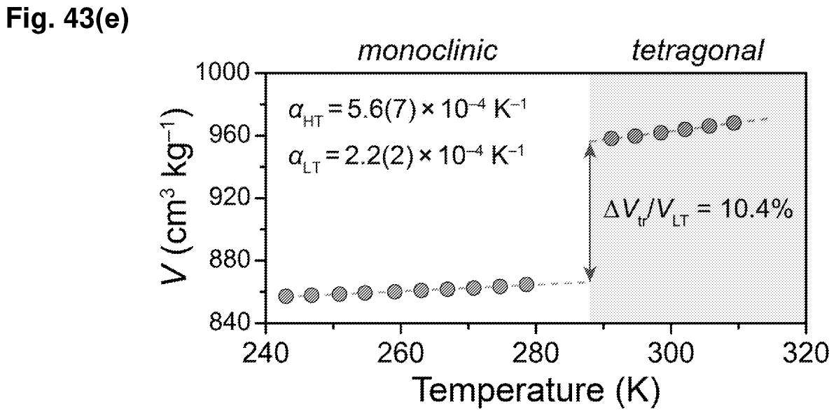

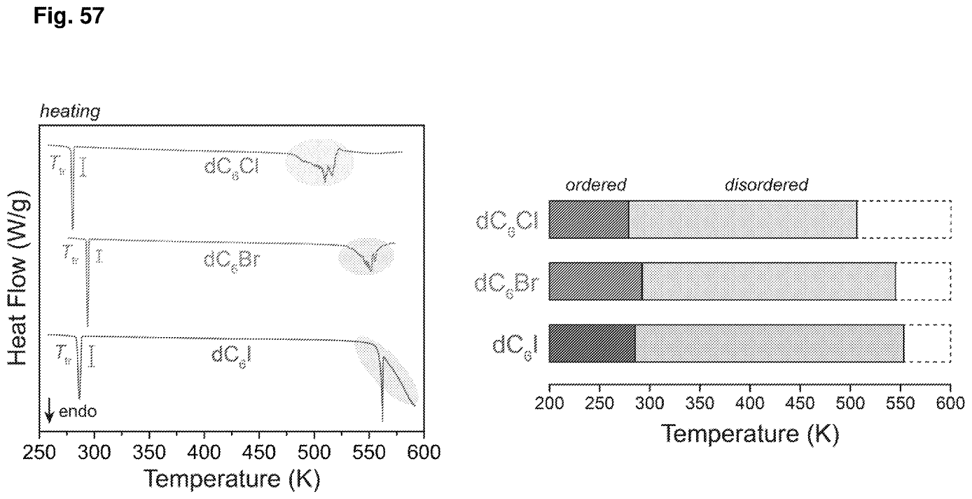

In this example, (C₆)₂Br [(C₆)₂=dihexylammonium] was chosen as a representative compound where its phase transitions at ambient pressure were investigated. As shown in differential scanning calorimetry (DSC) traces in FIG. 43(d), the crystalline powder of (C₆)₂Br upon heating undergoes a thermally-indued phase transition at the transition temperature (Tₜᵣ) of 292 K, with a transition entropy change, ΔSₜᵣ, of 300 J K⁻¹ kg⁻¹ (300 J K⁻¹ L⁻¹) and transition enthalpy change, ΔHₜᵣ, of 88 kJ kg⁻¹. The gravimetric and volumetric ΔSₜᵣ values of (C₆)₂Br are about 3.9 and 2.6 times larger than ΔSₜᵣ for 2-D perovskite (C₉)₂CuBr₄, respectively. Notably, despite having a shorter chain, (C₆)₂Br displays a molar ΔSₜᵣ of 80 J K⁻¹ mol⁻¹, which is substantially larger than the molar ΔSₜᵣ of 51 J K⁻¹ mol⁻¹ for (C₉)₂CuBr₄. In fact, when compared to a molar ΔSₜᵣ for a 2-D perovskite containing hexyl chain, (C₆)₂MnCl₄ (C₆=hexylammonium), which also undergoes an order-disorder transition near 292 K, the molar ΔSₜᵣ of (C₆)₂Br is still more than twice as large. Given its low melting entropy (<20 J K⁻¹ mol⁻¹) and high melting point (>520 K) (FIG. 57), the large solid-state ΔSₜᵣ of (C₆)₂Br indicates that a substantial fraction of lattice disordering can occur upon the solid-solid phase transition, rather than the melting transition.

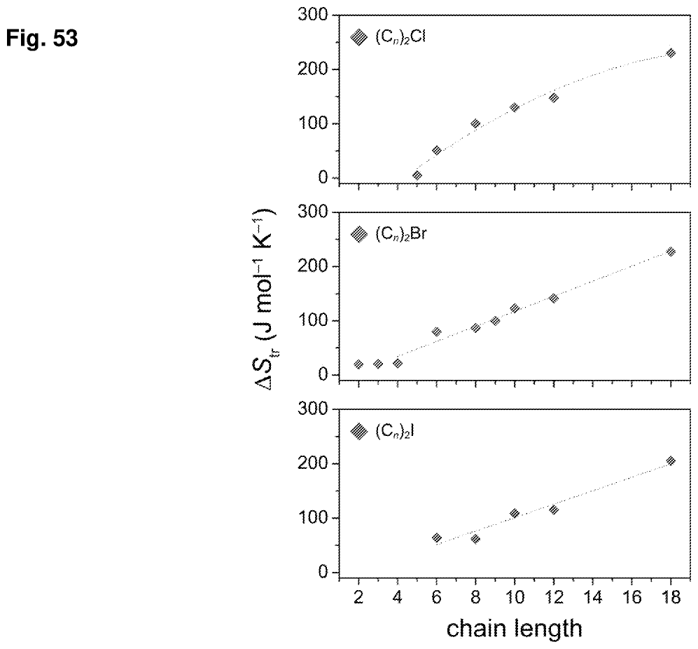

Furthermore, the molar ΔSₜᵣ for (Cₙ)₂Br (n=2-18) monotonically increase at increasing the chain length (FIG. 53), suggesting that the solid-state transitions for long-chain analogs may be driven mainly by conformational disordering of hydrocarbon chains.

Structural factors responsible for phase transitions of (C₆)₂Br were investigated by performing X-ray diffraction measurements. First, the structure of (C₆)₂Br in the low-temperature (LT) phase was determined by single-crystal X-ray diffraction at 100 K (FIG. 43(a)). In the monoclinic (C₂/c) phase, the dihexylammonium cations pack into non-interdigitated bilayers, weakly held through van der Waals interactions, with interlayer spacing of 13.1 Å. Each ammonium cation is confined within a square plane of four Br anions, primarily through two in-plane N—H . . . Br hydrogen bonding. Note that the area of the Br plane is 28.7 Å², which is on par with the area for the Br plane in Cu—Br perovskites (29 Å²). In addition, the electron-deficient carbon atoms (C1 and C1′) near the ammonium center also contribute to the chain confinement, by engaging in dipole-halide (C—H . . . Br) interactions with two remaining Br. The two hexyl chains, each of which protrudes out of the Br plane, are slightly distorted from each other, adopting a dihedral angle of 60° with one another. Notably, the hexyl chains feature C2-C3 torsion angles of 65°, similar to alkylammonium chains in 2-D perovskites that also display a C2-C3 gauche bond in LT phase. In both cases, the C2-C3 gauche bonds can serve as a key structural factor that guides energetic stabilization within and between alkyl chains, governing the molecular conformation of the hydrocarbon chains and thereby the interlayer spacing.

Variable-temperature powder X-ray diffraction (PXRD) experiments were then performed to probe structural changes that accompany the phase transition (FIG. 43(c)). Upon cooling, (C₆)₂Br undergoes a transition from an expanded, high-temperature (HT) phase (tetragonal 14/mmm) to a contracted LT phase (monoclinic C₂/c), with a large volume change (ΔVₜᵣ) of 10.4% (FIG. 43(e)). The volume change is highly anisotropic, largely occurring through the change in interlayer distance (d), with Δd/dLT of 13.4% (FIG. 56).

The variable-temperature PXRD revealed that the thermal expansivity (a) of the high-entropy HT phase is noticeably larger than for the low-entropy LT phase, with α_{HT}=5.6(7)×10⁻⁴ K⁻¹ and α_{LT}=2.2(2)×10⁻⁴ K⁻¹, indicating that strong anharmonicity may be present in the disordered hydrocarbons. In addition, HT-phase powder patterns feature strong diffuse scattering background (FIG. 43(c)). Taken together, these results suggest that the dihexylammonium cations can be dynamically disordered in the high-symmetry, expanded phase.

In this example, attempts to determine the HT-phase crystal structure of (C₆)₂Br were challenging owing to the extreme mechanical plasticity of the crystal at elevated temperatures. Atomic force microscopy (AFM) force spectroscopy revealed that the elastic modulus of thin-film samples of (C₆)₂Br at 300 K is 0.9 GPa (FIGS. 59(a)-(b)), supporting that its disordered state may be associated with substantial softness.

Alternatively, density functional theory (DFT) calculation enabled the modeling of a HT phase structure using the single-crystal structure at 100 K and PXRD unit-cell dimensions at 330 K.

As shown in FIG. 43(b), the dihexylammonium cation in the HT phase can become axially elongated, with two hexyl chains tilting up from the Br plane, featuring noticeable conformational changes. In the HT phase the gauche conformation-present only in C₂-C₃ in the LT phase—can be observed across the whole chain. Furthermore, the conformational switching can involve weakening of hydrogen bonds, as indicated by Hirshfeld surface analysis visualizing the elongation and distortion of N—H . . . Br and C—H . . . Br contacts. Nevertheless, despite these changes the Br plane hosting the dihexylammonium chain remains largely intact in the HT phase, with minimal change in its area. The presence of the in-plane hydrogen bonding in the HT phase is supported by the infrared spectrum featuring strong absorption bands near 2900 cm⁻¹, which can indicate a large redshift in N—H stretching vibrations. Overall, these results can suggest that the hydrogen bonding between ammonium chains and bromides persists in the HT phase and can provide long-range crystalline order, highlighting the critical roles halides may have in governing the internal degrees of freedom of the confined chains.

These structural insights indicate that the microenvironments around the organic chains can have direct impacts over phase-change thermodynamics of their order-disorder transitions. Specifically, the halide substitution may offer a simple strategy to establish structure-property relationship that governs the thermodynamics of the hydrocarbon phase transitions, because it can enable fine-tuning of the chain confinement without altering the hydrogen bond topology. To this end, (C₆)₂Cl and (C₆)₂I were synthesized and their phase-change thermodynamics were evaluated.

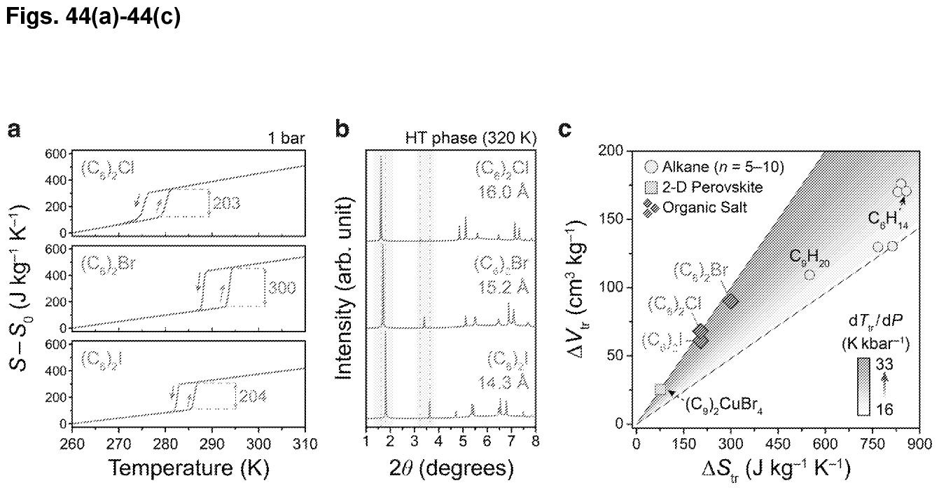

Temperature-entropy curves obtained from ambient-pressure DSC illustrate that (C₆)₂Cl and (C₆)₂I undergo reversible solid-solid transitions below room temperature, at Tₜᵣ (heating) of 279 K and 285 K, respectively (FIG. 44(a)). Both phase transitions are accompanied by large changes in entropy, with ΔSₜᵣ of 203 J K⁻¹ kg⁻¹ (45 J K⁻¹ mol⁻¹) and 204 J K⁻¹ kg⁻¹ (64 J K⁻¹ mol⁻¹) for (C₆)₂Cl and (C₆)₂₁, respectively. Note that (C₆)₂Cl undergoes a minor transition at 115 K with a small ΔSₜᵣ of 36 J K⁻¹ kg⁻¹ (8 J K⁻¹ mol⁻¹), which may be associated with the onset of rotation of dihexylammonium. The total ΔSₜᵣ for (C₆)₂Cl may be on par with the total ΔSₜᵣ for 2-D perovskite (C₆)₂MnCl₄. Similar to (C₆)₂Br, both compounds undergo melting transitions well above room temperature, at 470 K and 490 K for (C₆)₂Cl and (C₆)₂₁, respectively (FIG. 57). Importantly, unlike 2-D perovskites that start thermal decomposition near 420 K, (C₆)₂X (X═Cl, Br, I) can be thermally stable up to the melting points, providing a wide temperature window over which the order-disorder transitions can be utilized. Note that this feature also distinguishes dialkylammonium halides from rotator phases of n-alkanes, which may be observed only over a narrow temperature range (<10 K) between a crystalline solid and isotropic liquid.

The interlayer spacing for (C₆)₂X, determined in the HT phase (320 K), decreases at increasing halide size, from 16.0 Å (Cl) to 15.2 Å (Br) to 14.3 Å (I) (FIG. 44(b)). This trend may arise because the dihexyl chains adopt to the increasing area of the halide plane by increasing their cross-sectional area through the lowering of tilting angles. Note that fluoride analogs may not undergo solid-solid transitions, because the small size of fluoride anions (r_{F}=133 μm) may not fulfill packing requirements to host disordered dialkylammoniums whose rotational diameter is on the order of 400-500 μm.

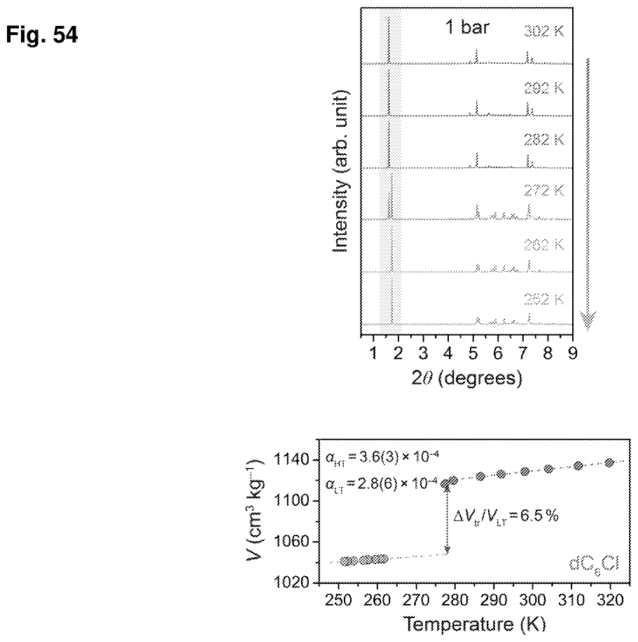

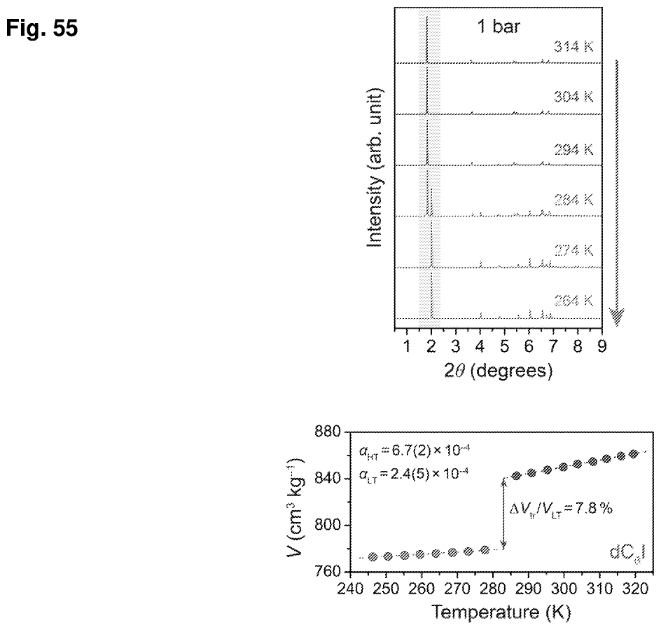

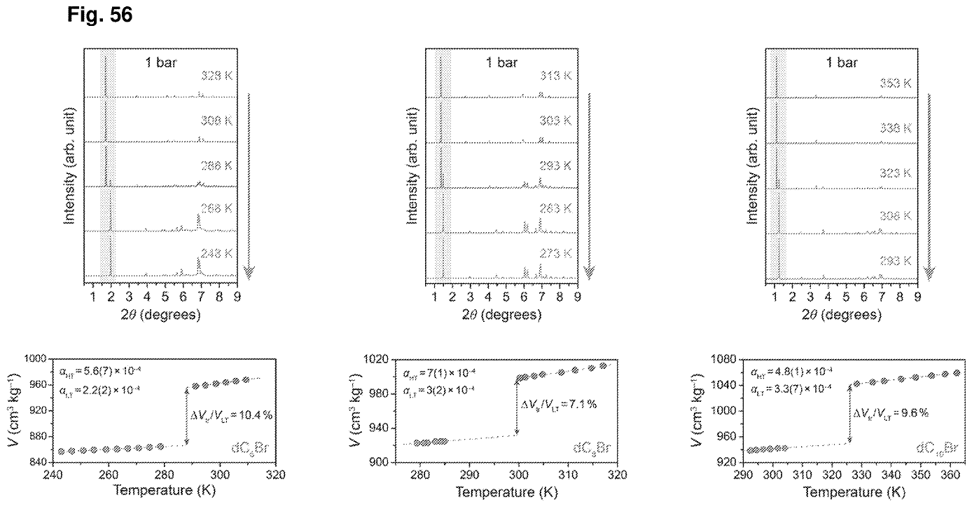

Variable-temperature PXRD experiments demonstrate that both (C₆)₂Cl and (C₆)₂I undergo large, anisotropic volume changes upon the phase transitions, with ΔVₜᵣ of 6.5% [(C₆)₂C] and 7.8% [(C₆)₂₁](FIGS. 54-55). ΔVₜᵣ values- and the ΔSₜᵣ values determined from DSC measurements-were used to estimate the pressure dependence of the transition temperature, dTₜᵣ/dP, through the Clausius-Clapeyron relation (dTₜᵣ/dP=ΔVₜᵣ/ΔSₜᵣ). dTₜᵣ/dP, also known as barocaloric coefficient, can represent the pressure sensitivity of the phase transition and can thus be critical to determining the performance and operating conditions of a barocaloric material, as it can dictate the magnitude of pressure shift (ΔP) needed to induce a given thermal change (ΔT). The calculations show that phase transitions in (C₆)₂X all feature high sensitivity to pressure: 33 K kbar⁻¹ (Cl), 30 K kbar⁻¹ (Br), and 30 K kbar⁻¹ (I). These values may be similar to pressure sensitivity values observed in 2-D perovskites and may be larger than those observed for melting transitions in n-alkanes (20 K kbar⁻¹). Despite the differences in how the hydrocarbon chains may be confined (halide planes for dialkylammonium halides, corner-sharing metal-halide octahedra for 2-D perovskites, and lack of confinement for n-alkanes), these hydrocarbon materials can all display similarly high dTₜᵣ/dP values, suggesting that hydrocarbon order-disorder transitions may generally feature strong coupling between ΔSₜᵣ and ΔVₜᵣ.

While the interlayer spacing for (C₆)₂X (X═Cl, Br, I) decrease at increasing size of halides, their molar ΔSₜᵣ—which can be highly correlated to ΔVₜᵣ—exhibit a volcano trend, with C (45 J K⁻¹ mol⁻¹; 6.5%)<I (64 J K⁻¹ mol⁻¹; 7.8%)<Br (80 J K⁻¹ mol⁻¹; 10.4%). Single-crystal structure analyses show that substituting C₁ with Br in dialkylammonium halides is accompanied by 13% expansion of the halide plane, from 25.5 Å² (Cl) to Br 28.7 Å² (Br). Such an expansion may be accompanied by the weakening of hydrogen bonding in the Br plane, which may lower the energy barriers for orientational and conformational motions of dihexyl chains. This effect, when combined with the increased free volume in (C₆)₂Br, may promote the flexible organic cations to access larger degrees of freedom in the Br plane than in the C₁ plane. Upon further enlargement of the halide plane to charge-diffuse 1, the confinement strength- and energy barriers—may be lowered to a greater extent, which may allow the dihexylammonium cations to gain access to residual thermal motions even in the LT phase. The excitation of such thermal motions in the LT phase, which may be indirectly estimated using heat capacity measurements, can partially explain why ΔSₜᵣ is lower in (C₆)₂I than in (C₆)₂Br.

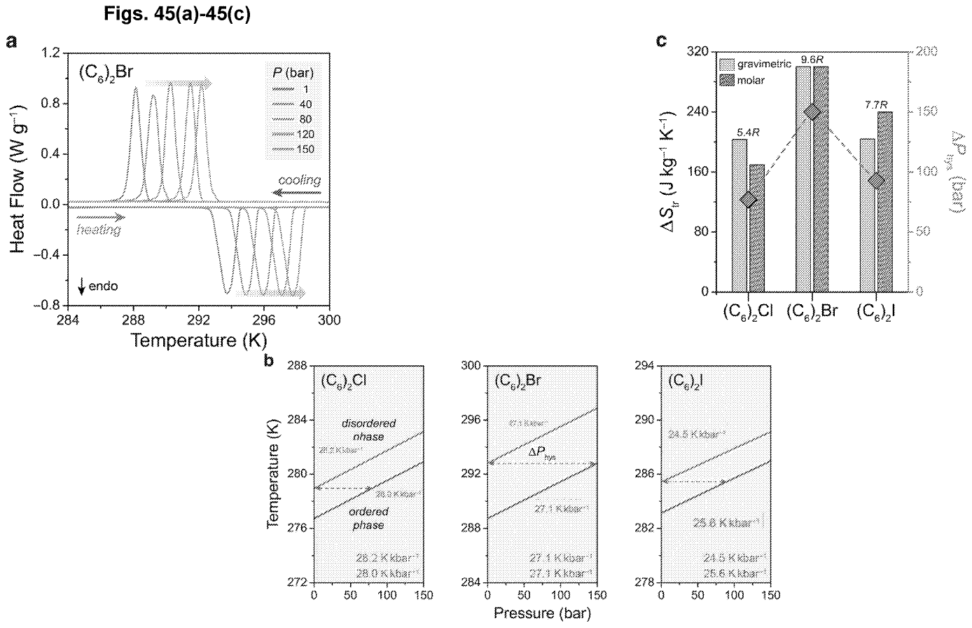

Pressure-temperature phase diagram. To experimentally probe barocaloric effects in in (C₆)₂X, isobaric high-pressure differential calorimetry (HP-DSC) measurements were performed. In these experiments, onset transition temperatures—as well as transition enthalpies and entropies—of thermally-induced transitions were determined as a function of pressure up to 150 bar, with He as the pressure-transmitting medium (FIG. 45(a)). The resulting pressure-temperature (P-T) diagrams feature phase boundaries that allow evaluation of pressure sensitivity and hysteresis (FIG. 45(b)). In the P-T diagrams the slopes represent d Tr/dP values, and the metastable region defined between heating and cooling boundaries illustrates thermal hysteresis (ΔT_{hys}), which corresponds to the difference between heating and cooling transition onsets at a given pressure.

Hysteresis can represent an additional energy barrier needed to be overcome to drive first-order phase transitions in a reversible manner, and can cause dissipation of input energy that negatively impacts efficiency, power, and longevity of caloric cooling cycles. As such, the reversibility- and effectiveness—of barocaloric effects arising from pressure-induced phase change can be inversely correlated to hysteresis.

For evaluation of barocaloric materials, pressure hysteresis (ΔP_{hys})—in this example defined as the difference in onset pressures between compression-driven ordering and expansion-induced disordering transitions—is an important metric. Just as a temperature swing wider than the width of a thermal hysteresis loop may be required to reversibly drive thermal transitions in full, reversibly driving pressure-induced phase change may require a pressure swing larger than the pressure hysteresis. Thus, ΔP_{hys} may represent a minimum operating pressure required to induce reversible barocaloric effects and, importantly, may provide a useful metric to evaluate reversibility of barocaloric transitions across a broad range of materials.

As illustrated in FIG. 45(b), (C₆)₂Br displays thermal hysteresis of 4 K, whereas (C₆)₂C₁ and (C₆)₂I exhibit a lower ΔT_{hys} of 2 K. On a P-T phase diagram, ΔPhys can be manifested as the horizontal width of the hysteresis region defined between cooling and heating boundaries, and thus can be calculated using ΔT_{hys} and phase boundaries (dTₜᵣ/dP):

$$\frac{{dT}_{tr}}{dP} \approx \frac{Δ {T}_{hys}}{Δ {P}_{hys}} \qquad ( 1 )$$

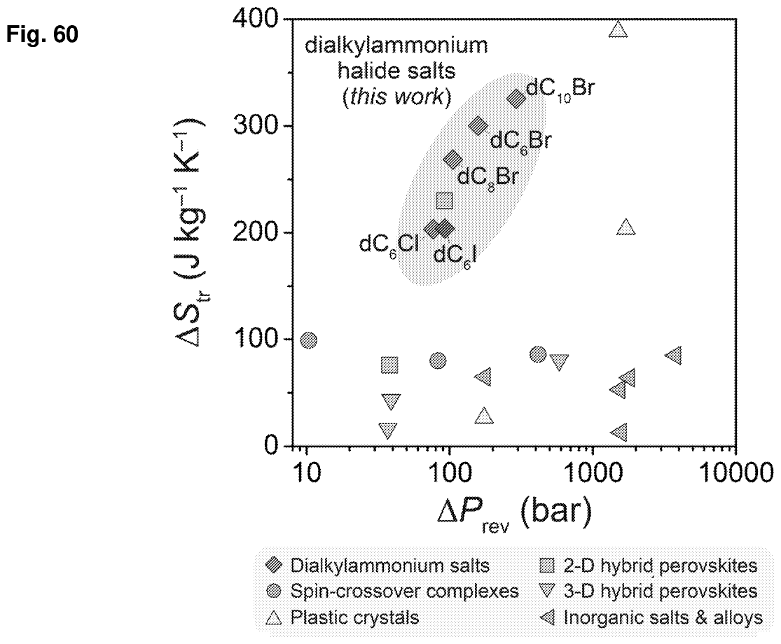

Using equation 1, ΔP_{hys} were calculated to be 76 bar (Cl), 149 bar (Br), and 98 bar (1), suggesting that a minimum pressure change of 80-150 bar would be required to run cooling cycles with (C₆)₂X. Specifically, it is worth highlighting that dialkylammonium halides, along with 2-D perovskites, may represent one of few materials that display a combination of large entropy changes (>200 J K⁻¹ kg⁻¹) and low pressure hysteresis (<200 bar) (FIG. 60).

Interestingly, as shown in FIG. 45(c), the calculated ΔP_{hys} values are correlated to the transition entropy changes, suggesting that there may be a trade-off between the reversibility and magnitude of barocaloric effects in (C₆)₂X. Given that ΔSₜᵣ is also correlated to ΔVₜᵣ in FIG. 44(c), the volume change—which can approximate the geometric differences between low-entropy and high-entropy phases—may be a key factor to understanding the entropy-hysteresis relationship. The difference and mismatch in lattice volume between the two phases can generate stress at the interface during the transition, giving rise to an energy barrier that causes the transition hysteresis.

Evaluation of barocaloric effects. Isothermal entropy curves were constructed through the quasi-direct method to evaluate barocaloric effects in (C₆)₂X (X═Cl, Br, I). In this approach, isobaric entropy curves, S_{ib}(P, T), are first calculated using the heat flow and heat capacity data obtained from isobaric DSC measurements. ΔSᵢₜ curves, which can describe entropy changes induced by a shift in pressure over a temperature range, are then obtained by subtracting isobaric entropy curves at two different pressures.

For the disordering transition that is induced by decompression from applied pressure P to ambient pressure P₀, ΔSᵢₜ curve is calculated from S_{ib} curves associated with heating transitions, with ΔSᵢₜ (P→P₀)=S_{ib,heating} (T, P₀)−S_{ib,heating} (T, P). Similarly, for the compression-induced ordering transition, S_{ib} curves obtained from cooling transitions are used to yield the ΔSᵢₜ curve, with ΔSᵢₜ (P₀→P)=S_{ib,cooling} (T, P)−S_{ib,cooling} (T, P₀).

The resultant ΔSᵢₜ curves for (C₆)₂X (X═Cl, Br, I) illustrate the impact of hysteresis can have on accessing reversible barocaloric effects (FIG. 46(a)-46(c)). The ΔSᵢₜ curves for (C₆)₂C₁ and (C₆)₂I show that the sizable amount of reversible isothermal entropy changes (ΔSᵢₜ,rev) can be induced by 150-bar operating pressure. As expected from their pressure hysteresis (76 bar for Cl; 98 bar for I), the ΔSᵢₜ,rev values-highlighted by the shaded area within the overlapping ΔSᵢₜ curves-start to arise above 80 bar and 120 bar for (C₆)₂C₁ and (C₆)₂₁, respectively (FIG. 46(a) and 46(c)). The reversible entropy changes approach the maximum values (ΔS_{it,rev,max}) of 71 J K⁻¹ kg⁻¹ and 113 J K⁻¹ kg⁻¹ at 150 bar (FIG. 46(d)). The 150-bar ΔSᵢₜ,rev curves for both compounds feature 2-K temperature window over which the reversible phase change can be accessed. In contrast, compression and decompression ΔSᵢₜ curves for (C₆)₂Br do not overlap below 150 bar, due to its relatively large pressure hysteresis of 149 bar (FIG. 46(b)). The lack of overlap in ΔSᵢₜ can denote that there is no temperature range over which ΔSᵢₜ,rev can be induced from a cyclic change in pressure. At 150 bar, a very small overlap in ΔSᵢₜ curves arises, with a maximum entropy change of 12 J K⁻¹ kg⁻¹ at 293 K (FIG. 46(d)); however, the temperature window is limited, as the ΔS_{it,rev,max} quickly vanishes outside the peak temperature of 293 K.

Although the 150-bar driving pressure may be above the pressure hysteresis for (C₆)₂X, the maximum entropy changes accessible at 150 bar are still lower than their ΔSₜᵣ values (FIG. 46(d)), indicating that the ΔSᵢₜ,rev may arise from partial phase transformations. This is because first-order phase transitions can be associated with finite peak width (ΔT_{width}). To access full entropy of transitions, a hysteresis loop created between heating and cooling entropy curves at an applied pressure may need to be fully separated from a hysteresis loop at ambient pressure, to an extent that the temperature shift in the hysteresis loop can surpass the combination of ΔT_{hys}, ΔT_{width,heating}, and ΔT_{width,cooling}. Such a pressure, denoted as P_{rev,full}, can be estimated using P_{rev,full}=(A T_{hys}+ΔT_{width,heating}+ΔT_{width,cooling})/(dTₜᵣ/dP). Above P_{rev,full}, reversible adiabatic temperature changes can also become accessible. The quasi-direct analysis suggests that P_{rev,full} of 253 bar, 257 bar, and 200 bar may be required to fully overcome hysteresis for (C₆)₂Cl, (C₆)₂Br, and (C₆)₂₁, respectively. Note that the maximum possible magnitudes of adiabatic temperature changes (ΔT_{ad,max}) can be estimated using the indirect calculation ΔT_{ad,max}(T)=−TΔS_{it,max}/C_{P}, where cₚ is an ambient-pressure heat capacity and ΔSᵢₜ,max is a maximum isothermal entropy change. ΔT_{ad,max} values for (C₆)₂X are 33 K (Cl), 59 K (Br), and 45 K (I), which can be accessed at 1150 bar, 2187 bar, and 1842 bar, respectively.

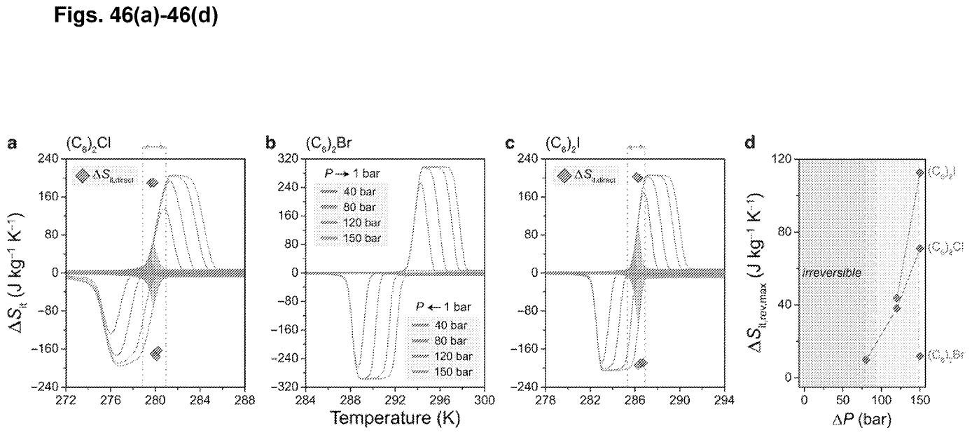

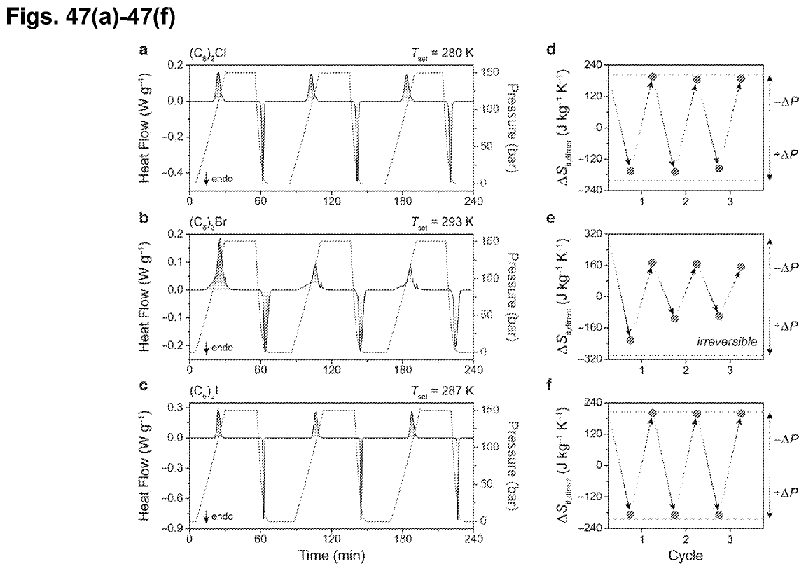

Isothermal pressure-swing DSC. Isothermal pressure swing DSC measurements were carried out to directly evaluate barocaloric effects in (C₆)₂X (X═Cl, Br, I; FIGS. 47(a)-47(f)). In these experiments, heat flow signals are measured as a function of time, as the hydrostatic pressure is continuously shifted between 1 bar and 150 bar. By capturing the compression-induced exotherms and decompression-induced endotherms, pressure-swing DSC can enable direction characterization of thermal energy (qᵢₜ) absorbed and released during the isothermal phase change, as well as and pressure hysteresis.

As shown in FIGS. 47(a)-47(c), each compound-initially equilibrated in the high-entropy phase under ambient pressure-upon compression undergoes an exothermic transition to the low-entropy phase.

Removal of the pressure triggers the transformation back to the high-entropy phase, as illustrated by a sharp endotherm, and the pressure-induced phase transitions were evaluated over three consecutive cycles. Throughout the pressure swing, the sample temperature was equilibrated about 1 K above ambient-pressure T_{tr,heating}. These set temperatures, Tₛₑₜ, were determined based on the P-T diagrams and isothermal entropy curves to ensure that reversible transitions are allowed at the temperature, and to capture onset transition pressures for exotherms and endotherms well below 150 bar and above 1 bar, respectively. Accordingly, the Tₛₑₜ for (C₆)₂X-280 K (Cl), 293 K (Br), and 287 K (I)—all fall within the reversible temperature window, as shown in FIGS. 46(a)-(c). From the cycling data, qᵢₜ values for exotherms and endotherms are obtained by calculating the area under the transition peaks. Using qᵢₜ, isothermal entropy changes, ΔS_{it,direct}, can be calculated using ΔS_{it,direct}=qᵢₜ/Tₛₑₜ. Although the use of He gas as the pressure medium led to small temperature fluctuations (ΔT<0.2 K) during the pressure cycling in this example, the temperature fluctuation quickly stabilized near the transition onset with ΔT<0.1 K, indicating that quasi-isothermal conditions.

As shown in FIGS. 47(d) and 47(f), pressure-induced phase transitions in (C₆)₂C₁ and (C₆)₂I were reversible under the 150-bar operating pressure. ΔS_{it,direct} calculated from the heat flow traces approached nearly full transition entropy, with 82% (compression) and 93% (decompression) of ΔSₜᵣ for (C₆)₂C₁ (163-190 J K⁻¹ kg⁻¹), and 92% (compression) and 98% (decompression) of ΔSₜᵣ for (C₆)₂I (189-200 J K⁻¹ kg⁻¹). Note that the compression ΔS_{it,direct} were consistently smaller than the decompression ΔS_{it,direct} because the compression step was carried out at a slower rate (6 bar min⁻¹) than the decompression step (13 bar min⁻¹) and thus may be associated with a larger dissipation of heat signals. The ΔS_{it,direct} values remained unchanged over the three cycles, demonstrating that the 150-bar pressure swing can provide a sufficient thermodynamic driving force for (C₆)₂Cl and (C₆)₂I to transition reversibly between low-entropy and high-entropy phases. In this example, the results were overall in agreement with the ΔSᵢₜ curves calculated from isobaric HP-DSC measurements (FIG. 46(a) and 46(c)), directly validating the reversible temperature window predicted from the quasi-direct analysis.

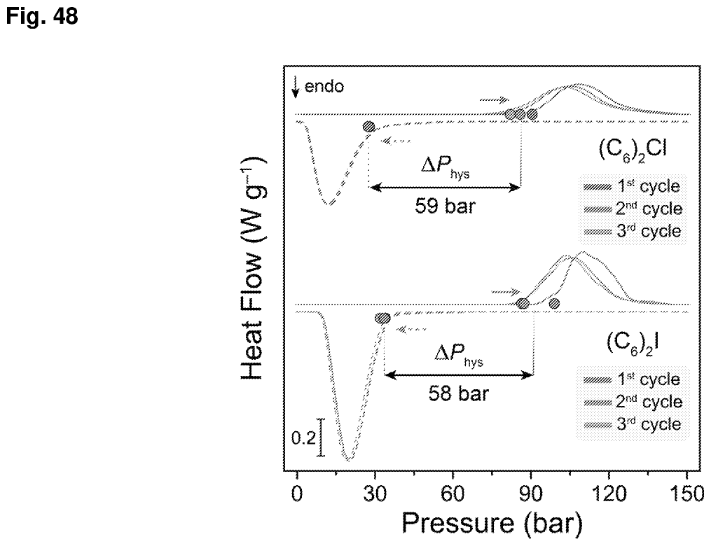

By contrast, (C₆)₂Br displays limited reversibility under the 150-bar swing (FIGS. 47(b) and 48(e)). The isothermal entropy changes determined from the 1^{st} cycle were substantially lower than its full transition entropy, with 74% of ΔSₜᵣ (223 J K⁻¹ kg⁻¹) and 58% of ΔSₜᵣ (174 J K⁻¹ kg⁻¹) for compression and decompression, respectively. Furthermore, the ΔS_{it,direct} values decreased over the three cycles, ultimately approaching 33% of ΔSₜᵣ (compression) and 50% of ΔSₜᵣ (decompression). This result indicates that (C₆)₂Br may only undergo partial phase transformations under these conditions, with the amount of phase fraction available for phase change decreasing over time. Consistent with the quasi-direct analysis illustrating a limited temperature window for ΔSᵢₜ,rev at 150 bar (FIG. 46(b)), this experiment demonstrates that an operating pressure sufficiently larger than ΔP_{hys} may be required to drive reversible phase change in full.

For (C₆)₂C₁ and (C₆)₂₁, heat flow traces were plotted as a function of pressure to directly evaluate pressure hysteresis (FIG. 48). In each cycle, pressure hysteresis was determined by calculating the difference in onset transition pressure (Pₜᵣ) between compression and decompression, with ΔPhys=P_{tr,compression}−P_{tr,decompression}. This evaluation reveals that pressure-driven phase transitions in (C₆)₂C₁ and (C₆)₂I are associated with ΔP_{hys} of 59 bar and 58 bar, respectively, which can be on par with ΔP_{hys} values directly measured for 2-D perovskites. This result establishes that these materials can be barocaloric materials.

Intriguingly, the experimental ΔP_{hys} values-59 bar (Cl) and 58 bar (I)—were noticeably smaller than the ΔP_{hys} values of 76 bar (Cl) and 98 bar (1) calculated from isobaric HP-DSC. The discrepancies of 20-40 bar between observed and calculated ΔP_{hys} exceed the difference (ΔP) predicted from the temperature fluctuation during the pressure swing. (Given the dT/dP of 25-28 K kbar⁻¹, ΔT<0.2 K would result in ΔP<10 bar.) Hence, the difference in ΔP_{hys} may originate from intrinsic differences in nucleation pathways and phase-change kinetics between pressure-driven and thermally-induced transitions, coupled with extrinsic factors (such as the deviation from isothermality and changes in thermal contact during the pressure cycle).

High-pressure X-ray diffraction and Raman spectroscopy. As demonstrated by the calorimetric studies, driving reversible phase transitions in (C₆)₂Br may require a relatively large shift in pressure (>150 bar). However, (C₆)₂Br can exhibit phase-change properties conducive to strong and useful barocaloric effects. The combination of substantial entropy change (300 J K⁻¹ kg⁻¹), high pressure sensitivity (27 K kbar⁻¹), and sub-ambient transition temperature (293 K) can make (C₆)₂Br particularly well-suited for space cooling applications. Moreover, owing to its simple chemical composition, (C₆)₂Br can be produced at scale using commodity chemicals. Synchrotron PXRD and variable-pressure Raman spectroscopy measurements were performed at the pressure range up to 1000 bar in order to fully establish (C₆)₂Br as a promising barocaloric material by investigating its phase behaviors at a higher-pressure regime (well above the 150-bar limit accessible in the calorimetry measurements).

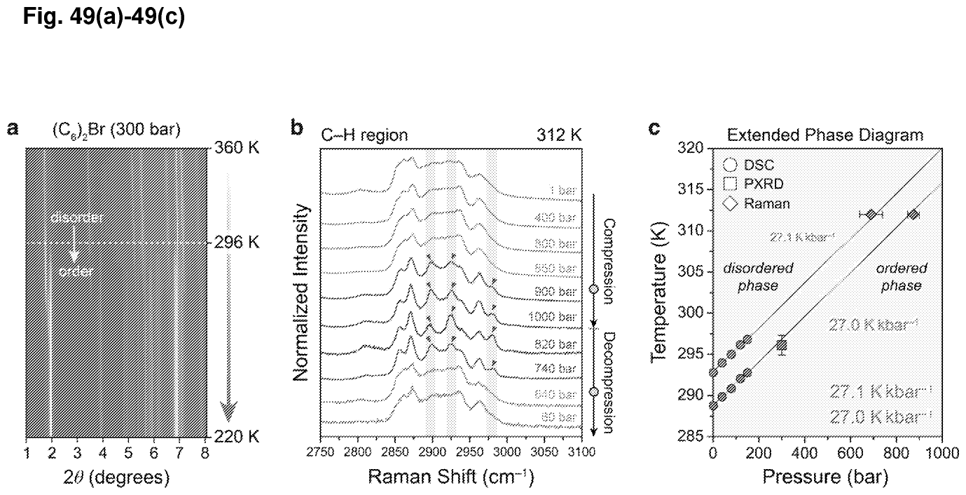

First, variable-temperature PXRD experiments at 300 bar were carried out with He as the pressure-transmitting medium. The gas pressure was applied through a syringe pump to the crystalline powder sample encapsulated in a sapphire capillary. The powder patterns were collected continuously during temperature scans, and the sample temperature was monitored using a thermocouple that maintained a direct contact with the sample within the capillary. FIG. 49(a) shows a waterfall plot obtained for the PXRD patterns of (C₆)₂Br collected during cooling scan, from 360 K to 220 K, at 300 bar. As illustrated in the waterfall plot, the compound, initially in the expanded phase at 360 K, undergoes a contracting, ordering transition upon cooling, at the onset temperature of 296 K. Unit-cell parameters determined by Le Bail refinement shows that the ordering transition is accompanied by a large anisotropic contraction of the lattice volume, with ΔVₜᵣ/VLT of 10.4%, which is comparable to the volume change observed at ambient pressure.

Isothermal, variable-pressure Raman spectroscopy measurements were subsequently conducted on (C₆)₂Br. In these experiments, the powder sample of (C₆)₂Br was dispersed in a pressure cell, with water serving as the pressure medium. Raman spectra were collected while the sample was isothermally pressurized from 1 bar to 1000 bar, and subsequently decompressed to 1000 bar, at 312 K. As depicted in FIG. 49(b), reversible transitions between ordered and disordered states were observed, with pressure onsets of 900 bar (compression) and 750 bar (decompression), the difference of which is in an excellent agreement with ΔP_{hys} of 149 bar predicted from HP-DSC. The transition onsets during the pressure-driven phase change were identified primarily by tracking C—H stretching modes. The peaks at 2920 cm⁻¹ and 2980 cm⁻¹-corresponding to symmetric and anti-symmetric C—H stretching on the α-carbon, respectively-became more prominent and sharper upon a compression-induced ordering transition. Additionally, in the fingerprint region, a new peak emerged at 1340 cm⁻¹ in the high-pressure ordered phase. DFT calculations indicate that this peak may be associated with a wagging mode of N—H bonds. In addition to identifying phase boundaries at higher pressures, these findings provide experimental evidence that the compression-induced ordering transition can be accompanied by enhancement of C—H . . . Br and N—H . . . Br interactions. This observation aligns with Hirshfeld surface analyses based on ambient-pressure structural models.

The transition onset points determined from synchrotron PXRD and Raman spectroscopy show agreement with the phase boundaries determined from HP-DSC (FIG. 49(c)). These results extend the P-T diagram of (C₆)₂Br up to 1000 bar, demonstrating that its pressure sensitivity of 27 K kbar⁻¹ persists even at the elevated pressure range and that it still undergoes a single transition between low-entropy and high-entropy phases. In addition, it is important to emphasize that the high-pressure Raman experiments used water as the pressure medium. This indicates that, in contrast to 2-D perovskites, dialkylammonium halides can be fully water-compatible.

Nanocalorimetry. In addition to water compatibility, dialkylammonium halides can exhibit several properties that are well-suited for device applications. These organic materials may not only be lightweight and soft, but they can also feature simple composition, high energy density, and excellent thermal and chemical stability. In particular, because of their solution-processable nature, they can be readily deposited onto a wide range of substrates. The facile processability, in particular, can offer a unique opportunity to characterize their phase-change properties through an array of advanced calorimetry techniques. To this end, nanocalorimetry—a method that enables characterization of phase-change phenomena under extreme, non-equilibrium conditions—was leveraged to probe thermal cyclability of dialkylammonium halides. By maintaining a high sensitivity of near 1 nJ K⁻¹, the nanocalorimetry technique allows thermal characterizations of thin films at rapid scan rates up to 10⁵ K s⁻¹.

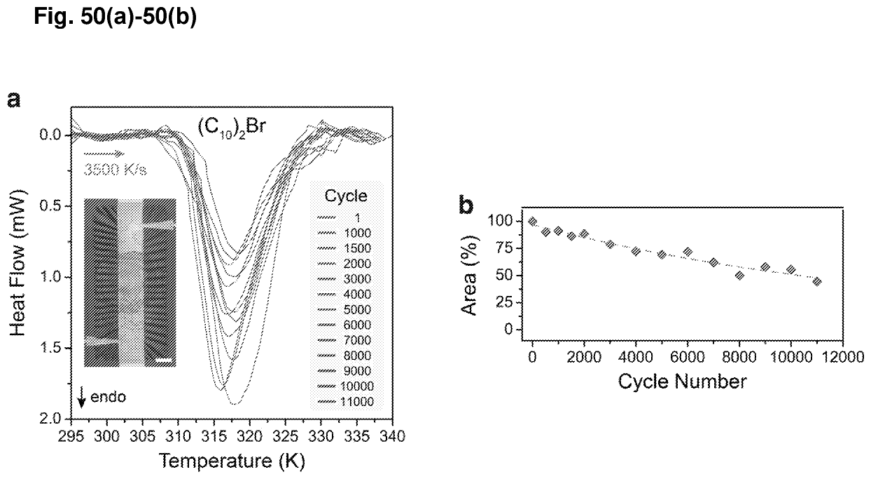

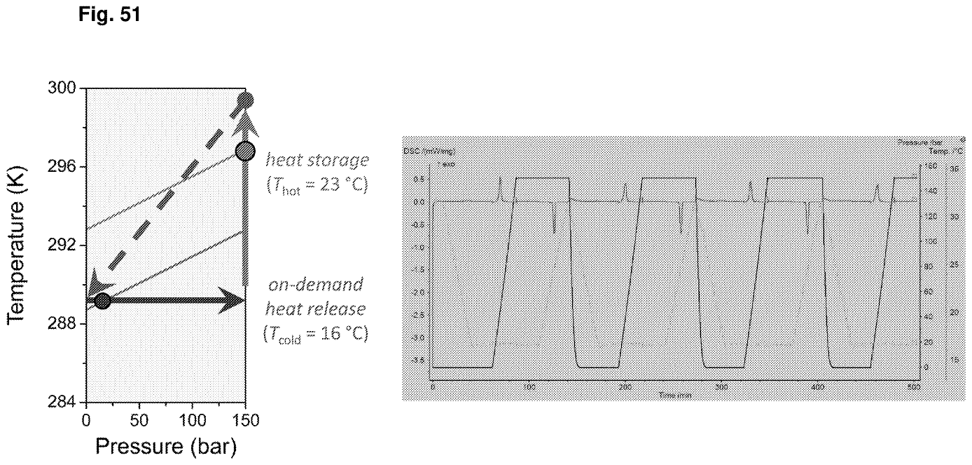

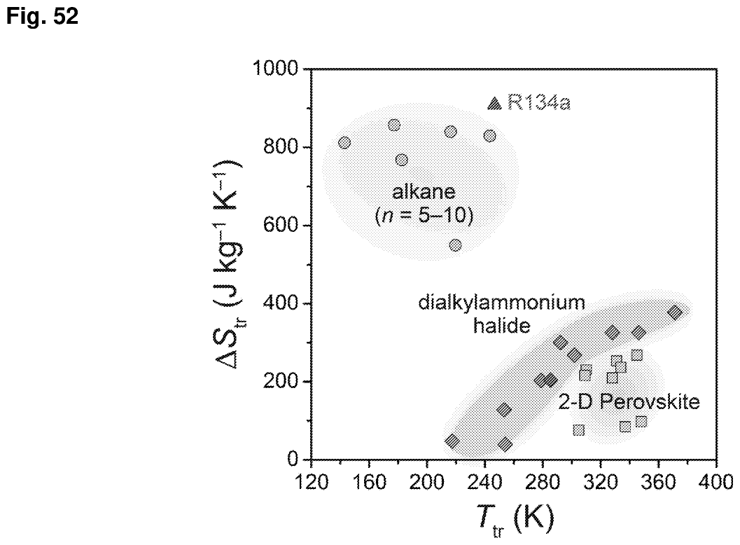

As illustrated in FIG. 50(a), a crystalline thin film of (C₁₀)₂Br [(C₁₀)₂=di-decylammonium]was deposited onto a small sensor area (1.9×10⁻² cm²) of the nanocalorimeter and thermally cycled it more than 11,000 times using a heating scan rate of 3500 K s⁻¹. To enable the rapid scan rate, the thermal mass of the thin film sample was kept very low, with its mass and thickness on the order of 100 ng and 50 nm. It is worth noting that for these nanocalorimetry tests (C₁₀)₂Br was opted for over dihexyl analogs, because its transition temperature (328 K) is well above room temperature and thus aligned better for the experimental setup. Remarkably, phase transitions in the thin-film sample—as indicated by the transition onset and peak temperatures of 311 K and 318 K-persisted throughout the aggressive thermal cycling, with only 50% decrease in the transition enthalpy (FIG. 50(b)) and with minimal change in its crystallinity.

The optical images of the sensor area taken after the cycling suggest that the decrease in transition enthalpy may be due to the combination of rapid heating and high vacuum resulting in sublimination of the sample, rather than due to material fatigue. Indeed, the cycling experiment repeated under ambient air demonstrated that the thermal cycling may have minimal impact on the transition enthalpy, showcasing an exceptional cyclability and stability of dialkylammonium halides.

Summaries of the results in this example can be found in Tables 8-14.

TABLE 8
Summary of the thermodynamics of order-disorder transitions
in (CₙH₂ₙ₊₁)₂NH₂X (X = Cl, Br, I).

| | | | | ΔSₜᵣ | ΔSₜᵣ |
|---|---|---|---|---|---|
| Chemical | Tₜᵣ^{b} | ΔHₜᵣ | ΔHₜᵣ | (J mol⁻¹ | (J kg⁻¹ |
| Formula^{a} | (K) | (kJ mol⁻¹) | (kJ kg⁻¹) | K⁻¹) | K⁻¹) |
| (C₅)₂Cl | 243.8 | 1.3 | 6.77 | 5.4 | 27.7 |
| (C₆)₂Cl | 115.3 | 0.9 | 4.09 | 7.9 | 35.5 |
| | minor | | | | |
| | 279.4 | 16.0 | 71.9 | 57.1 | 257.5 |
| | major | | | | |
| (C₆)₂Cl | 278.8 | 12.6 | 56.7 | 45.1 | 203.3 |
| | major | | | | |
| (C₈)₂Cl | 320.8 | 29.3 | 105.5 | 100.3 | 360.7 |
| (C₁₀)₂Cl | 338.2 | 41.8 | 125.0 | 130.2 | 389.7 |
| (C₁₂)₂Cl | 364.2 | 50.0 | 128.2 | 147.9 | 379.0 |
| (C₁₈)₂Cl | 292.5 | 84.0 | 150.4 | 230.7 | 413.1 |
| (C₂)₂Br | 283.0 | 2.2 | 14.3 | 7.7 | 50.0 |
| | 329.0 | 1.6 | 10.4 | 4.8 | 31.2 |
| | 342.0 | 2.3 | 14.9 | 6.8 | 44.1 |
| (C₃)₂Br | 293.0 | 5.9 | 32.4 | 20.1 | 110.4 |
| (C₄)₂Br | 228.0 | 3.1 | 14.8 | 13.5 | 64.2 |
| | major | | | | |
| | 254.0 | 2.1 | 10.0 | 8.2 | 39.0 |
| | minor | | | | |
| (C₆)₂Br | 292.8 | 23.4 | 87.8 | 79.9 | 299.9 |
| (C₈)₂Br | 301.8 | 26.1 | 81.0 | 86.5 | 268.4 |
| (C₉)₂Br | 301.0 | 30.1 | 86 | 100.1 | 285.8 |
| (C₁₀)₂Br | 328.1 | 40.4 | 106.8 | 123.2 | 325.6 |
| (C₁₂)₂Br | 346.2 | 49.0 | 112.7 | 141.6 | 325.7 |
| (C₁₈)₂Br | 371.2 | 84.5 | 140.2 | 227.7 | 377.6 |
| (C₆)₂I | 285.6 | 18.2 | 58.2 | 63.8 | 203.8 |
| (C₈)₂I | 285.$ | 17.6 | 47.7 | 61.7 | 167.0 |
| (C₁₀)₂I | 317.0 | 34.5 | 81.0 | 108.8 | 255.7 |
| (C₁₂)₂I | 338.2 | 39.0 | 81.0 | 115.3 | 239.5 |
| (C₁₈)₂I | 366.2 | 75.0 | 115.4 | 204.8 | 315.2 |

^{a}(Cₙ)₂ = (CₙH₂ₙ₊₁)₂NH₂⁺.
^{b}Measured during heating scan.
^{c}Measured using adiabatic calorimetry over a wide temperature range (from 25 K to 350 K). Note that thermal behaviors of dialkylammonium salts containing other anions (HSO₄_{^{−}}, ClO₃_{^{−}}, ClO₄_{^{−}}, H₂PO₄_{^{−}}, NO₃_{^{−}}) are summarized in Steinert et al. (2005), Thermochim. Acta 435 (1), 28-33.

TABLE 9
Summary of volume changes, entropy changes, and barocaloric
coefficients (dTₜᵣ/dP) for dialkylammonium halides.

| | | | | | dTₜᵣ/dP | dTₜᵣ/dP |
|---|---|---|---|---|---|---|
| | | | ΔVₜᵣ^{b} | ΔSₜᵣ^{c} | calc. | exp. |
| | Chemical | | (cm³ | (J kg⁻¹ | (K | (K |
| | Formula^{a} | Tₜᵣ^{b} | kg⁻¹) | K⁻¹) | kbar⁻¹) | kbar⁻¹) |
| Dialkyl- | (C₆)₂Cl | 293 | 68 | 203 | 33.4 | 28 |
| ammonium | | | | | | |
| halides | (C₆)₂Br | 293 | 89.9 | 300 | 30.0 | 27.1 |
| (solid-solid) | (C₆)₂I | 286 | 61 | 204 | 29.9 | 25 |
| | (C₈)₂Br | 302 | 66.3 | 268 | 24.7 | 21.7 |
| | (C₁₀)₂Br | 328 | 90 | 326 | 27.6 | 22.9 |

TABLE 10
Summary of phase-change properties
for select dialkylammonium halides.

| | | | | dT/dP | | |
|---|---|---|---|---|---|---|
| | | | ΔSₜᵣ^{c} | heating | | |
| | Chemical | | (J kg⁻¹ | (K | ΔT_{hys}^{d} | ΔP_{hys}^{e} |
| | Formula^{a} | Tₜᵣ^{b} | K⁻¹) | kbar⁻¹) | (K) | (bar) |
| Dialkyl- | (C₆)₂Cl | 293 | 203 | 28.1 | 2.2 | 76 |
| ammonium | | | | | | |
| Halides | (C₆)₂I | 286 | 204 | 25.1 | 2.4 | 98 |
| | (C₆)₂Br | 293 | 300 | 27.1 | 4.0 | 148 |
| | (C₈)₂Br | 302 | 268 | 21.7 | 2.3 | 106 |
| | (C₁₀)₂Br | 328 | 326 | 22.9 | 6.7 | 292 |

TABLE 11
Isothermal HP-DSC experiments for (C₆H₁₃)₂NH₂X (X = Cl, Br, I).

| | Tₛₑₜ | P_{tr, comp} | P_{tr, decomp} | ΔP_{hys} | q_{comp} | q_{decomp} | ΔS_{it, comp} | ΔS_{it, decomp} |
|---|---|---|---|---|---|---|---|---|
| | (°C) | (bar) | (bar) | (bar) | (J g⁻¹) | (J g⁻¹) | (J kg⁻¹ K⁻¹) | (J kg⁻¹ K⁻¹) |
| (C₆)₂Cl | 7.3 | 63(3) | 18(2) | 45 | −47.5 | 53.0 | −170 | 189 |
| | [0.3] | | | | | | | |
| | 7.5 | 76(4) | 22.3(4) | 54 | −49.2 | 53.4 | −176 | 191 |
| | [0.3] | | | | | | | |
| | 7.7 | 86(4) | 27.6(6) | 59 | −45.8 | 53.1 | −163 | 190 |
| | [0.4] | | | | | | | |
| (C₆)₂Br | 20.4 | 99(1) | 12.7(5) | 86 | −43^{b} | 47^{b} | −145^{b} | 163^{b} |
| | [0.1] | | | | | | | |
| | 20.7 | 110(4) | 19.7(7) | 91 | −77.0 | 87.2 | −262 | 297 |
| | [0.1] | | | | | | | |
| | 20.9 | 117(3) | 23.5(7) | 94 | −77.3 | 89.1 | −263 | 303 |
| | [0.1] | | | | | | | |
| (C₆)₂I | 13.5 | 61(5) | 20.9(9) | 41 | −55.3 | 55.2 | −193 | 203 |
| | [0.1] | | | | | | | |
| | 13.7 | 74(3) | 27.3(2) | 47 | −54.4 | 55.2 | −190 | 201 |
| | [0.2] | | | | | | | |
| | 13.9 | 91(7) | 33(1) | 58 | −54.1 | 57.2 | −189 | 200 |
| | [0.4] | | | | | | | |

^{b}irreversible

TABLE 12
Phase boundaries determined from isobaric and isothermal HP-DSC for (C₆H₁₃)₂NH₂X (X = Cl, Br, I)

| | Isobaric HP-DSC | | | Isothermal HP-DSC | | | | |
|---|---|---|---|---|---|---|---|---|
| | dT/dP | dT/dP | ΔP_{hys} | | dT/dP | dT/dP | ΔP_{hys} | Reversibility |
| | heating | cooling | calculated | Tₛₑₜ | decompression | compression | direct | at 150 bar |
| | (K/kbar) | (K/kbar) | (bar) | (°C) | (K/kbar) | (K/kbar) | (bar) | driving P |
| (C₆)₂Cl | 28.2 | 28.0 | 78 | 7.3-7.7 | 27.2 | 15.8 | 45-59 | reversible |
| | | | | | (R² = 0.97) | (R² = 0.99) | | |
| (C₆)₂Br | 27.1 | 27.1 | 149 | 20.4-20.9 | 26.8 | 24.9 | 86-94 | limited |
| | | | | | (R² = 0.95) | (R² = 0.92) | | |
| (C₆)₂I | 24.8 | 25.6 | 93 | 13.5-13.9 | 20.2 | 16.7 | 41-58 | reversible |
| | | | | | (R² = 0.99) | (R² = 0.99) | | |

TABLE 13
Deposition conditions for nanocalorimetry.

| | Deposition Area | Sample Mass | Sample Thickness | Deposition |
|---|---|---|---|---|
| a | (cm²) | (ng) | (nm) | Condition |
| vacuum | 1.9 × 10⁻² (sensor); | 102 (sensor); | 51 nm | 250 nL of 2.5 mM |
| | 4.4 × 10⁻² (total) | 237 (total) | | syringe-filtered |
| | | | | solution in i-PrOH |
| ambient air | 2.5 × 10⁻² (sensor); | 36 (sensor); | 14 nm | 125 nL of a 2 mM |
| | 6.6 × 10⁻² (total) | 95 (total) | | syringe-filtered |
| | | | | solution in i-PrOH |

TABLE 14
Single-crystal X-ray crystallography.

| | (C₁₀H₂₁)₂NH₂Br | (C₁₀H₂₁)₂NH₂Cl | (C₈H₁₇)₂NH₂Br | (C₆H₁₃)₂NH₂Br |
|---|---|---|---|---|
| Formula | C₂₀H₄₄BrN | C₂₀H₄₄BClN | C₁₆H₃₆BrN | C₁₂H₂₈BrN |
| Formula weight | 378.47 | 334.01 | 322.37 | 266.26 |
| (g/mol) | | | | |
| Temperature (K) | 100.0 | 100.0 | 100.2 | 100.0 |
| Crystal System | Orthorhombic | Monoclinic | Orthorhombic | Monoclinic |
| Space Group | P2₁2₁2 | P2₁/m | P2₁2₁2 | C2/c |
| a (Å) | 5.3475(4) | 4.8221(2) | 5.3716(15) | 26.2671(15) |
| b (Å) | 39.886(3) | 42.4398(14) | 33.568(10) | 5.3453(3) |
| c (Å) | 5.2758(4) | 5.2839(2) | 5.2791(15) | 10.7542(6) |
| α (°) | 90 | 90 | 90 | 90 |
| β (°) | 90 | 91.161(2) | 90 | 98.2990(10) |
| γ (°) | 90 | 90 | 90 | 90 |
| V (Å³) | 1125.27(15) | 1081.12(7) | 951.9(5) | 1494.14(15) |
| Z | 2 | 2 | 2 | 4 |
| Radiation, λ (Å) | MoKα, 0.71073 | CuKα, 1.54178 | MoKα, 0.71073 | MoKα, 0.71073 |
| μ (mm⁻¹) | 1.827 | 1.524 | 2.149 | 2.724 |
| Crystal size (mm) | 0.385 × | 0.276 × | 0.388 × | 0.354 × |
| | 0.090 × 0.040 | 0.195 × 0.052 | 0.376 × 0.138 | 0.311 × 0.140 |
| 2θ range for data | 6.128 to 49.97 | 4.164 to 133.242 | 4.854 to 50.142 | 3.134 to 55.206 |
| collection (°) | | | | |
| Number of | 18243 | 21819 | 18324 | 14144 |
| reflections | | | | |
| collected | | | | |
| Independent | 1967 | 1881 | 1687 | 1725 |
| reflections | | | | |
| Rᵢₙₜ, R_{sigma} | 0.0447, 0.0271 | 0.0604, 0.0298 | 0.0373, 0.0158 | 0.0211, 0.0114 |
| Data/Restraints/ | 1967/0/103 | 1881/0/104 | 1687/0/85 | 1725/0/67 |
| Parameters | | | | |
| Goodness of Fit | 1.183 | 1.073 | 1.286 | 1.061 |
| on F² | | | | |
| R₁, wR₂ | 0.0342, 0.0718 | 0.0342, 0.0718 | 0.0506, 0.1338 | 0.0186, 0.0454 |
| [I > 2σ(I)] | | | | |
| R₁, wR₂ | 0.0370, 0.0726 | 0.0395, 0.1075 | 0.0508, 0.1339 | 0.0248, 0.0482 |
| (all data) | | | | |
| Largest diff. peak | 0.98/−1.01 | 0.19/−0.20 | 1.99/−2.08 | 0.68/−17 |
| and hole (e Å⁻³) | | | | |

Other embodiments are in the claims.

What is claimed is:

1. A barocaloric system comprising:
a) a matrix comprising organic layers comprising compounds of formula (I): 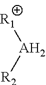
and a counterion, wherein R₁ and R₂ are optionally substituted polyfluorocarbyl or hydrocarbyl groups, and A=N or P; and
b) a source of compression.

2. The system of claim 1, wherein R₁≠R₂.

3. The system of claim 1, wherein at least one of R₁ and R₂ is optionally substituted C₃ hydrocarbyl or polyfluorocarbyl.

4. The system of claim 1, wherein R₁ comprises a linear chain of n atoms starting at a carbon of R₁ bonded to A, and R₂ comprises a linear chain of m atoms starting at a carbon of R₂ bonded to A, wherein n and m are from 1-36 atoms and wherein n>m.

5. The system of claim 1, wherein R₁ and/or R₂ comprises a carbon-carbon double bond or a carbon-carbon triple bond.

6. The system of claim 1, wherein R₁ and/or R₂ comprises two or more methylene or perfluoromethylene subunits separated by an O or S atom.

7. The system of claim 1, wherein R₁ is methyl or trifluoromethyl, and R₂ comprises optionally substituted C₃ hydrocarbyl or polyfluoroalkyl.

8. The system of claim 1, wherein R₁ comprises an ether or thioether linkage.

9. The system of claim 1, wherein R₁ is hydrocarbyl, and R₂ is a perfluorocarbyl group.

10. The system of claim 1, wherein R₁ is an alkyl group, and R₂ is a perfluoroalkyl group.

11. The system of claim 1, wherein the compound of formula (I) is a compound of formula: (CₙH₂ₙ₊₁)(CₘH₂ₘ₊₁)AH₂X, wherein A=N or P, X=a counterion, wherein m is 4-33 and n is 7-36, and wherein n−m≥3.

12. The system of claim 1, wherein the compound of formula (I) is a compound of formula:
(CₙH₂ₙ₊₁)(CH₂CₘF₂ₘ₊₁)AH₂X or (CₙH₂ₙ₊₁)(CₘF₂ₘ₊₁)AH₂X;
wherein A=N or P, X=a counterion, wherein m is 1-36 and n is 1-36.

13. The system of claim 1, wherein the compound of formula (I) is a compound of formula:
(CₙH₂ₙ₊₁)(CₘH₂ₘCH═CH₂)AH₂X;
wherein A=N or P, X=a counterion, wherein m is 1-34 and n is 1-36.

14. The system claim 1, wherein the compound of formula (I) is:
(C₆H₁₃)NH₂(CH₃)Br, (C₈H₁₇)NH₂(CH₃)Br, (C₁₀H₂₁)NH₂(CH₃)Br, (C₁₂H₂₅)NH₂(CH₃)Br, (C₆H₁₃)(CH₃)NH₂Cl, (C₈H₁₇)(CH₃)NH₂Cl, (C₁₂H₂₅)(CH₃)NH₂Cl, (C₆H₁₃)NH₂(CH₂C₅F₁₁H₂)Br, (C₁₀H₂₁)NH₂(CH₂C₉F₁₉)Cl, (C₁₀H₂₁)NH₂(CH₂C₉F₁₉)Br, (C₁₀H₂₁)NH₂(CH₂C₉F₁₉)I, (C₁₀H₂₁)NH₂(C₁₀H₁₉)Br, (C₂H₅)NH₂(C₆H₁₃)Br, (C₃H₇)NH₂(C₆H₁₃)Br, (C₄H₉)NH₂(C₆H₁₃)Br, (C₅H₁₁)NH₂(C₆H₁₃)Br, or (C₁₂H₂₅)(CH₃)NH₂Cl.

15. The system of claim 1, wherein the counterion is a halide, a sulfonate, a carboxylate, or is selected from NO₃—, ClO₃—, ClO₄—, H₂PO₄—, HSO₄—, CN—, HCOO—, N₃—, N(CN)₂—, BF₄—, BH₄—, PF₆—, SCN—, OCN—, or a combination thereof.

16. The system of claim 1, wherein system further comprises a pressure transmitting medium.

17. The system of claim 16, wherein the pressure transmitting medium comprises a gas.

18. The system of claim 17, wherein the gas comprises nitrogen, argon, krypton, xenon, methane, ethane, propane, butane, 2-methylpropane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, or a combination thereof.

19. A method of heating or cooling employing a barocaloric cycle comprising:
a) applying compression to induce an exothermic or endothermic phase transition in a matrix comprising an organic layer comprising compounds of formula (I): 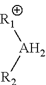
and a counterion, wherein R₁ and R₂ are optionally substituted polyfluorocarbyl or hydrocarbyl groups, and A=N or P;
b) providing or removing heat energy to or from the compressed matrix; and
c) removing the compression to allow reversion of the phase change.

20. The method of claim 19, wherein the phase change is an exothermic phase change to an ordered state and step (b) comprises removing heat energy from the matrix.

21. The method of claim 19, wherein the compression is provided via a pressure transmitting medium, wherein the phase change is an endothermic phase change to a disordered state, and wherein step (b) comprises providing heat energy to the matrix.

22. The method of claim 21, wherein the pressure transmitting medium comprises a gas.

23. The method of claim 22, wherein the gas comprises nitrogen, argon, krypton, xenon, methane, ethane, propane, butane, 2-methylpropane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, or a combination thereof.

24. The method of claim 19, wherein the compression is hydrostatic or mechanical and/or the heat is removed by a heat sink.

25. The method of claim 19, wherein the counterion is a halide, a sulfonate, a carboxylate, or is selected from NO₃—, ClO₃—, ClO₄—, H₂PO₄—, HSO₄—, CN—, HCOO—, N₃—, N(CN)₂—, BF₄—, BH₄—, PF₆—, SCN—, or OCN—.

26. The method of claim 19, wherein R₁≠R₂.

27. The method of claim 19, wherein at least one of R₁ and R₂ is optionally substituted 0!₃ hydrocarbyl or polyfluorocarbyl.

28. The method of claim 19, wherein R₁ comprises a linear chain of n atoms starting at a carbon of R₁ bonded to A, and R₂ comprises a linear chain of m atoms starting at a carbon of R₂ bonded to A, wherein n and m are from 1-36 atoms and wherein n>m.

29. A method of storing thermal energy comprising:
a) providing a composition comprising a matrix comprising an organic layer comprising compounds of formula (I): 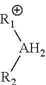
and a counterion, wherein R₁ and R₂ are optionally substituted polyfluorocarbyl or hydrocarbyl groups, A=N or P; wherein the composition is in an ordered state; and
b) subjecting the composition to a first pressure change that induces a first phase change in the composition to a disordered state, thereby storing energy.

30. The method of claim 29, further comprising subjecting the composition to a second pressure change to induce a second phase change to an ordered state and release heat energy.

31. The method of claim 29 or 30, wherein the first pressure change is a reduction in pressure.

32. The method of claim 29 or 30, wherein the first pressure change is provided via a pressure transmitting medium and wherein the first pressure change is an increase in pressure.

33. The method of claim 32, wherein the pressure transmitting medium comprises a gas.

34. The method of claim 33, wherein the gas comprises nitrogen, argon, krypton, xenon, methane, ethane, propane, butane, 2-methylpropane, sulfur hexafluoride, carbon dioxide, helium, nitrous oxide, cyclopropane, chloroform, dichloromethane, halothane, isoflurane, desflurane, sevoflurane, acetylene, R-134a, HFO-1234ze, diethyl ether, ethylene, or a combination thereof.

35. The method of claim 29, wherein the pressure change is provided by hydrostatic or mechanical compression.

36. The method of claim 29, wherein the counterion is a halide, a sulfonate, a carboxylate, or is selected from NO₃—, ClO₃—, ClO₄—, H₂PO₄—, HSO₄—, CN—, HCOO—, N₃—, N(CN)₂—, BF₄—, BH₄—, PF₆—, SCN—, or OCN—.

37. The method of claim 29, wherein R₁≠R₂.

38. The method of claim 29, wherein at least one of R₁ and R₂ is optionally substituted 0!₃ hydrocarbyl or polyfluorocarbyl.

39. The method of claim 29, wherein R₁ comprises a linear chain of n atoms starting at a carbon of R₁ bonded to A, and R₂ comprises a linear chain of m atoms starting at a carbon of R₂ bonded to A, wherein n and m are from 1-36 atoms and wherein n>m.

40. The system of claim 17, wherein the gas comprises an inert gas or a fluorinated gas.

41. The system of claim 16, wherein the pressure transmitting medium comprises a liquid.

42. The system of claim 41, wherein the pressure transmitting medium comprises a perfluorocarbon, an ionic liquid, an aqueous solution, an aqueous salt solution, or a combination thereof.

43. The system of claim 41, wherein the pressure transmitting medium comprises fluorocarbon oil, silicone oil, pentane, hexane, methanol, ethanol, alkylsilane, perfluorocarbon, water, hydraulic oil, mercury, mineral oil, glycerin, ethylene glycol, transformer oil, kerosene, silicone grease, liquid ammonia, liquid nitrogen, sodium-potassium alloy, gallium, indium, a liquid crystal, polyalphaolefin, liquid paraffin, grease, petroleum jelly, phosphate ester, polyol ester, propylene glycol, brake fluid, automatic transmission fluid, a vegetable oil, a synthetic oil, corn syrup, or a combination thereof.

44. The method of claim 22, wherein the gas comprises an inert gas or a fluorinated gas.

45. The method of claim 21, wherein the pressure transmitting medium comprises a liquid.

46. The method of claim 45, wherein the pressure transmitting medium comprises a perfluorocarbon, an ionic liquid, an aqueous solution, an aqueous salt solution, or a combination thereof.

47. The method of claim 45, wherein the pressure transmitting medium comprises fluorocarbon oil, silicone oil, pentane, hexane, methanol, ethanol, alkylsilane, perfluorocarbon, water, hydraulic oil, mercury, mineral oil, glycerin, ethylene glycol, transformer oil, kerosene, a hydrocarbon, silicone grease, liquid ammonia, liquid nitrogen, sodium-potassium alloy, gallium, indium, a liquid crystal, polyalphaolefin, liquid paraffin, an alkane, grease, petroleum jelly, phosphate ester, polyol ester, propylene glycol, brake fluid, automatic transmission fluid, a vegetable oil, a synthetic oil, corn syrup, or a combination thereof.

48. The method of claim 33, wherein the gas comprises an inert gas or a fluorinated gas.

49. The method of claim 32, wherein the pressure transmitting medium comprises a liquid.

50. The method of claim 49, wherein the pressure transmitting medium comprises a perfluorocarbon, an ionic liquid, an aqueous solution, an aqueous salt solution, or a combination thereof.

51. The method of claim 49, wherein the pressure transmitting medium comprises fluorocarbon oil, silicone oil, pentane, hexane, methanol, ethanol, alkylsilane, perfluorocarbon, water, hydraulic oil, mercury, mineral oil, glycerin, ethylene glycol, transformer oil, kerosene, a hydrocarbon, silicone grease, liquid ammonia, liquid nitrogen, sodium-potassium alloy, gallium, indium, a liquid crystal, polyalphaolefin, liquid paraffin, an alkane, grease, petroleum jelly, phosphate ester, polyol ester, propylene glycol, brake fluid, automatic transmission fluid, a vegetable oil, a synthetic oil, corn syrup, or a combination thereof.

52. The method of claim 19, wherein the providing or removing heat energy to or from the compressed matrix is facilitated by a heat transfer medium.

53. The method of claim 52, wherein the heat transfer medium comprises a heat transfer fluid.

54. The method of claim 53, wherein the heat transfer fluid comprises ethylene glycol, propylene glycol, a eutectic mixture of biphenyl and diphenyl oxide, silicone oil, mineral oil, polyalphaolefin (PAO), a pentaerythritol tetraalkanoate, a hydrogenated terphenyl, diphenyl ether, biphenyl, mineral oil, perfluoropolyether, perfluoroalkane, a molten salt, potassium formate, mono- and dibenzyltoluene, NaK (sodium-potassium alloy), a eutectic salt, a refrigerant, or a combination thereof.

55. The method of claim 53, wherein the heat transfer fluid can further comprise an additive, wherein the additive comprises a nanoparticle, a carbon nanotube, graphene, graphite, a metallic particle, boron nitride, diamond powder, carbon black, fullerene, a hydrotreated mineral oil, organosilane, a polymeric stabilizer, a surfactant, an antioxidants, an anti-foaming agent, a corrosion inhibitor, or a combination thereof.

56. The system of claim 1, further comprising a substrate, wherein the matrix is deposited on the substrate.

57. The system of claim 56, wherein the substrate comprises a binder, a shape-memory alloy, a thermally conductive additive, a thermally conductive scaffold, a carbon-based scaffold, a metal-based scaffold, a heat exchanger, a pipe, a tank, or a combination thereof.

58. The system of claim 57, wherein the thermally conductive additive comprises aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and graphene derivatives, hybrid graphene aerogel (HGA), sulphonated graphene (SG), graphite foams, carbon nanofibers (CNF), metallic nanoparticles, porous metals, graphene/ceramic composites, metal nanoparticles, metallic particles/beads, or a combination thereof.

59. The method of claim 19, wherein in (a) the matrix is deposited on a substrate.

60. The method of claim 59, wherein the substrate comprises a binder, a shape-memory alloy, a thermally conductive additive, a thermally conductive scaffold, a carbon-based scaffold, a metal-based scaffold, a heat exchanger, a pipe, a tank, or a combination thereof.

61. The method of claim 60, wherein the thermally conductive additive comprises aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and graphene derivatives, hybrid graphene aerogel (HGA), sulphonated graphene (SG), graphite foams, carbon nanofibers (CNF), metallic nanoparticles, porous metals, graphene/ceramic composites, metal nanoparticles, metallic particles/beads, or a combination thereof.

62. The method of claim 29, wherein in (a) the matrix is deposited on a substrate.

63. The method of claim 62, wherein the substrate comprises a binder, a shape-memory alloy, a thermally conductive additive, a thermally conductive scaffold, a carbon-based scaffold, a metal-based scaffold, a heat exchanger, a pipe, a tank, or a combination thereof.

64. The method of claim 63, wherein the thermally conductive additive comprises aluminum nitride (AlN), copper, carbon nanotubes, multi-walled carbon nanotubes (MWCNT), graphite nanoplatelets (GNP), aerogels based on GNP, foam based on GNP, graphite, exfoliated graphite (EG), graphene and graphene derivatives, hybrid graphene aerogels (HGA), sulphonated graphene (SG), graphite foams, carbon nanofibers (CNF), metallic nanoparticles, porous metals, graphene/ceramic composites, metal nanoparticles, metallic particles/beads, or a combination thereof.

65. The system of claim 1, wherein the matrix in (a) comprises a soft organic material.

66. The system of claim 65, wherein the soft organic material comprises bilayers of long-chain organic cations linked through charge-assisted hydrogen bonds to charge-balancing anions.

67. The system of claim 65, wherein the soft organic material undergoes a thermally induced, solid-solid phase transition.

68. The system of claim 67, wherein the thermally induced, solid-solid phase transition occurs near room temperature.

69. The system of claim 67 wherein the thermally induced, solid-solid phase transition occurs between low-entropy, low-temperature and high-entropy, high-temperature states.

70. The system of claim 69, wherein the thermally induced, solid-solid phase transition is driven by conformational disordering of hydrocarbon layers.
